(19) United States
(12) Patent Application Publication
(10) Pub. No.: US 2005/0027721 A1
(43) Pub. Date: Feb. 3, 2005

(54) System and method for distributed data warehousing

(76) Inventor: Javier Saenz, Spring Valley, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/877,810

(22) Filed: Jun. 25, 2004

Related U.S. Application Data
(63) Continuation-in-part of application No. 10/406,561, filed on Apr. 3, 2003.
(60) Provisional application No. 60/370,103, filed on Apr. 3, 2002.

(51) Int. Cl. G06F 17/00

(52) U.S. Cl. 707/100

(57) ABSTRACT

A computer-implemented system and method for gathering data from a plurality of properties. The system includes a plurality of data warehouses and each of the warehouses is located at a corresponding one of the plurality of properties. A central server unit is operatively connected to the plurality of data warehouses, and is configured to receive patron data and gaming machine data from each of the plurality of data warehouses, and to combine the patron data and said gaming machine data with corresponding property characteristics from each of the plurality of warehouses so as to generate a combined dataset. In variations of the invention, the patron, machine and property data is organized into a multi-dimension data model so that combinations of the patron, machine and said property data to be displayed vis-á-vis one another.

### CROSS-REFERENCE TO RELATED APPLICATIONS

This application is a continuation-in-part of U.S. patent application Ser. No. 10/406,561, filed on Apr. 3, 2003, entitled SYSTEM AND METHOD FOR CUSTOMER CONTACT MANAGEMENT, which itself claims priority under 35 U.S.C. §119(e) to U.S. Provisional Application No. 60/370,103, filed on Apr. 3, 2002, entitled INFORMATION PROCESSING SYSTEM FOR TARGETED MARKETING AND CUSTOMER RELATIONSHIP MANAGEMENT, and is related to copending U.S. patent application Ser. No 10/406,578, filed on Apr. 3, 2003, entitled INFORMATION PROCESSING SYSTEM FOR TARGETED MARKETING AND CUSTOMER RELATIONSHIP MANAGEMENT, each of which are herein incorporated by reference in their entirety.

### FIELD OF THE INVENTION

The present invention relates generally to computerized business information processing systems, and more particularly to computerized business information processing systems to enable intelligent patron awarding.

### BACKGROUND OF THE INVENTION

Businesses engage in marketing of their goods and services both to augment relationships with existing customers and to establish relationships with new customers. In order to ensure that marketing resources are expended productively; marketing campaigns are ideally only to existing customers and to those entities reasonably likely to become customers.

Many businesses do not maintain a comprehensive repository or database of customer transaction history, and hence lack knowledge of customer demographics and purchasing trends which could potentially be leveraged in developing effective marketing programs. Although other businesses may maintain detailed records of customer activity, many businesses nonetheless remain largely incapable of developing sophisticated marketing offers and campaigns likely to be attractive to both existing and potential customers. This is often because the task of gleaning useful information from the often voluminous records of customer activity has proven to be difficult. Moreover, even when promotional campaigns are formulated using existing customer databases, businesses are often unable to readily estimate the effectiveness of the promotional campaign. Similarly, it is also often difficult to discern change in the behavior of various demographic groups of customers, which precludes formulation of effective promotional campaigns.

As a consequence of the foregoing, decisions regarding marketing and promotional programs are often made primarily on the basis of the experience and inclination of marketing personnel. As a consequence, substantial marketing resources may be allocated based upon decisions which do not leverage historic transactional and other empirical data. This may lead to substantial waste of marketing resources, since such resources may then become directed to population groups in which only a relatively small fraction of the group's members are actually interested in the product or service being marketed.

### SUMMARY OF THE INVENTION

In accordance with one embodiment, the invention may be characterized as a method for warehousing data. The method include the steps of: receiving, from each of a plurality of properties, corresponding patron data and gaming machine data; appending property characteristics to the patron data and gaming machine data so as to generate a plurality of datasets respectively corresponding to the plurality of properties; combining the plurality of datasets so as to generate a combined dataset; and populating a data warehouse with said combined dataset so as to generate stored combined data.

In accordance with another embodiment, the invention may be characterized as a system for gathering data from a plurality of properties comprising: a plurality of data warehouses, each of the plurality of data warehouses being located at a corresponding one of the plurality of properties; a central server unit operatively connected to said plurality of data warehouses, said central server including a processor and a memory associated with said processor wherein said memory includes: a staging module executable by said processor, said staging module being disposed to receive, from each of the plurality of data warehouses, patron data and gaming machine data; a data combination module executable by said processor, said data combination module being configured to combine said patron data and said gaming machine data from each of the plurality of warehouses with corresponding property characteristics associated with each of the plurality of warehouses so as to generate a combined dataset; and a central data warehouse disposed to receive said combined data set.

In accordance with yet another embodiment, the invention may be characterized as a processor readable medium including processor executable instructions for warehousing data, the instructions including: receiving, from each of a plurality of properties, corresponding patron data and gaming machine data; appending property characteristics to the patron data and gaming machine data so as to generate a plurality of datasets respectively corresponding to the plurality of properties; combining the plurality of datasets so as to generate a combined dataset; and populating a data warehouse with said combined dataset so as to generate stored combined data.

### BRIEF DESCRIPTION OF THE DRAWINGS

For a better understanding of the nature of the features of the invention, reference should be made to the following detailed description taken in conjunction with the accompanying drawings, in which:

FIG. 1 provides an overview of a computing environment in which a patron bonusing system may be implemented.

FIG. 2 is a schematic diagram of the structure of a central server included within the system of FIG. 1.

FIG. 3 provides a schematic representation of a user computer included within the system of FIG. 1.

FIG. 4 is a data flow diagram illustrating the interaction among various functional components comprising an exemplary implementation of the system of FIG. 1.

FIG. 5 is a data flow diagram which depicts the cooperation between various functional components of the system of FIG. 1 in effecting a data extraction, transformation and load process.

FIG. 6 provides a flowchart representing a high-level sequence of operations performed in connection with creating a promotional campaign.

FIG. 7 is a flowchart representative of a Segment creation process.

FIG. 8 is a flowchart representative of an Offer creation process.

FIG. 9 is a flowchart illustrating a campaign creation process.

FIG. 10 is a flowchart illustrating a data visualization process.

FIG. 11 provides a simplified illustrative representation of certain aspects of the structure and function of a Player Contact System (PCS) module relative to other system components.

FIG. 12 is a flowchart illustrating the operation of the player contact system.

FIG. 13 is a flowchart illustrating the operations involved in making calls upon patrons, the scheduling of such calls, and the definition of associations between patrons.

FIG. 14 is a flowchart of an exemplary statistical analysis routine which may be employed in connection with the analysis of data accumulated by the player contact system.

FIG. 15 is a flowchart illustrating a patron locator and data visualization process pertinent to the player contact system.

FIG. 16 is an overview of a computing environment in which a distributed data warehouse system of the present invention may be embodied.

FIG. 17 is a schematic diagram of an exemplary embodiment of the structure of the central server of FIG. 16.

FIG. 18 is a data flow diagram illustrating the interaction among various functional components comprising an exemplary embodiment of the distributed data warehouse system system.

FIGS. 19-51 depict various user interface windows displayed during interaction with the campaign management system.

FIGS. 52-76 depict various user interface windows displayed during interaction with the player contact system.

FIGS. 77 and 78 are tabular and graphic reports respectively illustrating reporting along exemplary dimensions available in accordance with an exemplary embodiment of the distributed data warehouse system.

### DETAILED DESCRIPTION OF THE INVENTION

I. Summary Overview

The present invention relates to a distributed data warehouse system capable of gathering patron and machine data from several properties, and storing the gathered information in a central warehouse. With access to the cross-property data in the central warehouse, a user is be able to draw meaningful conclusions about the success of a particular gaming machine relative to a particular group of patrons and/or a particular type of property. With such information, a user will be able to make a more accurate prediction about a particular machines' likelihood of success in a particular property which is frequented by a particular demographic of patrons. Although the exemplary embodiment of the inventive distributed data warehouse system described herein is adapted to the casino industry, the inventive system can be readily applied to other types of business concerns.

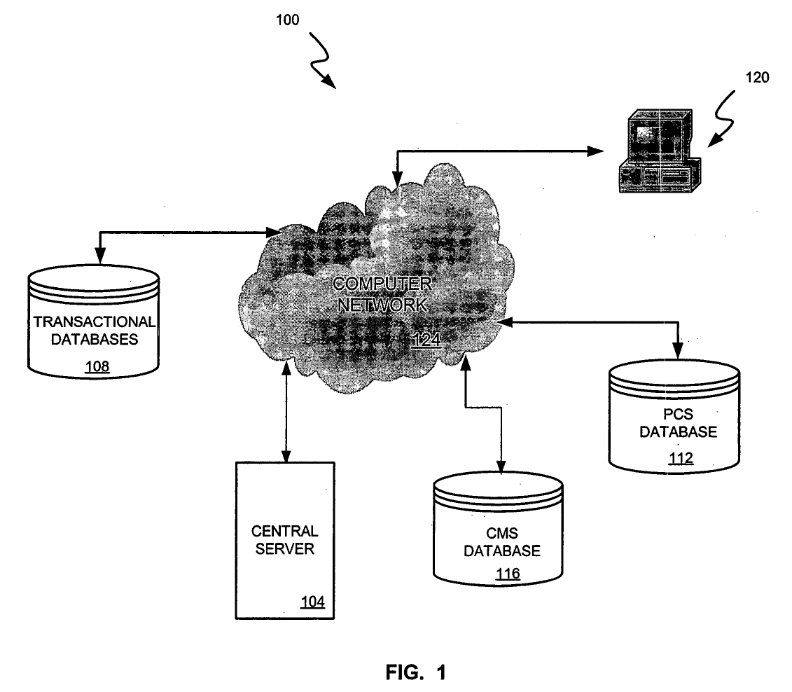

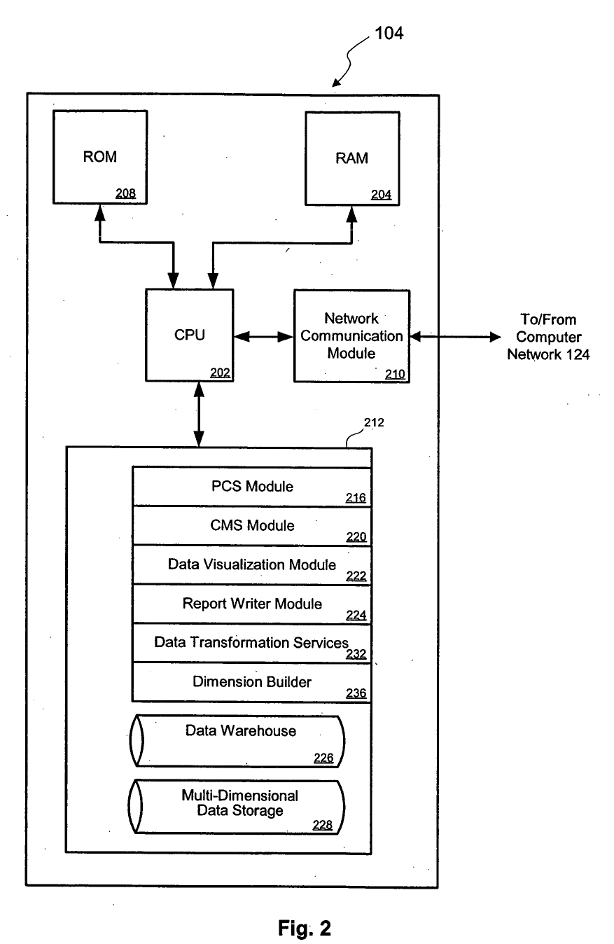

In order to more fully appreciate the distributed data warehouse system, a description is first provided with reference to FIGS. 1-15 of a business information processing system, disclosed in copending U.S. patent application Ser. No. 10/406,561, filed on Apr. 3, 2003, entitled SYSTEM AND METHOD FOR CUSTOMER CONTACT MANAGEMENT.

The business information processing system described in the above copending patent application is configured to transform and integrate data from various transactional systems into a central data warehouse. The data integrated within the central data warehouse is accessible to various applications designed to work in concert to improve and manage marketing and business intelligence activities. In the exemplary implementation the transactional systems providing information to the central data warehouse are operated or controlled by a casino or other gaming establishment, within which a number of gaming machines are located in one or more rooms of a facility. In accordance with one aspect of the business information processing system, data extracted from the transactional systems is transformed in a predefined manner and used to populate designated fields in the data warehouse.

As is described below, the business information processing system of the above copending patent application retains contact information for patrons registered with a particular gaming establishment, and also tracks the preferences of these patrons. Such preferences may include, for example, stated preferences with regard to particular casino games, leisure activities, and offers redeemed. In addition to recording stated preferences, the system determines actual preferences based upon data included within the data warehouse. Based on these preferences, managers employed by the gaming establishment may create reports listing patrons sharing a common preference (e.g., interest in professional football) and assign hosts to contact the listed patrons. Other types of reports could reveal which customers have not visited the gaming establishment since a given date, or which “VIP” customers have not been assigned a host. This enables the gaming establishment to ensure that appropriate levels of its customer service resources are directed to its most valued patrons.

General System Architecture & Functionality

An overview of a computing environment in which the business information processing system 100 may be implemented is shown in FIG. 1. As discussed further herein, the business processing system 100 is capable of implementing a patron bonusing system in accordance with the present invention. In the environment of FIG. 1, the system 100 is implemented using a central server 104 disposed to interface with transactional databases 108, a patron contact system (PCS) database 112, a customer management system (CMS) database 116, and with one or more user computers 120. The central server 104 communicates with the transactional databases 108, PCS database 112, CMS database 116 and user computers 120 over a computer network 124 (e.g., the Internet or a local area network (LAN)). The transactional databases 108 will often include data representative of the interaction between customers and merchants. In certain cases this data may be culled from existing customer databases, merchant loyalty programs, and/or promotional data. In exemplary implementations of the system 100, the transactional databases 108 may include a casino management system, slot accounting system, hotel/property management system, retail or point-of-sale (POS) system, and golf and events management systems. In alternate implementations yet other sources of data may also be tapped as necessary to facilitate additional functionality (e.g., third party databases containing demographic or geographic data, census data, and the like).

FIG. 2 is a schematic diagram of the structure of the central server 104. The central server 104 includes a CPU 202 connected to RAM 204, ROM 208, a network communication module 210 and secondary data storage 212. Included within secondary data storage 212 are a PCS module 216, a CMS module 220, a data visualization module 222, a report writer module 224, a data warehouse 226 and multi-dimensional data storage 228. Secondary data storage also includes a copy of the operating system for the server 104 (not shown), data transformation services 232 and a dimension builder 236 disposed to operate upon the contents of the legacy transactional databases and the data warehouse 226, respectively. When effecting the functionality described below, the CPU 202 loads into RAM 204 and executes one or more of the program modules stored within secondary data storage 212.

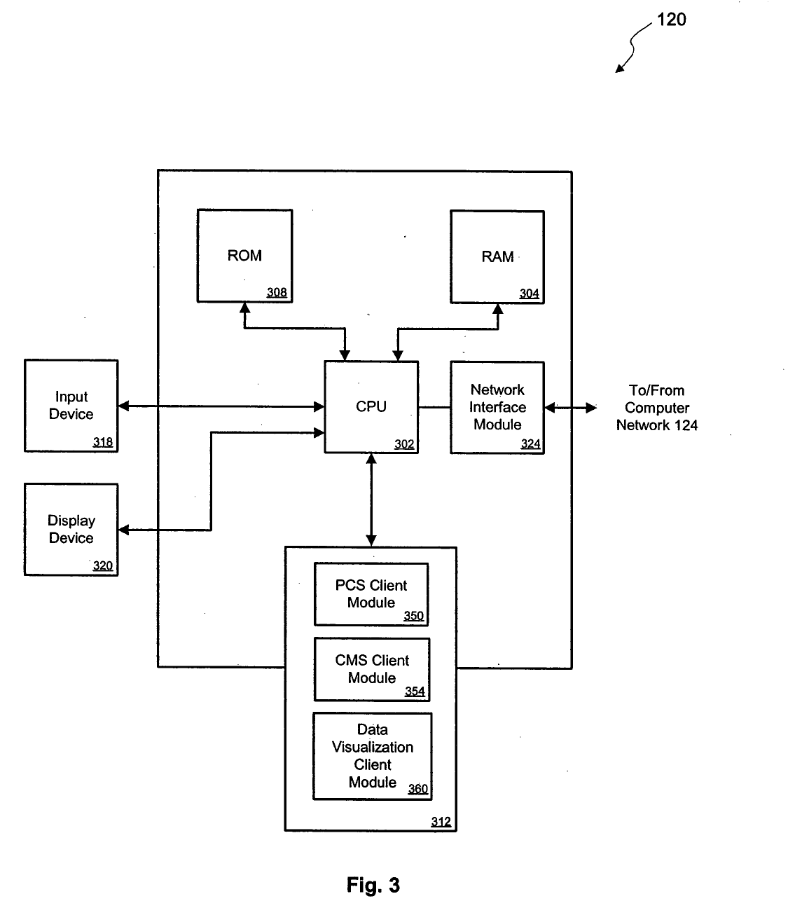

A schematic representation of a user computer 120 is provided by FIG. 3. As shown, the user computer 120 includes a CPU 302 connected to RAM 304, ROM 308 and hard disk storage device 312 containing a copy of the operating system (not shown) for the computer 120. The storage device 312 further includes a PCS client module 350, a CMS client module 354 and a data visualization client module 360, the operation of each of which is described hereinafter. The CPU 302 is also operatively connected to an input device 318 and to a display device 320 through which a user may communicate with user computer 120. Communication with the central server 104 via computer network 124 is facilitated by a network interface module 324, which may comprise a network interface card when user computer 120 is utilized in a LAN networking environment and a modem or the like when user computer 120 interfaces directly with the Internet. The functionality of the system 100 may be accessed by users (e.g., operators of casinos) via one of the user computers 120. In certain implementations the user computer 120 may comprise a portable wireless device, such as a handheld computer or personal digital assistant.

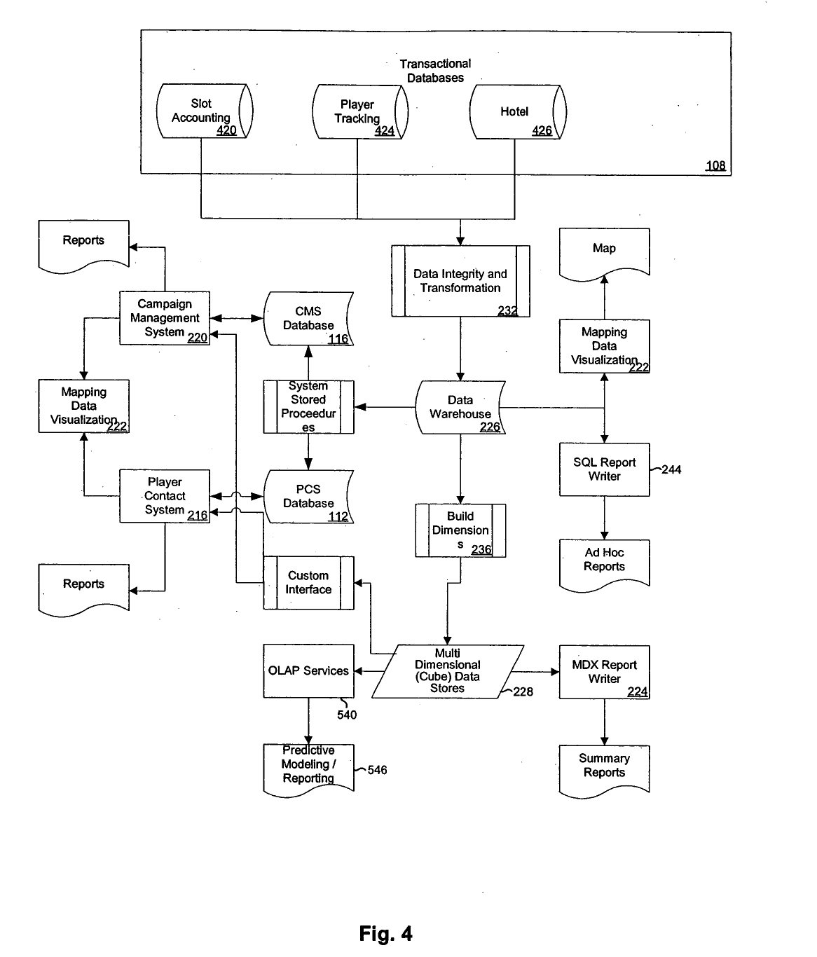

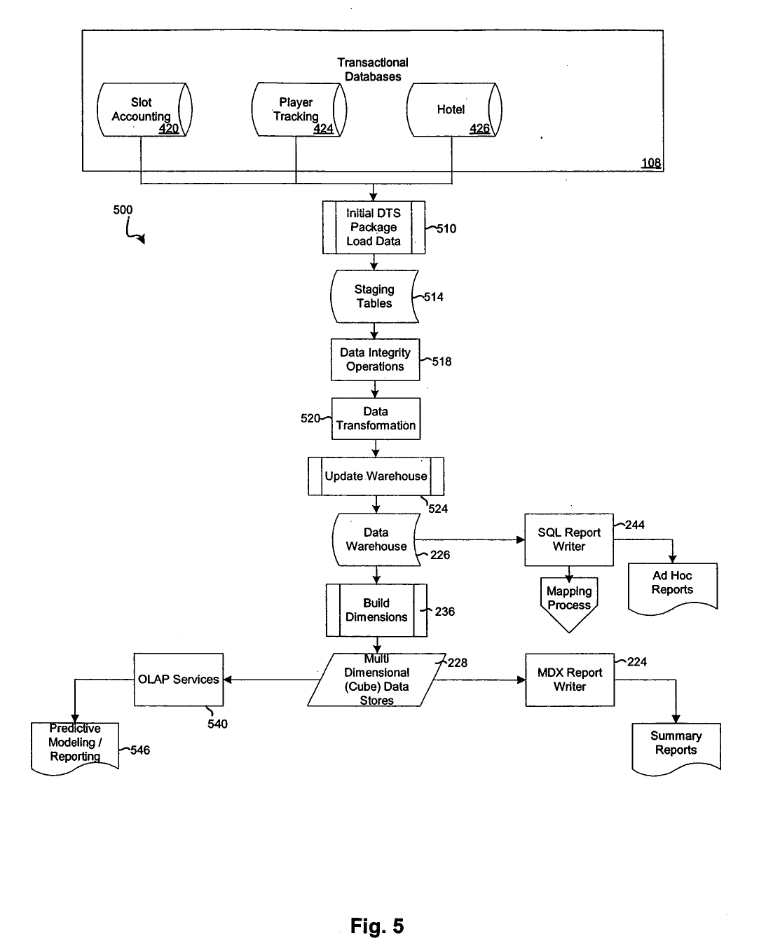

FIG. 4 is a data flow diagram illustrating the interaction among various functional components comprising an exemplary implementation of the system 100. As is described further below with reference to FIG. 5, data transformation services 232 serve to transform data from the transactional databases 108 prior to storage within the data warehouse 226. In the case in which the system 100 is configured to be utilized in the context of a casino or the like, the transactional databases are seen to include a slot accounting database component 420, a patron tracking database component 424, and a hotel database component 426.

As shown, system stored procedures 440 function to supply data from the warehouse 226 that is required by the PCS database 112 and the CMS database 116. The dimension builder 236 also functions to generate a plurality of multi-dimensional data representations (cubes) based upon the contents of the data warehouse 226, and to store such representations within the multi-dimensional data storage 228. The report writer module 224 draws upon the contents of the multi-dimensional data storage 228 in generating reports of desired complexity (e.g., from simple, transactional-based reports to more complex “drill-down” reports). In addition, a SQL report writer 244 is configured to generate reports based upon the “flat” table structures of the data warehouse 226 described below.

As may be appreciated by reference to FIGS. 2-4, the data flow and functionality described with reference to FIG. 4 may be effected by various combinations of modules and elements disposed at the user computers 102 and central server 104. The precise division of functionality between the modules within the user computers 120 (e.g., the PCS client module 350 and the CMS client module 354) and the modules within the central server 104 is not critical to the present system, and variations of the system may be predicated upon different distributions of functionality between the central server 104 and the user computers 102. Accordingly, references in the description below to the modules within the central server 104 (e.g., the PCS module 216 and the CMS module 220) are not necessarily intended to be directed exclusively to such modules, and should be construed as being applicable to implementations in which the relevant functionality is implemented in cooperation with complementary modules disposed within the user computers 102.

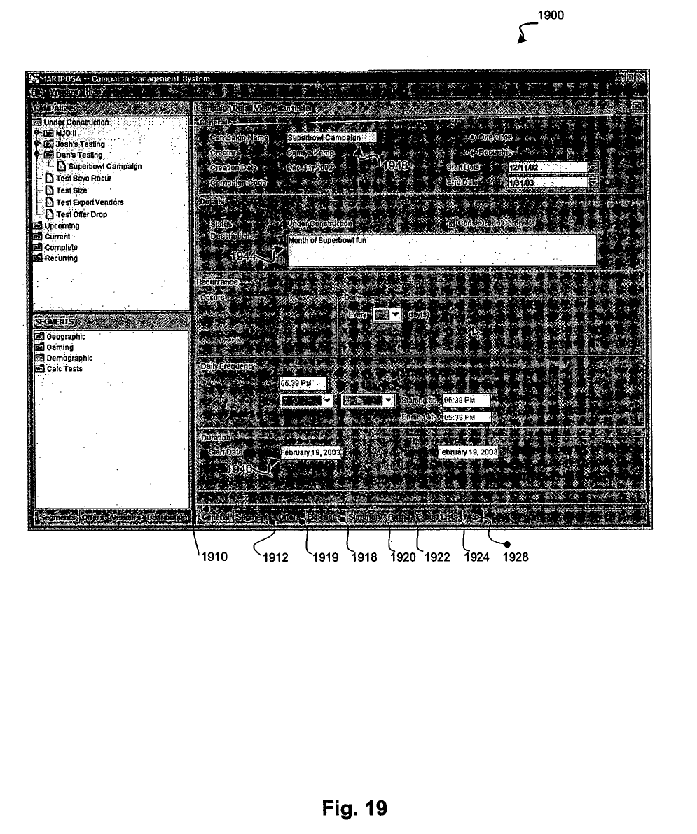

FIG. 19 shows a user interface window 1900 presented to a user when initiating interaction with a promotional campaign under development using the CMS module 220. As shown, a General tab 1910 has been selected in the view of FIG. 19. Other tabs (described below) capable of being selected from the window 1900 include a Segments tab 1912, Offers tab 1916, Expenses tab 1918, Summary tab 1920, Forma tab 1922, Export Lists tab 1924 and a Map tab 1928. The window 1900 also shows certain parameters of the campaign which have been previously selected. For example, a Start Date 1940 is indicated, as well as a Description 1944 and Campaign Name 1948.

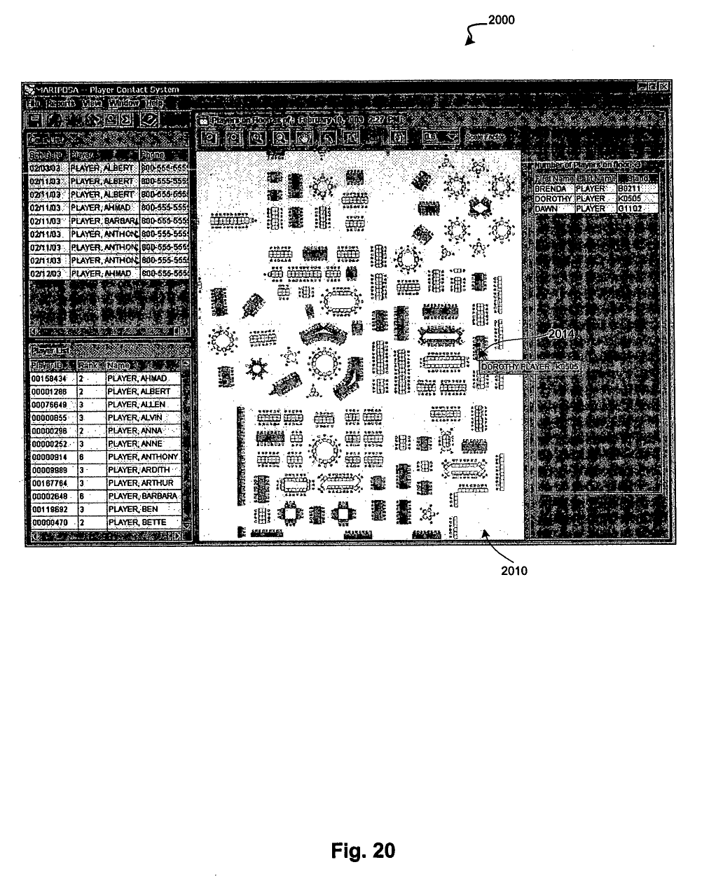

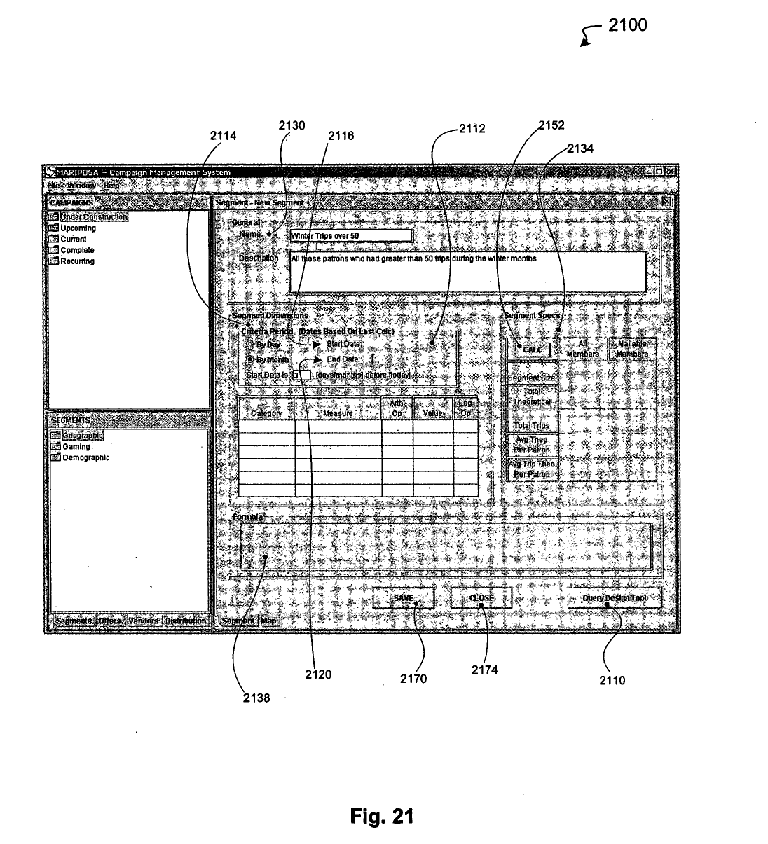

Turning now to FIG. 20, there is shown a user interface window 2000 displayed upon invoking the functionality of the PCS module 216. The user interface window 2000 includes a primary pane 2010 depicting a map of a casino floor. As shown, a user has positioned a mouse pointer 2014 proximate the location of a particular patron. Using a customer identifier or the equivalent, the PCS module 216 retrieves data such as, for example, the name (i.e., “Dorothy Player”) from memory and superimposes this information on the pane 2010.

III. Extraction, Transformation & Load Process

FIG. 5 is a data flow diagram which depicts the cooperation between various functional components of the system 100 in effecting a data extraction, transformation and load (ETL) process 500. It is assumed that data is collected and compiled within the transactional database 108 using conventional techniques. For example, in the gaming industry it is common for patrons to be issued a patron identification card encoded with a patron identification number uniquely identifying the patron. Within the casino or other gaming area, individual gaming devices are fitted with a card reader, into which the patron inserts the patron tracking card prior to playing the associated gaming device. The card reader reads the patron identification number off the card and informs a central computer of the patron's subsequent gaming activity. This enables individual patron usage to be monitored by associating dated records from the gaming device with patron identification numbers. As a patron interacts with a gaming device and/or visits a hotel, interaction or other transactional data is generated, collected and stored within the transactional database 108. The collected data could be stored within a number of records within a relational database structure of the transactional database 108. Each record may include, for example, a customer identifier associated with a particular patron identification card.

In certain exemplary implementations the ETL process 500 is conducted at least once daily, and automatically copies data from the transactional database 108 into the data warehouse 226. Specifically, based upon the pertinent fields within the database components 420, 424, 426 of the transactional database 108, a data transformation service (DTS) package 510 is developed so as to enable extraction of each of the pertinent fields from the various transactional databases (e.g., the databases 420, 424 and 426). The content of these fields are assembled into staging tables 514, at which point various data validation or integrity operations 518 are performed. Such operations could comprise, for example, validating that a field expected to contain a date does in fact contain information formatted consistently with a date, or confirming that a field expected to contain zip code information does in fact contain a valid zip code. The validated data may then be used as the basis for a variety of data transformation operations 520. For example, new fields may be computed based on the validated data that do not exist within the transactional databases 108 (e.g., a profit margin field could be created on the basis of revenue and cost information fields). Data from external sources could also be appended as part of the data transformation operations 520. In any event, the resultant transformed data is then used to update 524 the data warehouse 226, which stores the table structures created pursuant to the preceding operations.

In the implementation of FIG. 5 the data within the warehouse 226 is organized on the basis of a plurality of dimensions (e.g., age, gender, time). Data associated with ones of these dimensions is then assembled into cubes and stored within the multi-dimensional data store 228. Various on-line analytical processing (OLAP) services 540 may also be developed in order to provide an interface through which users may transform or limit the raw data within the data stores 228 in accordance with user-defined or pre-defined functions, and quickly and interactively examine the results in various dimensions of the data. The OLAP services 540 may also be used in performing predictive modeling and reporting 546 in the manner described hereinafter.

IV. Campaign Management System (CMS)

A. Overview

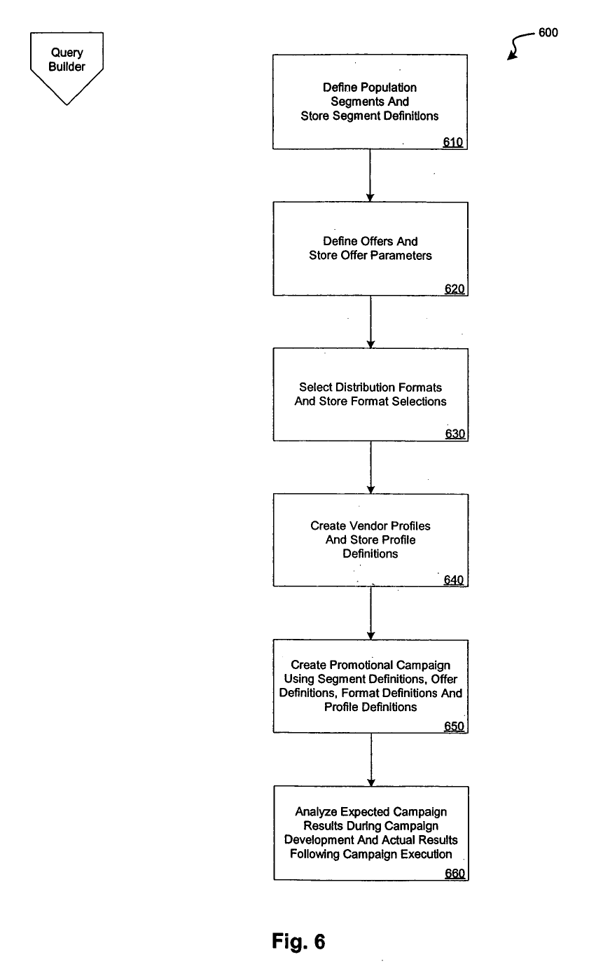

The CMS module 220 and CMS client module 354 are designed to cooperatively function as a tool for the creation, management and analysis of multi-channel marketing campaigns. As is described below, marketing campaigns consist of one or more offers directed to a particular segment of patrons (e.g., players), hereinafter referred to as a “Segment” or a “Segment population”. Campaigns are distributed in a predefined format by way of one or more selected distribution channels. In the exemplary implementation, the CMS module 220 facilitates the use of MDX in order to substantively improve response times for Segment calculations. The CMS module 220 then converts the MDX query into a SQL query when the actual list of individual records required for export and campaign execution is identified. The expense worksheet, proforma and analysis functions, along with the integration with the mapping and PCS systems are also believed to be unique. Each of the elements of a marketing campaign are described in further detail below. In these descriptions reference may be made to FIG. 6, which illustratively represents certain aspects of the structure and function of the CMS module 216 with reference to other components of the system 100.

As is discussed below, the campaign management system is configured to facilitate the targeting of appropriate Offers to specified Segment populations. For example, the system enables definition of a Segment corresponding to those “platinum” patrons which spend at least $100 per trip at the applicable gaming establishment. In addition, Offers such as free meals or rooms may be defined. A campaign is then constructed at least in part based upon Offers and Segment definitions such as these, and an estimate of the results of one or more potential campaigns is then generated. The results of each potential campaign may then be analyzed, and Offer and Segment definitions adjusted accordingly until a desired return-on-investment (ROI) is attained. Once a campaign has been selected and initiated, the actual performance of the campaign may be evaluated through the tracking of spending and other activity ancillary to the redemption of Offers.

FIG. 6 provides a flowchart 600 representing a high-level sequence of operations performed in connection with creating a promotional campaign. Commercial entities may elect to conduct promotional campaigns in order to attract additional business from existing customers and/or to attract new customers or patrons. As shown at 610, a user initiates creation of a promotional campaign by defining one or more Segment populations, which are then stored by the system as corresponding Segment definitions. The campaign creation process also involves defining one or more Offers and storing corresponding Offer parameters (step 620). Appropriate formats for distributing the details of the offers are also selected and the resulting selections are also stored (step 630). In addition, profiles of vendors capable of distributing the defined Offers in the selected formats are defined (step 640). Once these definitions and selections have been made, the promotional campaign may be created in the manner described hereinafter (step 650). The expected results of the campaign may be analyzed during development of the campaign, and the actual results analyzed following its execution (step 660).

B. Segments

The group of customers or patrons included within a Segment population each meet a specific set of criteria defined by a Segment definition. The user defines Segments for use in developing current or subsequent promotional campaigns. Segments are expected to typically be selected based upon characteristics such as age, gender, geographic location and other demographic criteria or patron characteristics. Segment definitions may also be inclusive of those patrons for which transaction histories have not been stored by the applicable merchant. Accordingly, the term “patrons” or “players” as used in the specification includes patrons and potential patrons, whether or not registered with a particular merchant or gaming establishment.

In an exemplary implementation of the system 100, Segments are defined using a Segment definition “wizard” (step 604 of FIG. 6). The wizard is in the form of a graphical user interface (GUI) that provides any easy to use and understand interface for creating complex MDX queries based on measures (data sets that describe attributes of a patron, such as gender, theoretical win, etc.) available in the data warehouse 226. Once a Segment is created, it must later be associated with a campaign (described below). Segments, once defined, are characterized by a Segment profile 612 defined by attributes such as size, worth, average trip theoretical win, etc. As the Segment definition is manipulated, the CMS module 220 modifies the MDX query that describes the Segment to reflect the changes and uses that query definition to calculate the Segment attribute values. Additionally, as a Segment is associated with various campaigns, the Segment MDX query definition is converted to a SQL query definition so that the records that, in aggregate, make up the Segment can be extracted from the data warehouse 226 for the purpose of creating distribution lists in a format consistent with the format required for the channel(s) and vendor(s) associated with the Segment. The use of MDX to query aggregated data in the data warehouse 226 greatly increases the speed of the query, thereby enabling a user to determine the effectiveness of the Segment definition more quickly than if the query were run against a traditional record set within a relational database. This timely feedback allows greater agility in the Segment definition process, and better ensures accurate and effective segmentation.

Referring now to FIG. 21, there is illustrated a user interface window 2100 through which a user may edit previously defined Segments and create new Segments. The window 2100 is accessed by selecting the Segments tab 1912 of window 1900 (FIG. 19). In certain implementations a tree structure (not shown) may be displayed upon selection of the Segments tab 1912. Through such a tree structure or the like a user may open an exiting Segment to view and/or edit, create a new Segment, rename one or more Segments, and/or create or rename folders to manage and organize existing Segments. In general, the window 2100 enables users to define a group of customers having characteristics comporting with various user-defined criterion. Through use of table-driven query builder, users may define relatively complex Segment definitions using the intuitive drop-down menu design of the user interface window 2100. For more robust queries, selection of a Query Design Tool button 2110 displays a design tool interface through which a user may fine-tune, edit, and test more complicated queries.

Segments may be stored and re-used in connection with future promotional campaigns. Such re-used is facilitated through inclusion, within a Criteria Period sub-panel 2112 included in a Segment Dimensions panel 2121, of a Start Date 2116 and an End Date 2120 field designed to enable users to indicate a desired criteria period without entering specific dates. For example, in one implementation the End Date field 2120 is set by default at the current date, and the Start Date 2116 is set by default to three months prior to the current date. Accordingly, a Segment can be defined once and used simultaneously in several campaigns, since the actual start/end dates characterizing the Segment will vary depending upon when the campaign is actually conducted.

In addition to the Segment Dimensions panel 2121, the window 2100 includes a General panel 2130, a Segments Spec panel 2154 and a Formula panel 2138. In the implementations of FIG. 21 the Formula panel 2138 is populated in real-time with pseudo-code of the SQL query corresponding to the Segment definition criteria entered by the user. The fields of the General panel 2130 and additional details regarding the fields of the Segment Dimensions panel 2121 are described below in Tables I and II, respectively.

TABLE I

| Field of General | |
|---|---|
| Panel | Description |
| Name | The user enters a name and that name is tested against |
| | the data warehouse 226 for uniqueness only when the |
| | user attempts to save the Segment definition. |
| Description | This field is used to provide a brief description |
| | of the Segment. |

TABLE II

| Field of Segment | |
|---|---|
| Dimensions Panel | Description |
| Criteria Period | This panel allows the user to define the date range for the Segment. The date |
| Sub-Panel | range is dynamic, and statistics based on the associated date range are |
| | updated within the campaign that the Segment is being used each time the |
| | Segment is recalculated. For example, if a user selects start date is 3 months |
| | before today, then the query uses the current date and the 3 months prior to |
| | the current date whenever this Segment is calculated. |
| By Day/By Month | The user selects whether it is desired that the Start Date begin either ‘x’ |
| | number of days, or ‘x’ number of months, prior to the End Date. |
| Start Date | The displayed Start Date will be equal to the End Date less the specified |
| | number of days/months prior to the End Date. The Start Date will also be |
| | updated upon pressing CALC. If the Segment is newly defined, the Start Date |
| | will display “undefined” until the CALC button is pressed. The Start Date |
| | cannot be before the End Date. |
| End Date | In the case of a previously defined Segment, the End Date will be displayed as |
| | the date at which the Segment was last calculated. If the Segment is newly |
| | defined, the End Date will be displayed as “undefined” until the CACL button is |
| | pressed. The End Date cannot be greater than the current date. |
| Text Field | The “Start Date is . . . ” field allows the user to define the date range of the |
| | applicable Segment by entering the number of days or months prior to the End |
| | Date corresponding to the Start Date. |

In the implementation of FIG. 5 the Segment Specs panel 2154 serves as an interface to a read-only table populated by the data warehouse 226. Specifically, the data warehouse 226 populates this table with information relevant to a specified Segment based on the query results from the warehouse 226. If a user desires to recalculate the table information (for example, in response to a change in the dates the Criteria Period sub-panel 2112), then the user may select a CALC button 2152 in order to display the new results or statistics. The results may be made to appear in a predefined color (e.g., red) in cases in which the applicable Segment has never been calculated (or has not been calculated for more than a predefined period of time, such as two weeks), thus indicating that the displayed statistical information or results may be inaccurate.

Again referring to FIG. 21, the user interface window 2100 is also illustrated as including a SAVE button 2170 and a CLOSE button 2174, the functionality of each being described below in Table III.

TABLE III

| Button | Description |
|---|---|
| SAVE | Upon pressing SAVE, a document validation routine checks to |
| | ensure that all fields are filled with valid information. If so, the |
| | Segment will be saved but the window 2100 will remain open. |
| | If an error occurs, a dialog box will inform the user and the |
| | Segment will not be saved until the fields in question have |
| | appropriate content. |
| CLOSE | Upon pressing CLOSE, a dialog box will query the user as to |
| | whether it is desired to save any changes that have been made |
| | since the last SAVE. If so, the validation routine is executed |
| | will run and the window will close after the save is completed. |
| | If no, the window 2100 closes without any such changes |
| | being saved. |

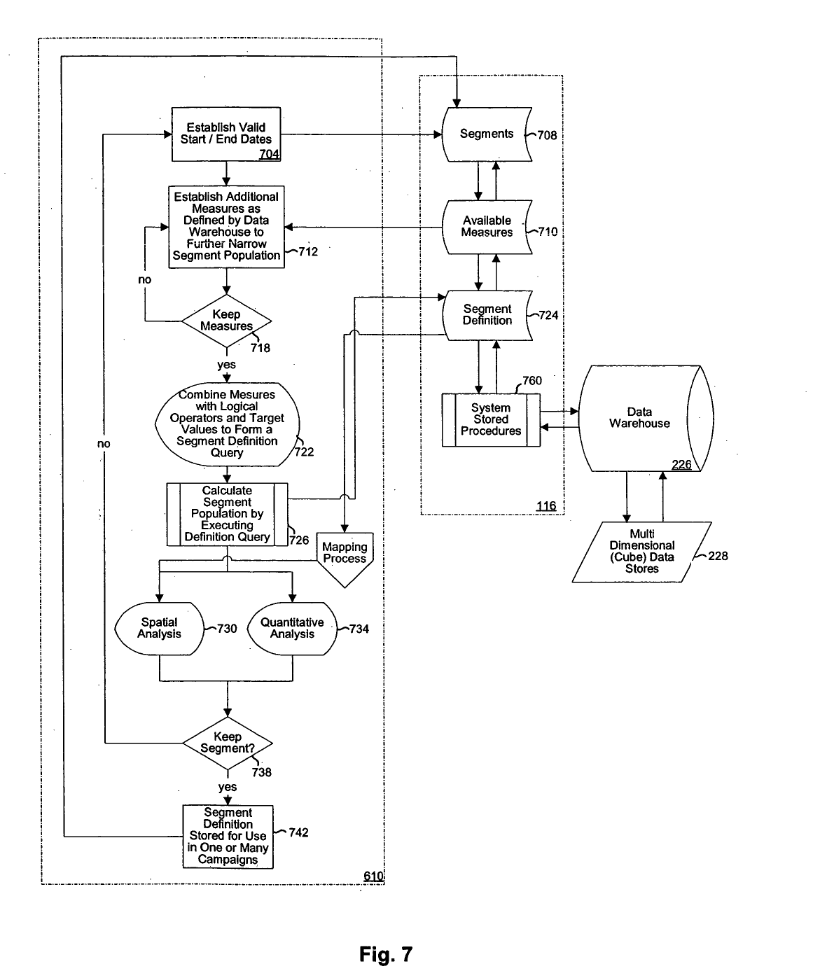

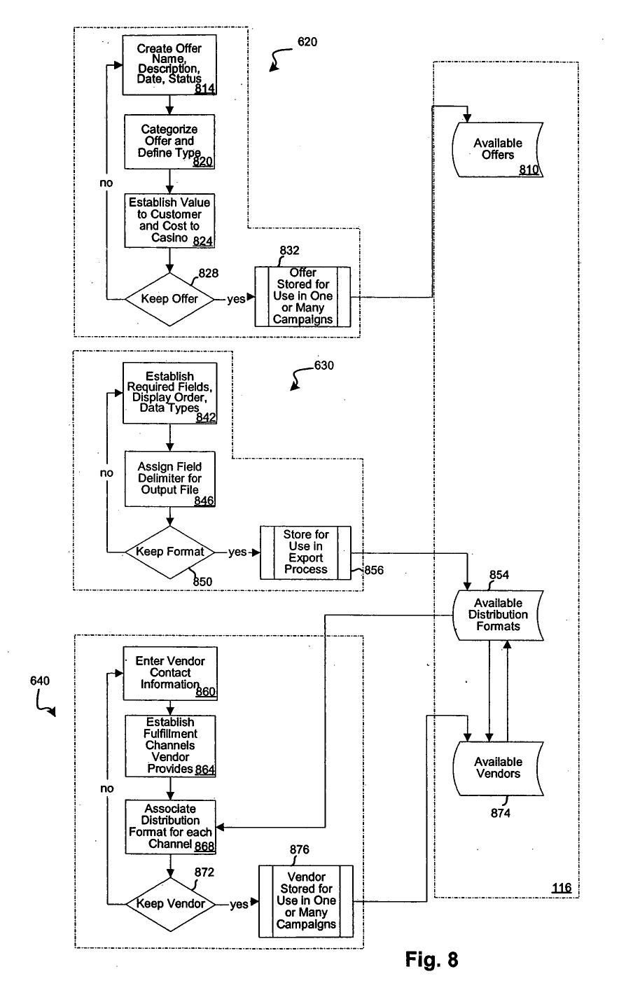

Referring now to FIG. 7, a flowchart is provided of the Segment creation process 610 mentioned above with reference to FIG. 6. As shown, the interaction occurring with the CMS database 116 and data warehouse 226 during the Segment creation process is also illustrated in FIG. 7 in order to more fully elucidate this process. As may be appreciated with reference to FIG. 7, the CMS database 116 provides a first or “local” repository of information that is populated by the data warehouse 226.

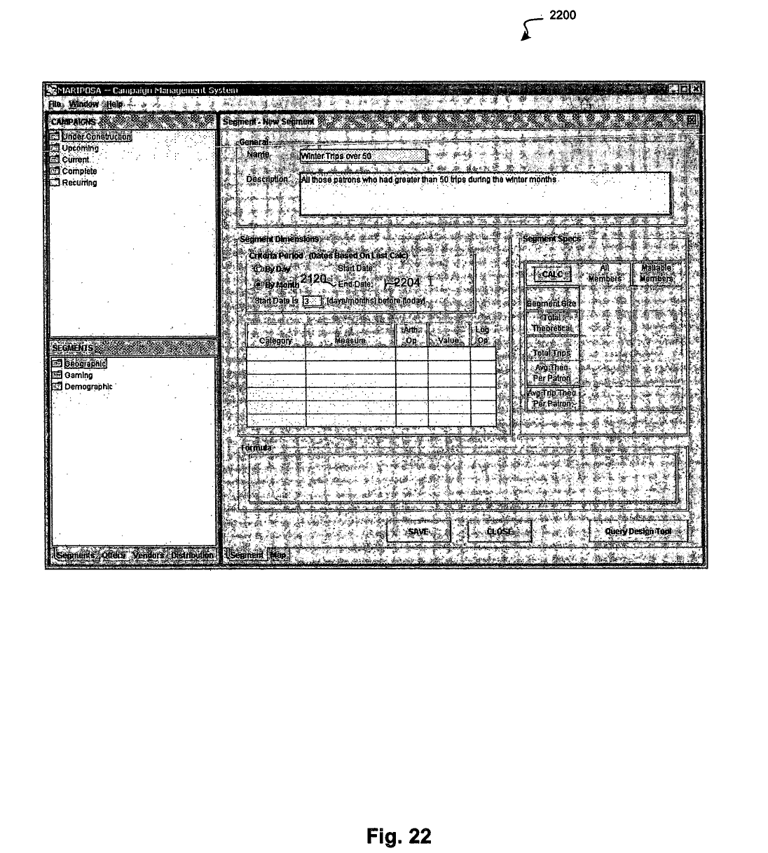

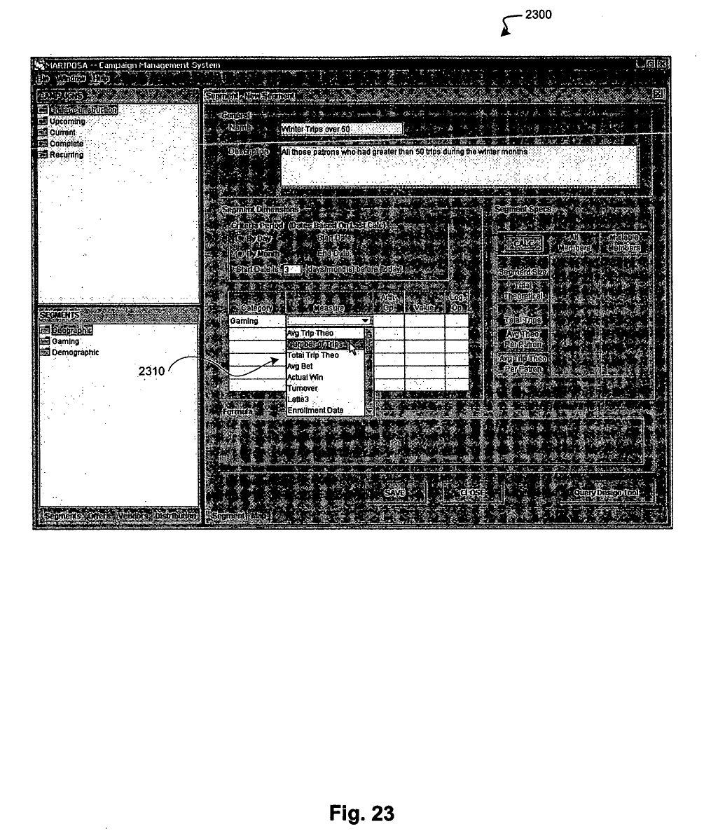

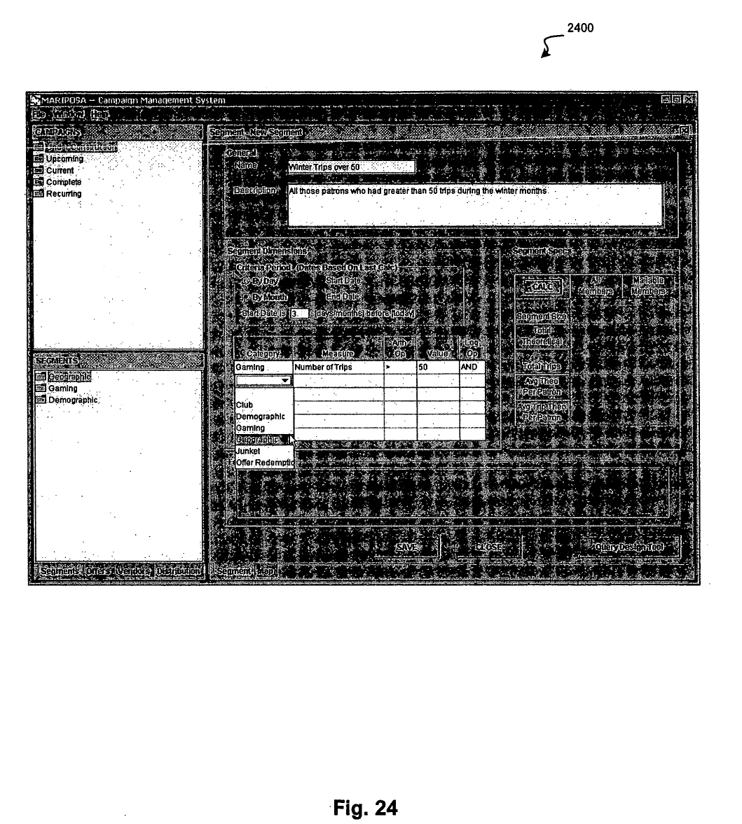

A first step 704 in creating a Segment is to establish a valid Start Date and End Date for the Segment. This is illustrated by the user interface window 2200 of FIG. 22, which depicts a cursor 2204 within the End Date field 2120. In FIG. 22, a user has entered Name and Description information for a newly created Segment, and is in the process of entering a Start Date and an End Date. As shown in FIG. 7, the selected Start Date and End Date are used identify any existing Segments 708 within the CMS database 116 having compatible Start Date and End Date criteria. The set of compatible Segments may then be further narrowed by establishing additional parameters or “measures” consistent with the organizational parameters of the data warehouse 226 (step 712). In the exemplary implementation this involves selecting a category and a measure from a set of available measures 710, each of which comprises part of the criteria defining the Segment being created. The foregoing aspects of the Segment creation process are illustratively represented by the screen shots of FIGS. 23 and 24. Specifically, FIG. 23 depicts a user interface window 2300 within which a user is in the process of selecting from a list 2310 of warehouse measures pertinent to the gaming industry in order to further define the Segment definition query. FIG. 24 depicts a user interface window 2400 substantially similar to the window 2300, but in the case of FIG. 24 a user is show as being in the process of selecting a category from a category list 2410. Once an initial group of measures has been identified, a decision is made of whether or not to retain them (step 718). If a decision is made to keep the measures, then the measures are combined with logical operators and target values in order to form a Segment definition query (step 722); otherwise, a new set of measures is selected pursuant to step 712.

Once a Segment definition 724 has been developed, a corresponding Segment is calculated by applying a query based on the definition the data warehouse 226 (step 726) via system stored procedures 760. In the exemplary implementation the result of application of a Segment definition query against the data warehouse 226 is a list of patron identification numbers corresponding to a set of individual patrons meeting the criteria established by the Segment definition.

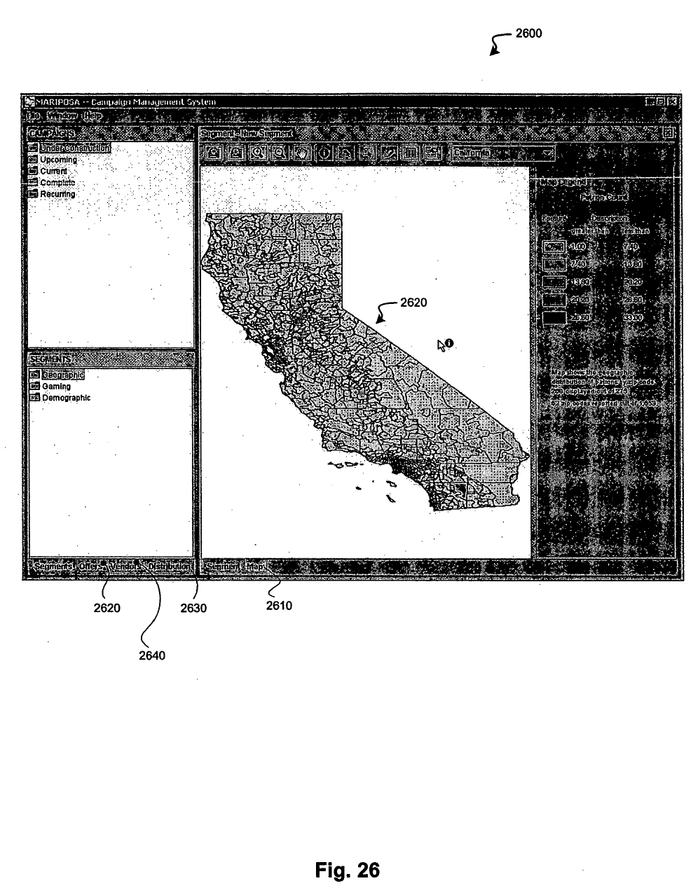

Once the composition of the Segment has been calculated, it may be spatially analyzed (i.e., geographically mapped) in a step 730. Turning now to FIG. 26, a screen shot is depicted of a user interface window 2600 which illustratively represents the geographic distribution of the results of a Segment definition query. The user interface window 2600 is displayed upon selection of a Map tab 2610, and is color-coded or gray-scaled coded to reflect the clustering of members of the applicable Segment throughout the illustrated geographic area 2620.

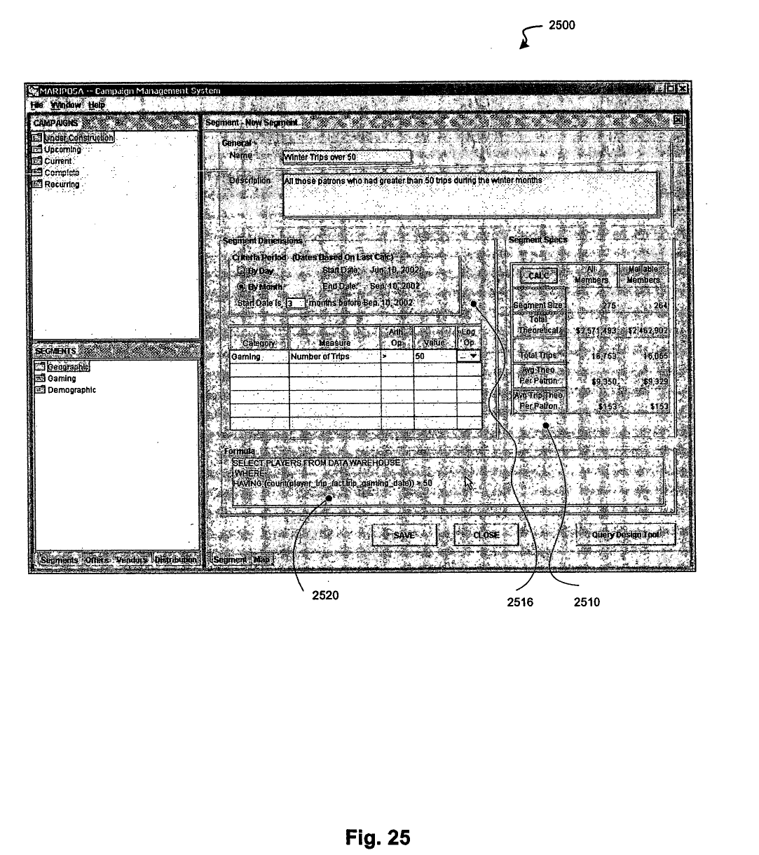

A Segment may also be quantitatively analyzed (step 734) subsequent to its calculation pursuant to step 726. For example, FIG. 25 depicts a user interface screen 2500 as it could appear immediately following the execution of the Segment calculation operation of step 726. As may be appreciated from FIG. 25, quantitative analysis may now be performed on the basis of the values displayed within the Segment Specs panel 2510. In addition, the accuracy of the applied Segment definition query be verified by comparing the values from the Segment Dimensions panel 2516 with the text in the Formula display box 2520.

Following completion of the above spatial and quantitative analysis of the calculated Segment, it may be desired to retain the corresponding Segment definition (step 738); otherwise, essentially any aspect of the Segment definition may be changed as desired. Once it has been decided to keep a particular Segment definition, it is stored for subsequent use as an existing Segment 708 within the CMS database 116 (step 742). As is discussed below, if it is decided to utilize a particular Segment definition in the context of a given campaign, the Segment definition is retrieved from the existing Segments 708 within the CMS database 116. The criteria corresponding to the retrieved definition are then applied against the contents of the data warehouse 226 in order to yield a list of patron identification numbers identifying a set of patrons meeting such criteria.

C. Offers

FIG. 8 is a flowchart representative of, inter alia, the Offer creation process 620 described briefly above with reference to FIG. 6 In the exemplary implementation any number of Offers (e.g. free hotel room, free gaming chips, food discounts, etc.) may be defined in the manner illustrated by FIG. 8. Offers have a plurality of attributes such as name, type (gaming, hotel, food, etc.), location, cost, value, etc. Once an Offer is created, it is stored as an available Offer 810 within the CMS database 116 and made available for use in subsequent promotional campaigns.

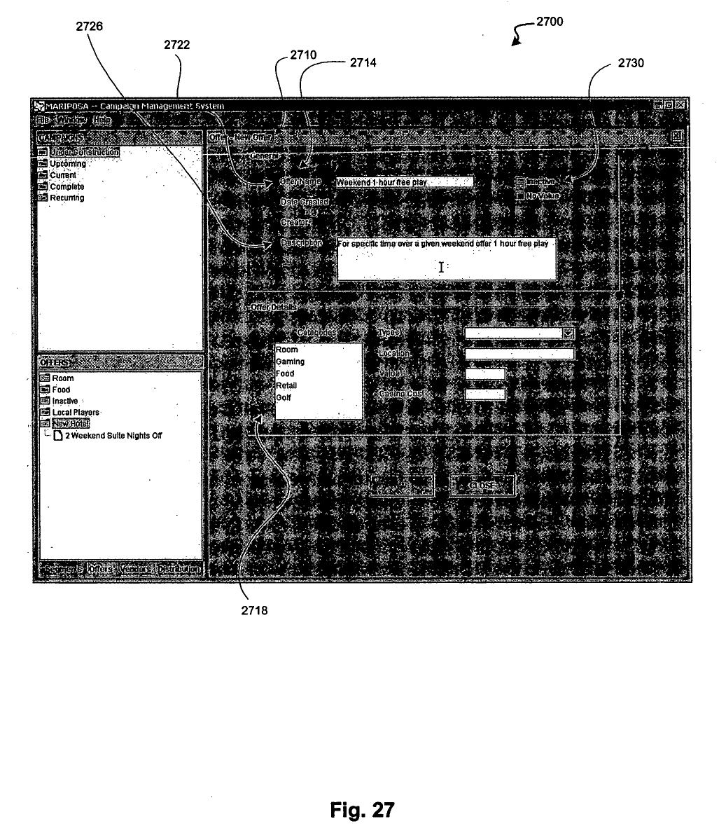

Referring to FIG. 8, the Offer creation process 620 is initiated by ascribing a name, description, date and status to a new Offer (step 814). This aspect of the process is illustrated by FIG. 27, which depicts a user interface window 2400 having a New Offer panel 2710. As shown, the New Offer panel 2710 includes a General sub-panel 2714 and an Offer Details sub-panel 2718. In the exemplary implementation each user interface window driven by the CMS module 220 includes an Offers tab (see, e.g., the Offers tab 2620 of window 2600), which may be selected (i.e., “double-clicked”) in order to display the New Offer panel 2710.

Within the General sub-panel 2714, a user has begun the process of creating a new Offer by entering a name within an Offer Name field 2722 and a description of the Offer within a Description field 2726. An Offer status (e.g., active or inactive) may also be indicated through appropriate selection of a status box 2730. If a user desires to use the same name as a previously defined Offer, by checking the “Inactive” status box 2730 the Offer is automatically moved to an Inactive folder (not shown) and a new Offer may be created with the same name.

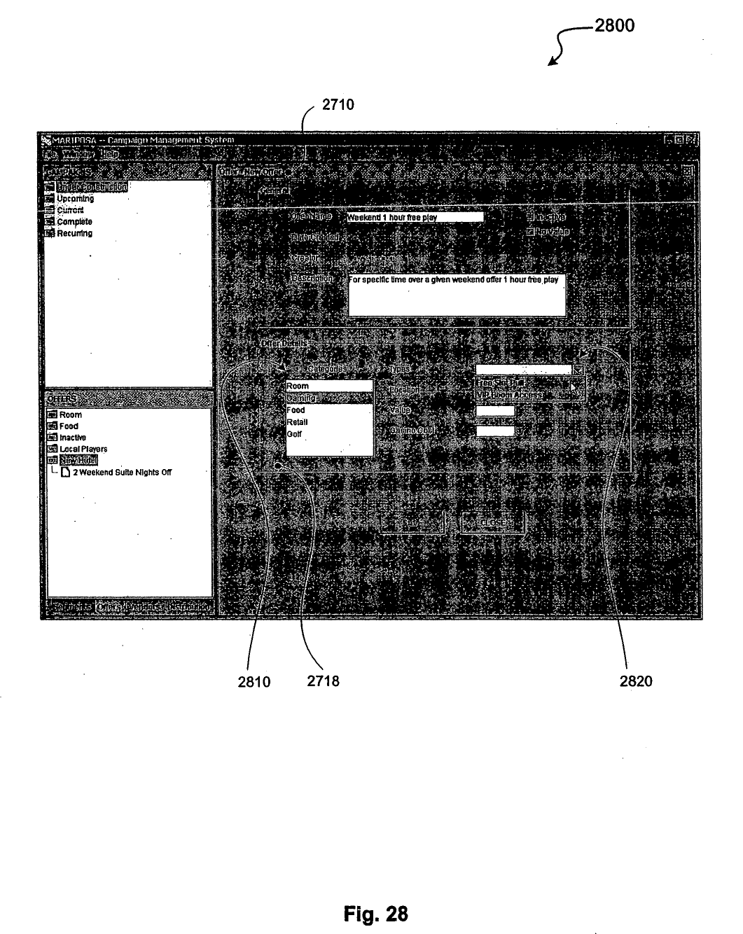

The Offer creation process also involves categorizing the Offer and identifying it as a particular type (step 820). This is illustrated by the user interface window 2800 of FIG. 28, which is substantially identical to the window 2700 but further depicts the selection of a category (i.e., “Gaming”) from a Categories list 2810 within the Offer Details sub-panel 2718. In addition, the window 2800 indicates that the user has also selected an Offer type from a drop-down menu associated with a Types field 2820.

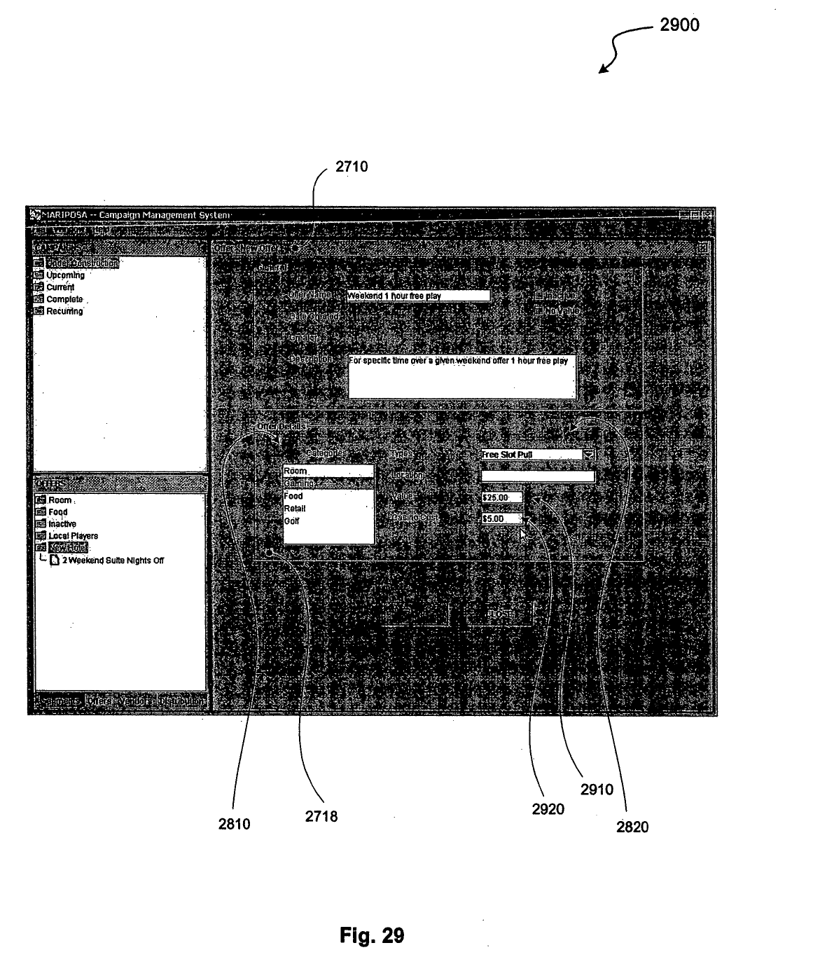

The Offer creation process continues through specification of a value of the Offer to a potential patron and the cost of the Offer to the offering casino or other gaming establishment (step 824). These values arc determined by management of the applicable casino or gaming facility. For example, the value of the Offer may be equivalent to the value of the Offer perceived by the patron receiving the Offer (e.g., a ticket to some form of entertainment having a face value of $50 would likely be perceived as a $50 value). Similarly, the cost of the Offer to the casino could simply be the actual cost of extending the Offer to the patron (e.g., the cost of procuring the ticket given to the patron). In the user interface window 2900 of FIG. 29, a user has entered a value of an Offer within a Value field 2910 of the Offer Details sub-panel 2718 and a cost of the Offer within a Casino Cost field 2920. Once an Offer has been saved, it is generally not permitted to be edited other than to change the its description or be declared inactive. This is because Offers are directly associated with promotional campaigns, and changing the values of the Value field 2910 or the Casino Cost field 2920 would impact the post-analysis of the efficacy of a given campaign.

If it is determined to keep the Offer which has been created (step 828), the Offer is stored as an available Offer 810 for later use in one or more campaigns (step 832).

Additional details regarding the various fields within the General sub-panel 2714 of the windows of FIGS. 27-29 are set forth in Table IV. Similarly, further description of the fields of the Offer Details sub-panel 2418 are given below in Table V.

TABLE IV

| Field of General | |
|---|---|
| Panel | Description |
| Offer Name | A user enters a unique Offer name within the Offer Name field. Upon SAVE or |
| | CLOSE, the CMS database 116 will be queried to ensure the Offer name is |
| | unique. If it is not, a dialog box will prompt the user to enter a new one. |
| Date Created | The Date Created is a non-editable text field. Upon SAVE, the current date will |
| | be entered in this field. |
| Creator | The Creator is the person creating the Offer. This field is automatically entered |
| | based on the identification provided during the system login process. |
| Description | The Description field is a text field. It will allow special characters, numbers, |
| | etc. The user will input a description of the Offer in this area. |
| Inactive | If a user would like to end an Offer, the Inactive status box may be checked |
| | and the Offer will be put in an Inactive Folder. At that time, the Offer cannot be |
| | used in any future campaigns. |
| No Value | If the No Value status box is selected, the offer properties will not require the |
| | input of “Value” or “Cost” data, as the offer will be considered an |
| | advertisement. |

TABLE V

| Field of Offer | |
|---|---|
| Details Panel | Description |
| Categories | The Categories field is a list box that will be populated by the CMS database |
| | 116 to include all available Offer categories. A user will select the category |
| | that best fits the Offer. In the exemplary implementation there are several |
| | pincipal predefined categories such, as, for example, Room, Gaming, Special |
| | Events, and Entertainment. Each of these general categories includes “Offer |
| | Types” unique to that category. For example, a Room (general category) |
| | contains a predefined set of Offer types that include (but are not limited to) |
| | Casino Rate/Limited Food & Beverage or Full Comp Room/No Food & |
| | Beverage. |
| Types | Upon selection of the category, the Types dropdown will populate from the |
| | CMS database 116 with the subtypes of the category chosen. The Types field |
| | is a dropdown list of subtypes for the chosen Category. The user selects a |
| | type that is best suited to the Offer. |
| Location | Location is a text field in which is entered the location where the Offer is valid. |
| | For example, “Benihana” or “Bellagio”. |
| Value | Value is a text field of the currency format in which the value of the Offer to the |
| | guest is entered. |
| Casino Cost | Casino Cost is also a text field of the currency format in which the cost of the |
| | Offer to the Casino or other gaming establishment is entered. |

D. Channels

Marketing campaigns can be executed through a number of channels, including, but not limited to, direct mail, email, telemarketing, door-to-door. Each Segment receiving an Offer within a campaign can be delivered via any number of channels. When integrated, the PCS module 216 provides information regarding telemarketing channels for campaigns utilizing this approach.

E. Distribution Formats

As is described below, during the process of creating a promotional campaign specific vendors and channels will be specified through which the campaign is executed. Since different vendors may utilize different equipment when developing campaign-related material for particular channels, various distribution formats specific to particular vendors and channels may be defined. Typically, a distribution format defines the specifics of the electronic files generated and sent to vendors in connection with campaigns of various types (e.g., mailing, or e-mail, or telemarketing). Exemplary distribution formats may, for example, specify the required fields for such electronic files, the display order, the data types to be output, and the delimiter(s) to be used for the output files.

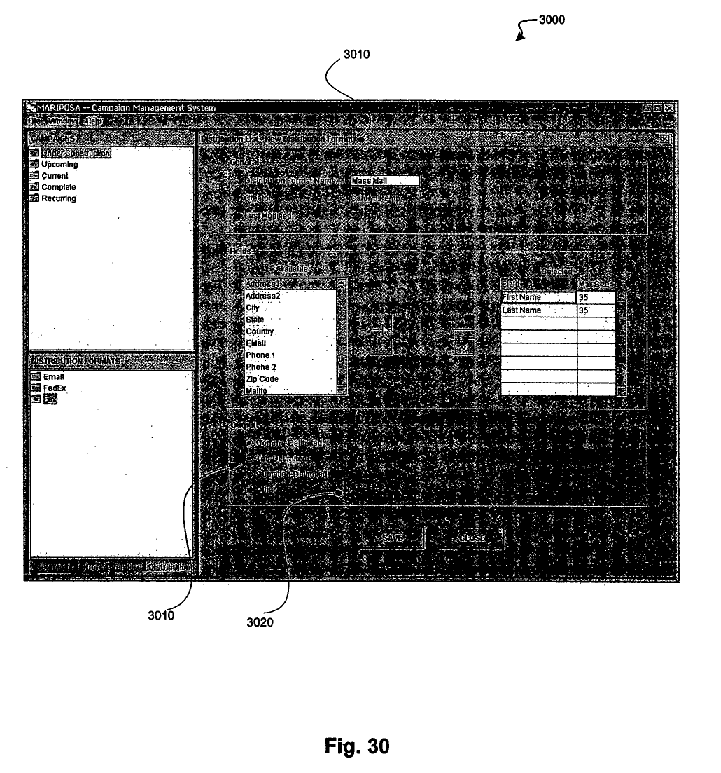

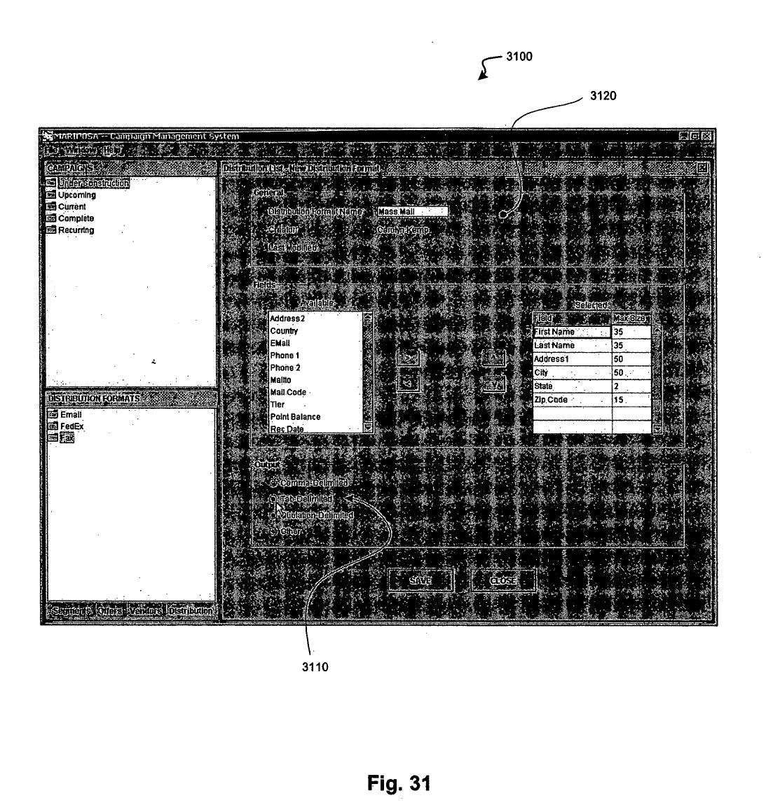

Turning again to FIG. 8, there is shown a flowchart representative of the Offer distribution format creation process 630. The process 630 may be initiated by selecting a Distribution tab 2630 (FIG. 26) from any window relating to the campaign management system. For example, selection of the Distribution tab 2630 could result in display of the user interface window 3000 of FIG. 30. Through the window 3000 a user may open an existing distribution format for viewing and/or editing, create a new distribution format, rename an existing distribution format, and create or rename folders to manage and organize existing distribution formats. In particular, through a New Distribution Format panel 3010 a user may create or edit distribution formats by adding or deleting fields, entering the maximum size allowed for particular fields, and place the fields in the desired order (step 842). Then, using an Output sub-panel 3020, the user selects the preferred delimiter for the chosen format (step 846). Radio buttons 3010 on the sub-panel 3020 allow a user to choose the delimiter for the distribution format, with comma-delimited being the default selection in the exemplary implementation. The selection of “Other” enables the Char-Delimited field, which allows the user to enter one letter as a delimiter.

If it is determined to keep the distribution format which has been created (step 850), the format is stored as an available distribution format 854 for later use in the campaign export process (step 856).

Additional details regarding the various fields within a General sub-panel 3120 of the distribution format windows of FIGS. 30-31 are set forth in Table VI. Similarly, further description of the fields of the Offer Details sub-panel 2718 are given below in Table VII.

TABLE VI

| Field of General | |
|---|---|
| Sub-Panel | Description |
| Distribution List | Distribution List Name is a text field in which the user |
| Name | assigns a name to the particular distribution list. |
| Creator | Creator is a non-editable text field which is |
| | automatically populated based upon login |
| | information supplied by the creator of the |
| | distribution format. |
| Last Modified | Last Modified is a non-editable text field which |
| | auto populates based on the last time the format |
| | was saved with changes. |

TABLE VII

| Field of Fields Sub- | |
|---|---|
| Panel | Description |
| Available | Available is a database-populated list of all |
| | available fields. These fields are used to create |
| | a template for the Distribution Format. Upon |
| | selection of a field from the list, the user will click |
| | the > to move that field into the Selected table, |
| | simultaneously removing it from the list. |
| Selected | This list constitutes all fields selected by the |
| | user. A user may remove a field from the |
| | Selected table by clicking on <. At the |
| | same time as the removal, that field is |
| | added back into the Available list. |
| | The user may move the fields in the Selected |
| | table up and down as required, using the [symbol] |
| | and v buttons, thereby changing the order in |
| | which the distribution format is later returned |
| | when exported to a file. |

F. Vendors

Again referring to FIG. 8, there is shown a flowchart representative of the Vendor creation process 640. In the exemplary implementation each Vendor corresponds to a commercial vendor of materials or services used in the execution of a campaign. For example, a Vendor may be utilized for printing or otherwise producing brochures distributed through one or more channels in connection with execution of a campaign.

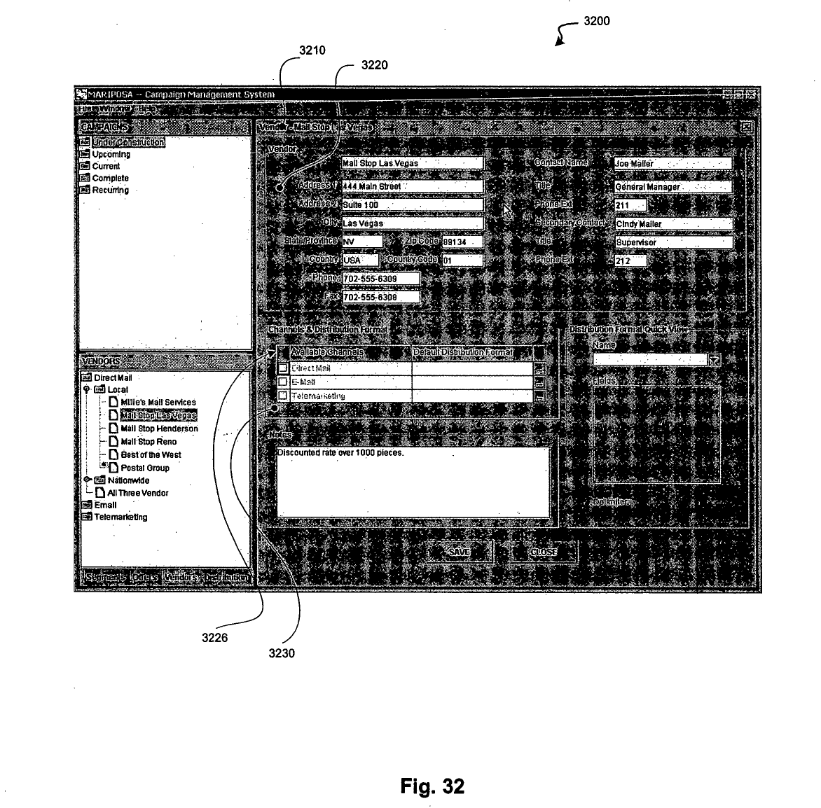

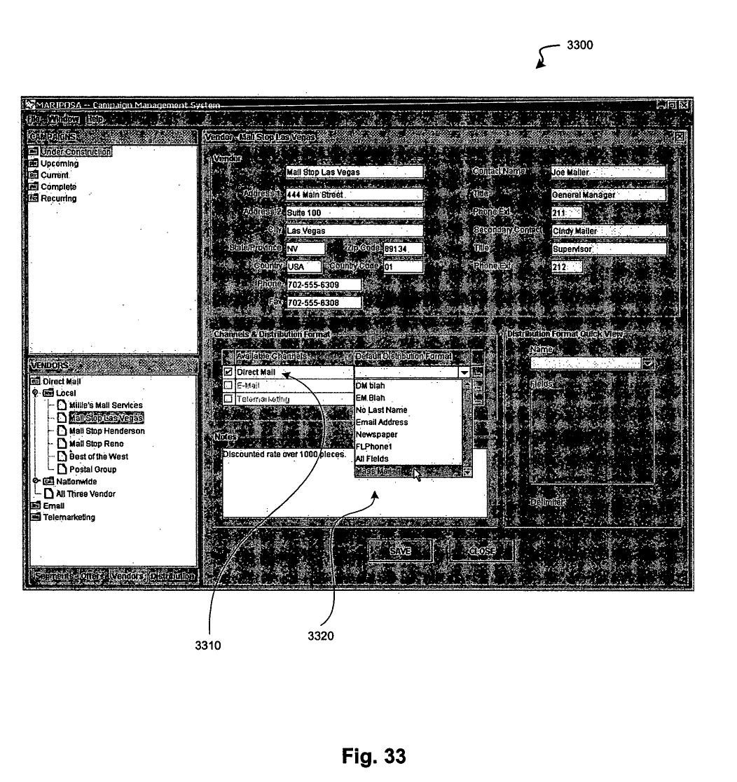

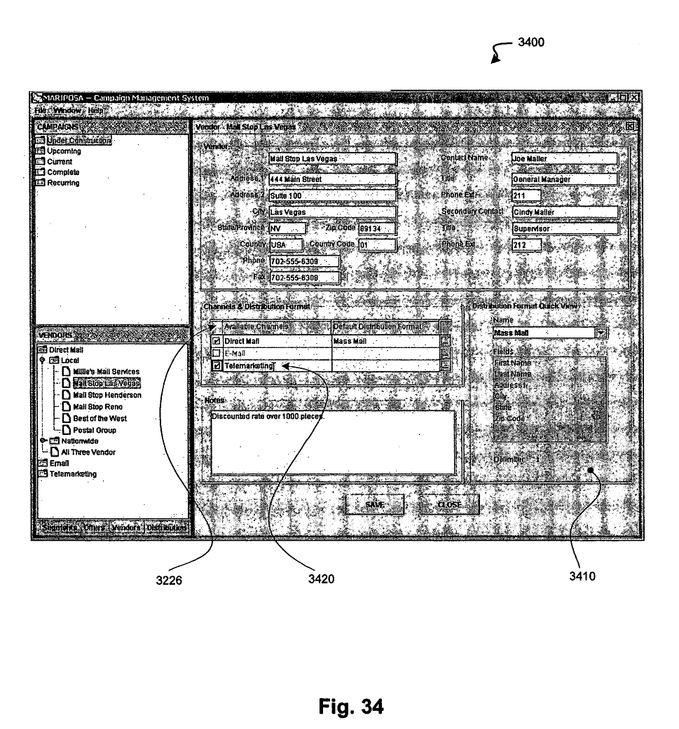

The Vendor creation process 640 may be initiated by selecting a Vendor tab 2640 (FIG. 26) from any window relating to the campaign management system, which results in display of a user interface window 3200 such as that depicted in of FIG. 32. Through the window 3200 a user may open an existing Vendor for viewing and/or editing, create a new Vendor, rename Vendors, and create or rename folders to manage and organize existing Vendors. In particular, through a Vendor panel 3210 a user may create or edit Vendors by specifying contact information, indicating the Vendor's format preferences, and adding notes regarding the Vendor (step 860). An Available Channels table 3226, generally dynamically created based upon the number of marketing channels in the CMS database 116, is disposed within a Channels and Distribution Format sub-pane 3230. Users can select those marketing and fulfillment channels that the Vendor is capable of handling (step 864), each of which is associated with a default distribution format specifying the format/style preferred by the Vendor (step 868). The selection of a fulfillment channel is illustrated by the window 3300 of FIG. 33, in which a Direct Mail channel 3310 has been selected. FIG. 33 also indicates that a user is in the process of associating a distribution format from within a drop-down list of distribution formats 3320 with the Direct Mail channel 3310. Referring now to the user interface window 3400 of FIG. 34, it is seen that after a distribution format (i.e., Mass Mail) has been selected from the list of formats 3420, a Distribution Format Quick View panel 3410 is populated with a preview of the selected format. FIG. 34 also indicates that the user is also in the process of selecting Telemarketing 3420 as an additional Available Channel 3226 provided by the Vendor.

If it is determined to keep the Vendor which has been created (step 872), the format is stored as an available Vendor 874 for later use in one or more campaigns (step 876).

Additional details regarding the various fields within the Vendor panel 3210 of the Vendor windows of FIGS. 32-34 are set forth in Table VIII. Similarly, further description of the fields of the Distribution Format Quick View panel 3410 are given below in Table IX.

TABLE VIII

| Field of Vendor | |
|---|---|
| Panel | Description |
| Company Name | The Company Name will be checked against the |
| | database upon saving to ensure its uniqueness. |
| | In the event that the name is already in use, the |
| | validation will lead to a dialog box, which asks |
| | the user if they wish to overwrite the current |
| | information or create a new company. |
| Address1 | The Address1 field will accept all numbers, letters, |
| | apostrophe, pound sign, and a hyphen. |
| | (I.e.: 29 1st Street). |
| Address2 | The Address2 field is not required. It will also |
| | accept all numbers, letters, apostrophe, pound |
| | sign, and a hyphen. (I.e.: #B-34). |
| City | The City field will accept letters, hyphen, and |
| | apostrophe only. |
| State | The State field will accept letters, hyphen, |
| | and apostrophe only. |
| Country | Country will allow input of letters, hyphen, |
| | and apostrophe only. |
| Country Code | The Country Code is a prefix for the telephone |
| | number. Only numbers will be allowed. |
| Phone | Phone will accept hyphens and numbers only. |
| FAX | Fax will accept hyphens and numbers only. |
| Contact Name | Contact Name is not a required field. Contact Name |
| | will accept letters, comma, hyphen, and apostrophe |
| | only. |
| Title | Letters, apostrophe, hyphen, and comma will be |
| | accepted. |
| Phone Ext | Phone Ext is not a required field. |
| Secondary Contact | Secondary Contact is not a required field. It will |
| | enact the same validation as Contact Name. |
| Title | Title is not a required field. |
| Phone Ext | Phone Ext is not a required field. |

TABLE IX

| Field of Quick View | |
|---|---|
| Panel | Description |
| Name | The Name field consists of a dropdown box |
| | populated by the CMS database 116 with all |
| | available distribution formats. The user may choose |
| | a distribution format to view or they may click on |
| | the ellipses button in the table to the left in order to |
| | make a selection. Once a selection is highlighted, |
| | all the fields in that particular distribution format |
| | will populate in the list box below. |
| Delimiter | The delimiter field is a read only text field, which is |
| | populated by the CMS database 116 with the |
| | delimiter associated with the selected distribution |
| | format. |

G. Creating a Campaign

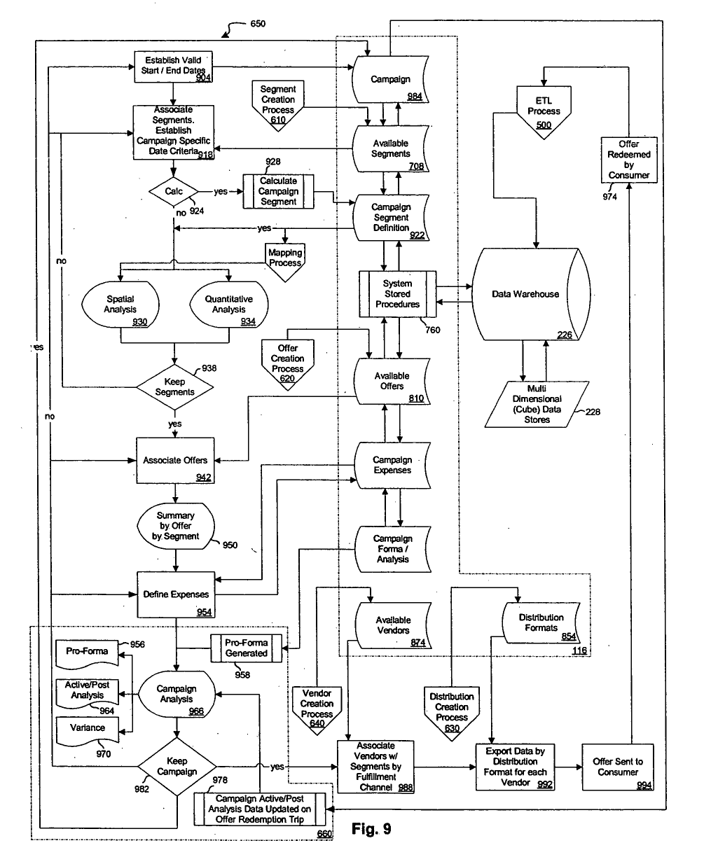

FIG. 9 is a flowchart illustrating the campaign creation process 650. As shown, the interaction occurring with the CMS database 116 and data warehouse 226 during the campaign creation process is also illustrated in FIG. 9 in order to more fully elucidate this process. As may be appreciated with reference to FIG. 9, the CMS database 116 provides a first or “local” repository of information that is populated by the data warehouse 226. In the exemplary implementation the functionality of the campaign management system is effected though execution of program instructions stored within the CMS module 220 and the CMS client module 354.

As was discussed above, the data warehouse 226 is filled via the extraction, transformation and load process (ETL) 500 of FIG. 5..

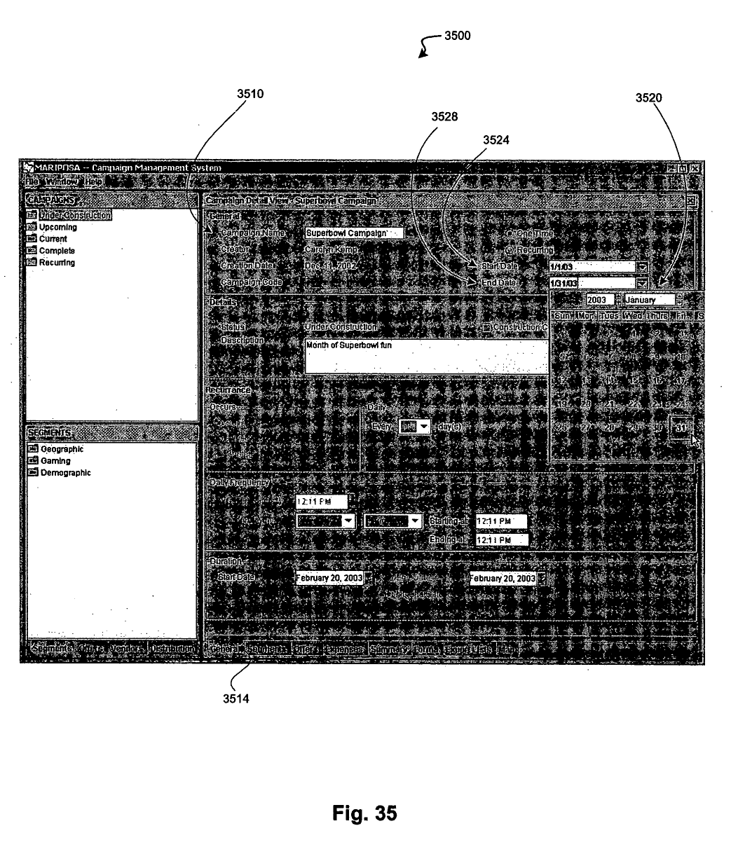

A first step 904 in creating a campaign is to establish a valid start date, end date, and name for the campaign. In the exemplary implementation the start date for the campaign may correspond to the date upon which promotional materials for the campaign are distributed to existing and/or potential patrons, or any other date in some way corresponding to the beginning of the campaign. The establishment of campaign start/end dates is illustrated by the user interface window 3500 of FIG. 35, in which a user has entered a name for the campaign in a Campaign Name field 3510 after selecting the General tab 3514. In addition, the user has utilized a drop-down calendar 3520 to facilitate entry of campaign start/end date information into a Start Date field 3524 and an End Date field 3528, respectively. As is indicated by FIG. 35, a campaign may also be further defined by entry of appropriate information into a Campaign Code field 3532, Description field 3536, and a Creator field 3540. When a campaign's Start Date is reached, the campaign is tagged as active and certain attributes can no longer be modified. Additionally, active and completed campaigns have actual redemption activity associated with them, whereas campaigns in creation stages are characterized by only proforma redemption metrics.

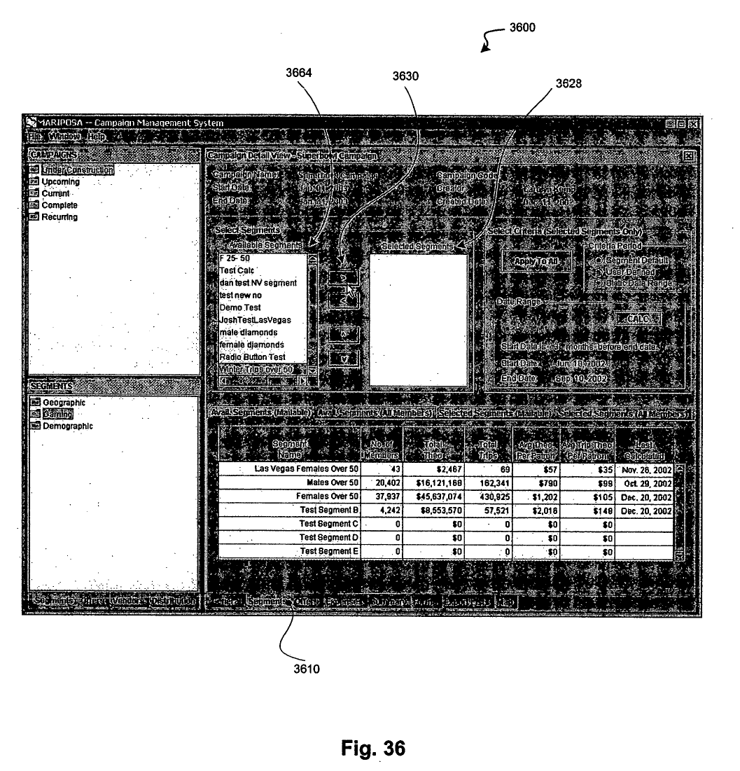

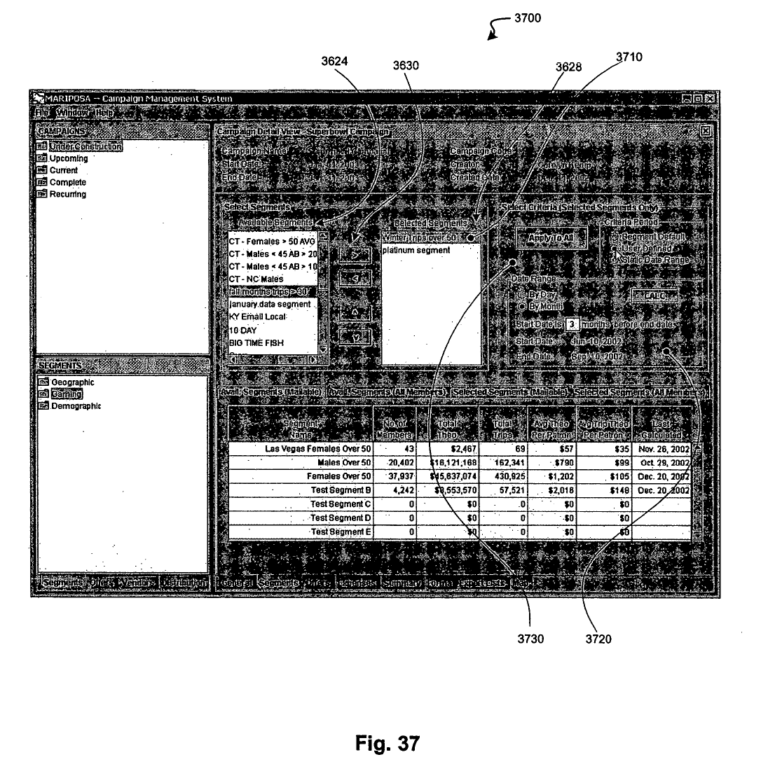

Any number of Segments are chosen from the Available Segments 708 and associated with the campaign (step 918). This process is illustrated by the user interface window 3600 of FIG. 36, which is displayed upon selection of a Segments tab 3610. As shown, the window 3600 includes a Select Segments panel 3620 containing an Available Segments list 3624 and a Selected Segments sub-panel 3628. In the example of FIG. 36, a user is in the process of associating a Segment from the Available Segments list 3624 with the current campaign (i.e., the campaign having a Campaign Name of “Superbowl Campaign”). Segments are selected from the Available Segments list 3624 and added (associated) to the current campaign by use of the arrow buttons 3630. In the user interface window 3700 of FIG. 37, which illustrates the user interface window 3600 of FIG. 36 as it could exist at a later time, the user has highlighted a particular Segment 3710 within the Selected Segments sub-panel 3628. As shown, the user is in the process and of establishing campaign-specific date parameters for this Segment within a Date Range sub-panel 3420 of a Select Criteria panel 3730, thereby yielding a campaign Segment definition 922 (FIG. 9).

Referring again to FIG. 9, once a campaign Segment definition 922 has been determined, the user may elect to calculate a corresponding campaign Segment population (step 924). If so, the campaign Segment population is calculated by applying the campaign Segment definition 922 against the contents of the data warehouse 226 (step 928). Once a campaign Segment population has been calculated, it may be analyzed both spatially (step 930) and quantitatively (step 934).

It is observed that by changing the date range for a Segment definition, corresponding changes accrue in the corresponding Segment population as a different set of patrons will typically qualify relative to the patron set qualifying under the original date range. For example, if a particular Segment definition requires a theoretical win of $1000 over a nine month period, a potentially different set of patrons will be identified by altering the Segment definition to specify a date range spanning one month.

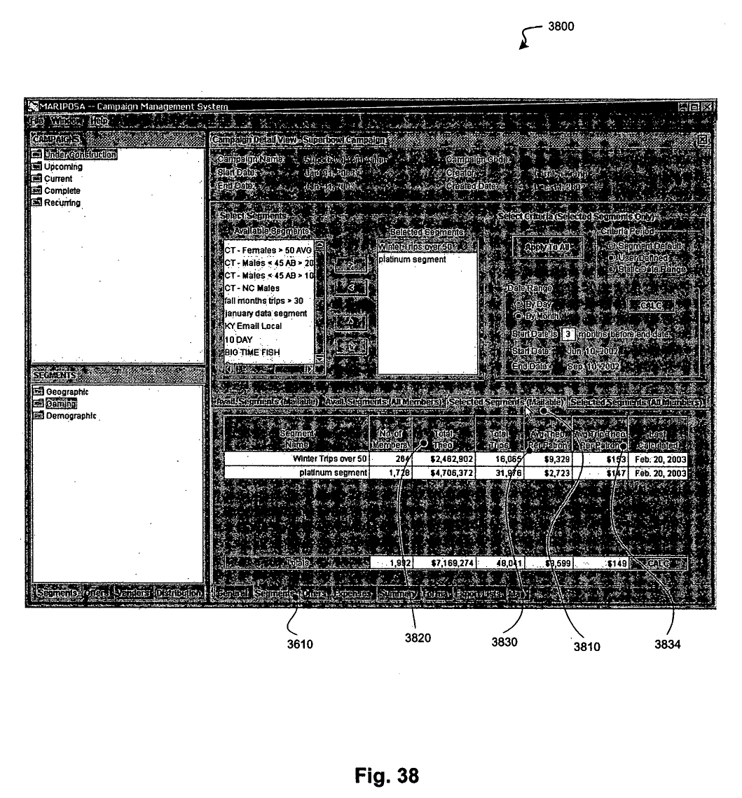

FIG. 38 depicts a user interface window 3800 illustratively representing the type of quantitative analysis which may be effected with respect to selected campaign Segment populations. As is indicated by FIG. 38, a Selected Segments sub-panel 3810 accessible upon selection of the Segments tab 3610 displays various statistical information associated with a pair of campaign Segment populations. These statistics include, for example, total theoretical win 3820 for the Segment population, average theoretical win per patron 3830 within the Segment population, and average theoretical win per patron per trip 3834. It is noted that once a set of potential Segments for a campaign have been selected and the corresponding Segment populations calculated, a prioritization calculation determines the appropriate placement for each member of all the Segments selected. That is, if a patron qualifies for more than one Segment within a campaign, the patron will be placed into the Segment given the highest priority in the system. As a consequence, in the exemplary implementation each Segment population identified within the window 3800 contains a mutually exclusive set of patrons (i.e., individual patrons are not “duplicated” within different Segment populations). This ensures that only a single Offer is distributed to each patron in connection with execution of a given campaign, and places patrons within the most highly “ranked” of the various Segments in which they could be included for a given campaign. Although Segments may be so ranked in any order desired, ranking will often be done on the basis of theoretical win per patron.

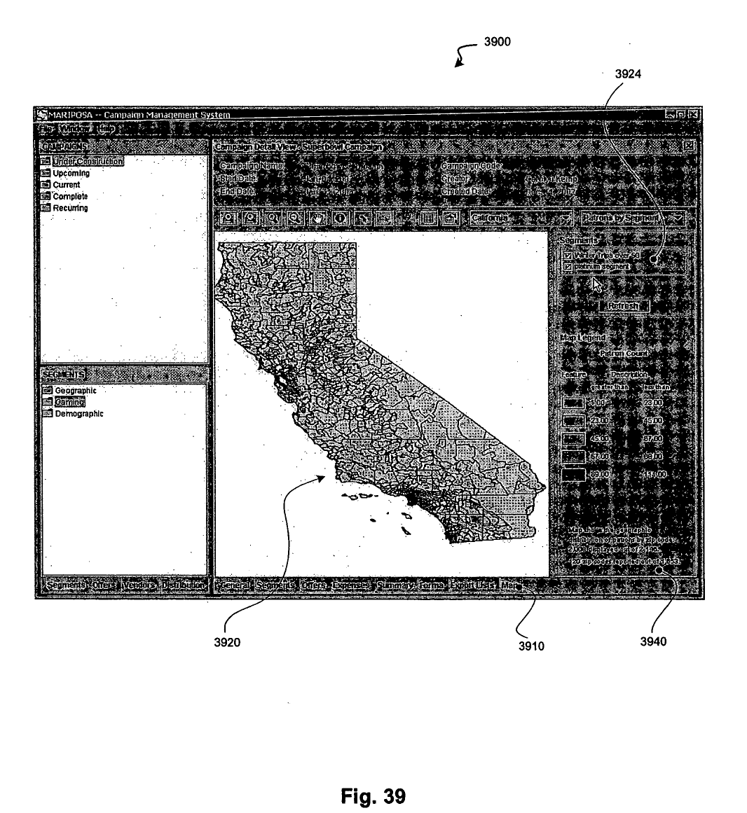

Turning now to FIG. 39, there is shown a user interface window 3900 illustratively representing the type of spatial analysis which may be effected with respect to selected Segment populations. As is indicated by FIG. 39, the window 3900 is displayed upon selection of a Map tab 3910. The map 3920 illustratively represents the geographical distribution of the campaign Segment populations identified within a Segments panel 3924. In the implementation of FIG. 36 the set of population members within a given zip code are aggregated and the composite results for each zip code are displayed. Spatial analysis the map 3920 may be performed by using various mapping tools, as well as by simply viewing it in accordance with the legend information contained within a Map Legend panel 3940. The quantitative and spatial analysis window 3800 and 3900 permit a user to evaluate various economic attributes of a given Segment population, which facilitates determination of whether to actually include the corresponding Segment definitions within the campaign under development.

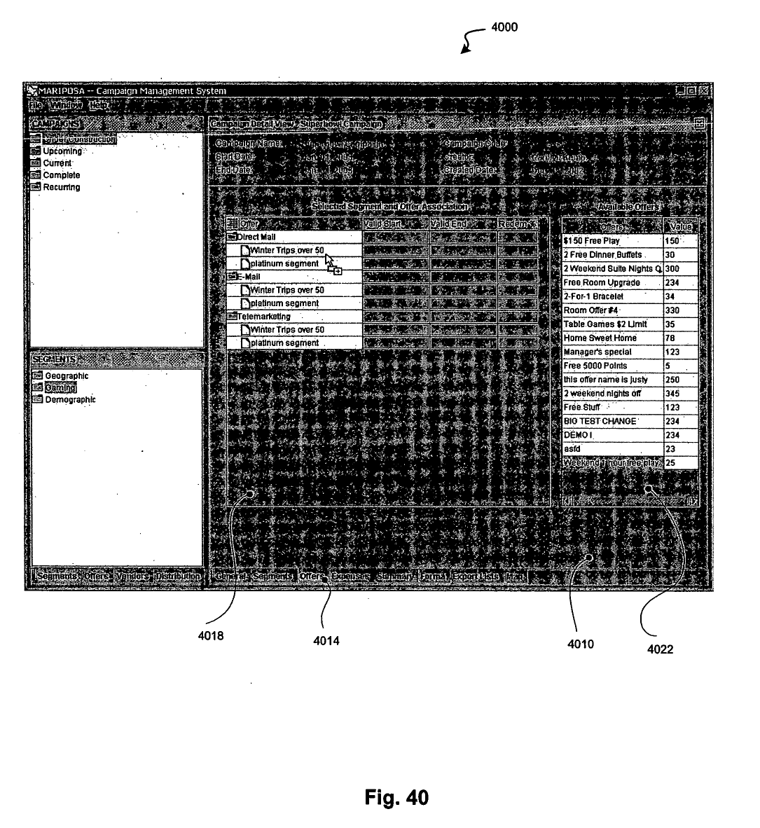

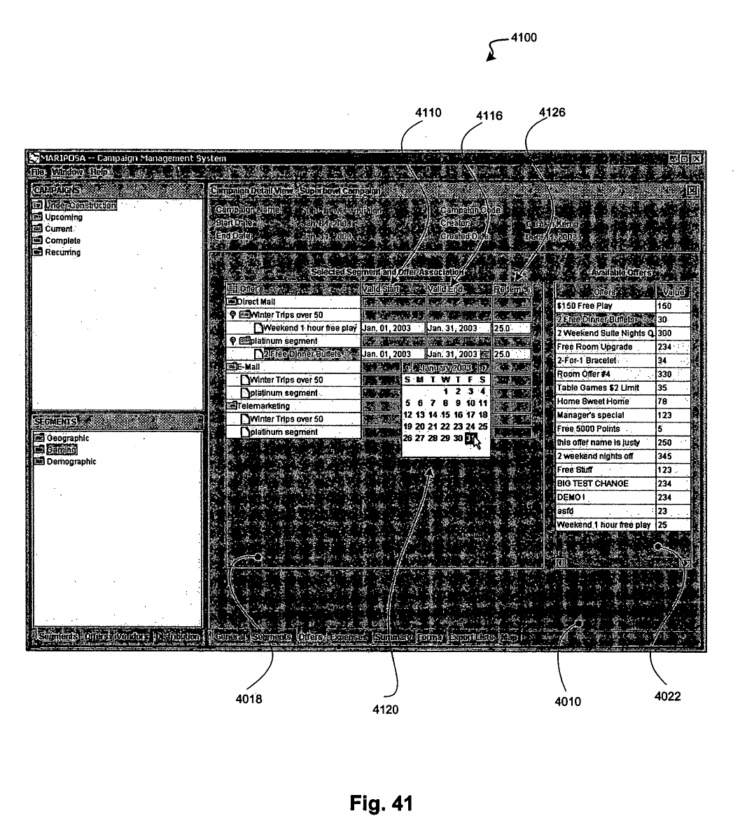

Once a set of one or more Segments have been selected for inclusion within the campaign (step 938), any number of predefined Offers can be associated with each Segment (step 942). FIG. 40 shows a user interface window 4000 containing a primary panel 4010 displayed upon selection of an Offers tab 4014. As shown, the primary panel 4010 includes a Selected Segment and Offer Association sub-panel 3718 and an Available Offers list 4022. In the example of FIG. 40 a user is in the process of associating Offers from the Available Offers list 4022 with the individual Segments of the open campaign identified within the Selected Segment and Offer Association sub-panel 4018. This is shown as being effected by selecting an Offer from the Available Offers list 4022 and “dragging and dropping” the selected Offer onto a Segment in the sub-panel 4018 in order to perform the association. As shown within a user interface window 4000 of FIG. 40, other attributes may then be associated with the Offers copied to the sub-panel 4018. For example, in the implementation of FIG. 40 a period of time during which a given Offer may be redeemed can be set by specifying a Valid Start date 4110 and a Valid End date 4116 using a drop-down calendar 4120. An expected redemption percentage 4126 during the specified redemption period may also be entered. In order to facilitate estimation of redemption rates, the data warehouse 226 may be configured to support the training of predictive models utilizing, but not limited to, cluster and decision tree modeling protocols. To the extent available, users may utilize such predictive models to associate redemption rates with Offers within a campaign.

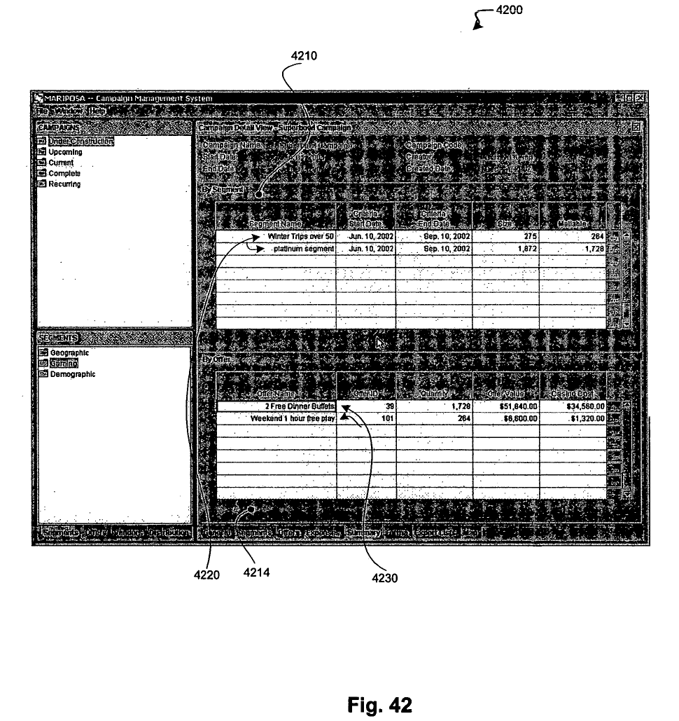

Once an Offer has been associated with each Segment of a campaign, a summary of statistical information characterizing each Offer and Segment of a campaign may be viewed (step 950). This is illustrated by the user interface window 3900 of FIG. 42, which is seen to include a By Segment summary panel 3910 and a By Offer summary panel 4214. As shown, the By Segment summary panel 4210 provides certain statistical information relating to the various Segments 4220 of the applicable campaign. Similarly, the By Offer summary panel 4214 provides various statistics pertinent to the Offers 4230 of the campaign.

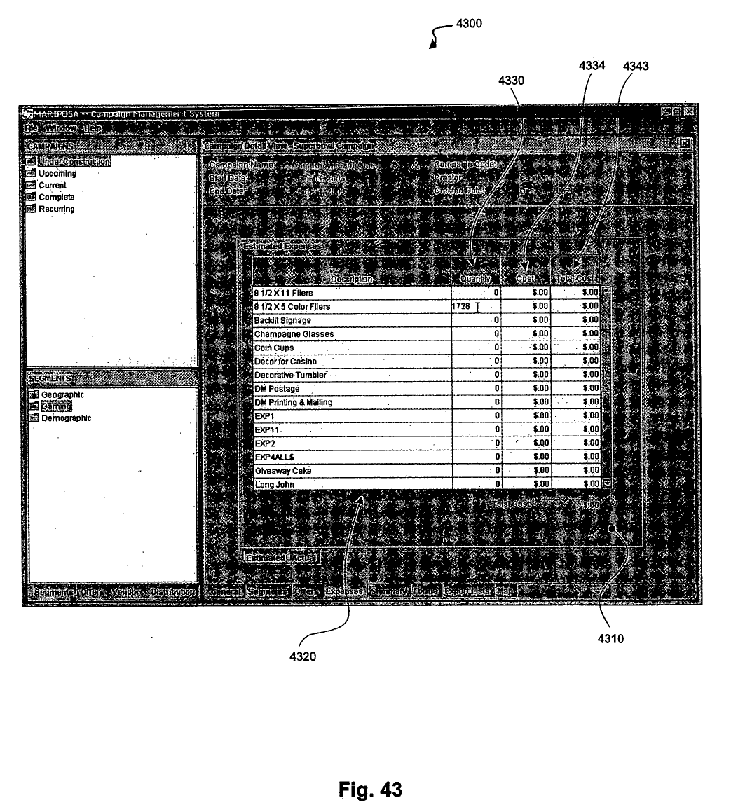

Turning now to FIG. 43, there is shown a user interface window 4300 containing an Estimated Expenses panel 4310 through which various expense items may be associated with a campaign (step 954). The expenses entered via the worksheet 4320 within the Estimated Expenses panel 4310 frequently correspond to those additional expenses or “hard costs” associated with execution of a promotional campaign; that is, to those costs ancillary to the inherent costs of the Offers extended during execution of the campaign. For example, such additional expenses could comprise the costs of television or print advertising, mailing costs, printing costs and the like, but would not include the cost to a casino of offering a free night of accommodations through a particular Offer. In FIG. 43, a user is shown entering a value with a Quantity field 4330 of the expenses worksheet 4320, and will then enter a value within a Cost field 4334. A total cost value will then be calculated and appear within the corresponding Total Cost field 4340. The expense items occupying the rows of the worksheet 4320 can be added and removed by means of a right-click context menu (not shown). Although it is assumed that estimated costs are being entered within the worksheet 4320, at the conclusion of the applicable campaign actual expenses could subsequently entered in a different portion of the worksheet 4320 (not shown).

In a particular implementation the development of a promotional campaign is considered complete and amenable to a pro forma analysis when all Segments, channels, Offers, redemption rates, Vendors, expenses and distribution formats have been defined. Once these definitions have been completed, the expected pro-forma results 956 of the campaign may be generated (step 958). As is discussed below, the results 962 of this pro-forma analysis may be analyzed in conjunction with, or independently of, the active/post campaign performance data 964 resulting from the actual execution of the campaign itself (step 966). Specifically, once a campaign has begun to be executed (i.e., is active), the active campaign performance data 964 may be compared to the pro-forma results 956, while the post campaign performance data 964 may be compared to the pro-forma results 956 at the conclusion of the campaign. A variance 970 between the pro-forma results 956 and the active/post campaign performance data 964 may be determined in connection with each comparison.

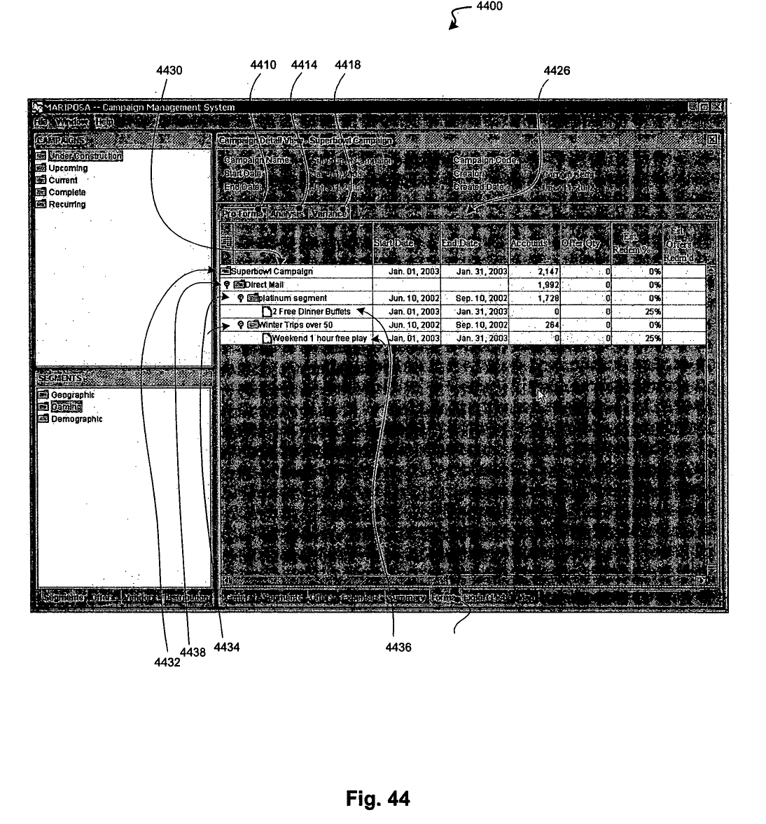

FIG. 44 depicts a user interface window 4400 containing a used for quantitative analysis of a campaign. As shown, the user interface window includes a Pro-Forma tab 4410, an Analysis tab 4414 and a Variance tab 4418, with the Pro-Forma tab 4410 having been selected in the implementation of FIG. 44. Selection of these tabs results in population of the window 4400 with the pro-forma results 956, the active/post campaign performance data 964, and the variance 970, respectively. After a campaign has been launched, data relating to the redemption of Offers during patron trips to the applicable casino or other gaming establishment, i.e., “redemption trip data” (step 974) is used in subsequent campaign analysis (step 978). The variance 970 is also updated in association with updating of the active campaign performance data 964 which occurs in response to each iteration of step 978.

Referring to FIG. 44, a results table 4426 is displayed upon selection of the Pro-Forma tab 4410. In the exemplary implementation similar results tables are displayed upon selection of the Analysis tab 4414 and the Variance tab 4418. As shown, a first column 4430 of the results table 4426 includes various objects comprising a significant portion of the applicable campaign 4432 (e.g., Segments 4434, Offers 4436, distribution channels 4438). An Accounts column 4450 provides an indication of the raw counts associated with each object, while an estimated redemption percentage column 4452 indicates the redemption percentage estimated for the Offers objects 4436.

If the pro-forma results 956 generated on the basis of a given campaign definition are deemed acceptable, it may be determined to keep the campaign (step 982). If not, and as is indicated by FIG. 9, essential any aspect of the campaign definition may be modified. For example, different Segments may be used, different Offers may be associated with different Segments, and/or the campaign expense structure may be modified. If it is decided that the campaign is acceptable, the information defining the campaign (e.g., Segments, Offers, Vendors, distribution formats) is stored within the CMS database 116 as a campaign definition 984. In addition, the Vendors for the campaign are associated with the Segments of the campaign as a function of fulfillment channel (step 988).

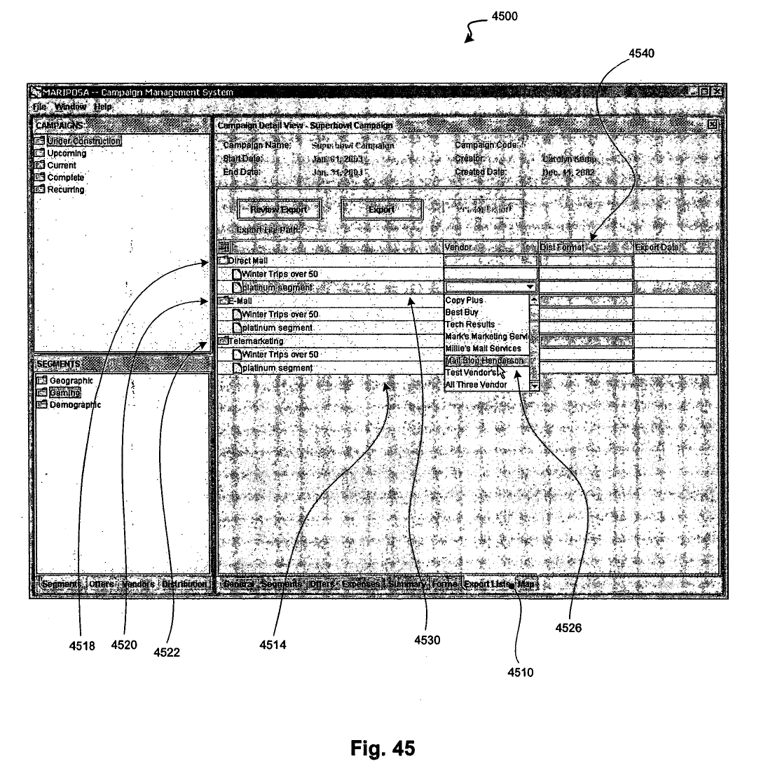

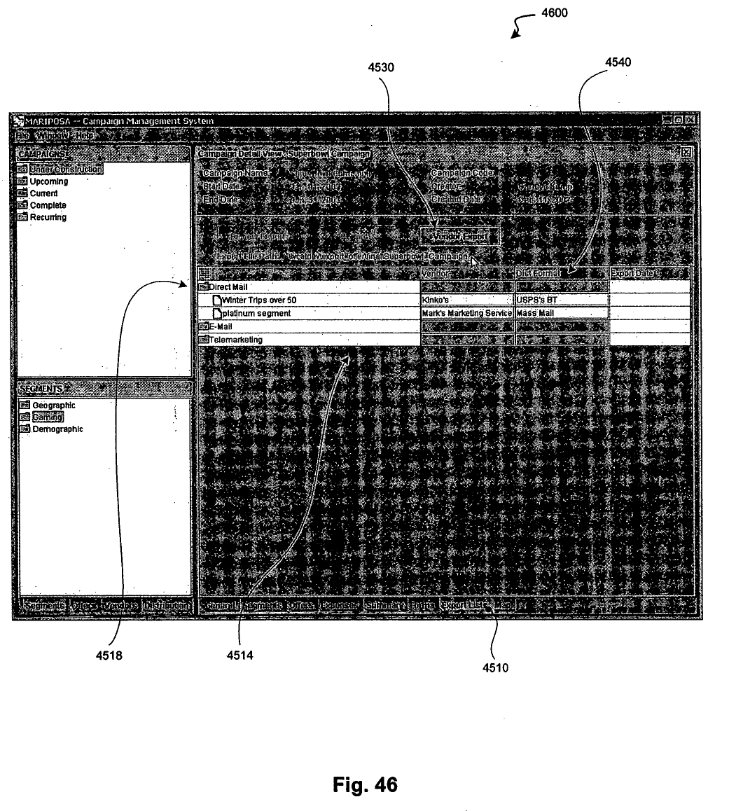

Referring now to FIG. 45, a user interface window 4500 is shown in which a Vendor is being associated with a Segment for a particular Offer fulfillment channel. In particular, selection of an Export Lists tab 4510 results in display of a file export table 4514 organized as a function of fulfillment channel. As shown, the rows of the file export table 4514 are divided into groups corresponding to the fulfillment channels of Direct Mail 4218, E-Mail 4520 and Telemarketing 4522. In the example of FIG. 42, a particular Vendor 4226 is being associated with Segment 4530 for purposes of Direct Mail 4520 fulfillment; that is, Vendor 4526 will distribute Offers to members of Segment 4530 via direct mail. Once this association has been effected, a format for distribution (i.e., Dist Format 4540) via the Direct Mail 4518 fulfillment channel will be chosen.

Referring again to FIG. 9, once Vendors and distribution formats have been selected, the data defining a given campaign is exported in files to the applicable Vendors in the selected distribution formats (step 992). In particular, one file is sent to each Vendor for each Segment/channel combination. FIG. 43 is a user interface window 4600 which again depicts the file export table 4514, which is displayed upon selection of the Export Lists tab 4510. As shown, since both a Vendor 4610 and a Distribution Format 4540 have been specified for each Segment within the Direct Mail 4518 category, the user has chosen to export the corresponding data to files by selecting a Vendor Export button 4530. In the exemplary implementation the file for each fulfillment channel includes data (e.g., name, account number, address) for the patrons included in the applicable Segment that is arranged in accordance with the selected distribution format. These files are then sent to the applicable Vendors for fulfillment, which appropriately process them and forwards the specified Offers to patrons or other consumers (step 994).

As mentioned above, as Offers are redeemed by patrons or consumers via one or more transactional systems (step 974), the corresponding redemption events are recorded in the applicable transactional databases 108 and subsequently transferred to the data warehouse via the ETL process 500. The CMS database 116 then recognizes the redemption record and updates the campaign attributes 984 to include the redemption event and any associated records appropriate for the completion of a financial performance analysis 966 vis-á-vis the proforma financials. In addition, Offer performance records can be further utilized to train predictive models for use in future campaigns.

H. Data Process Visualization

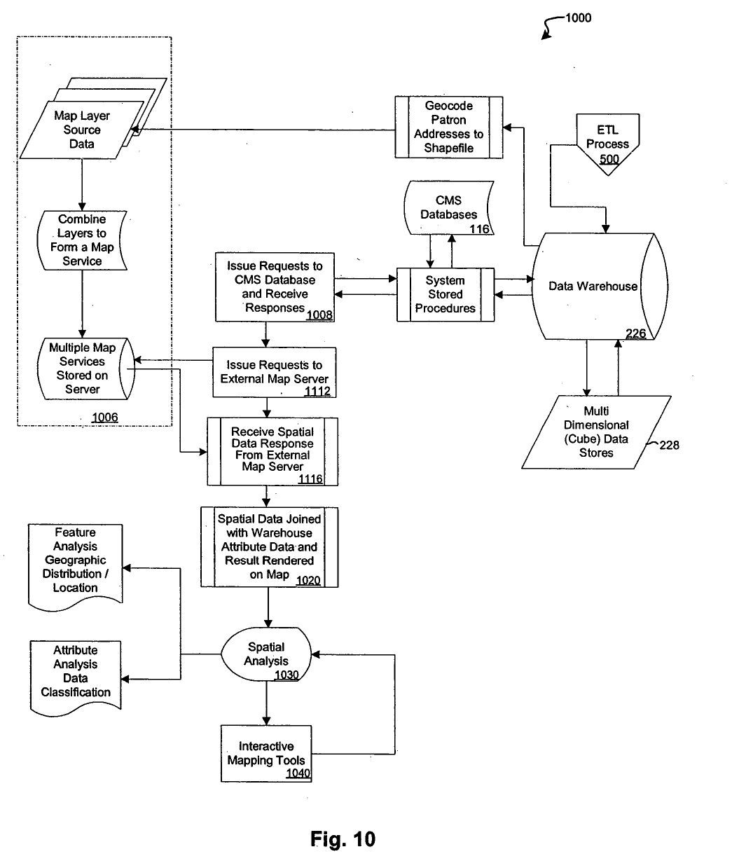

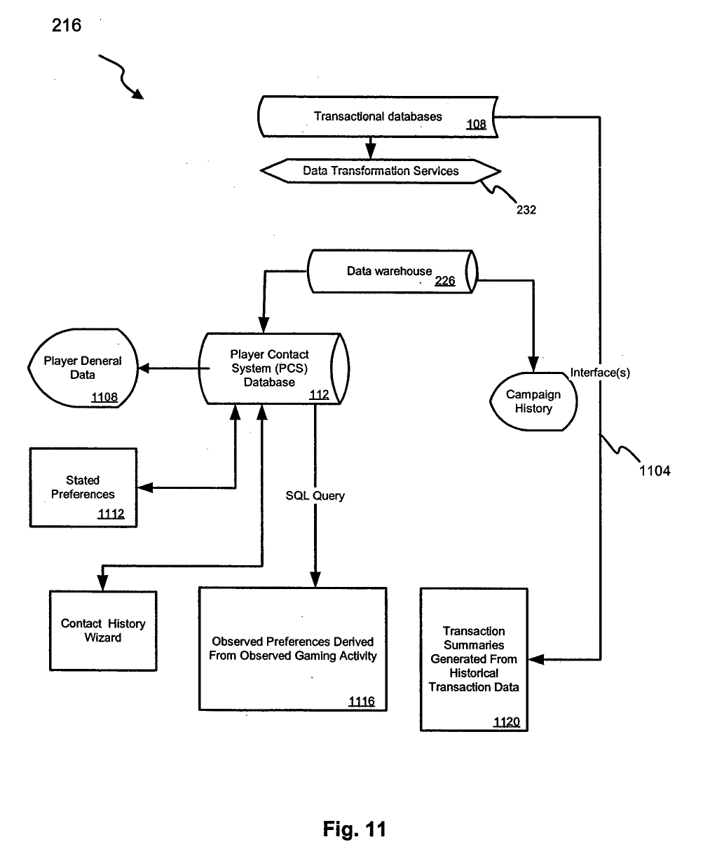

FIG. 10 is a flowchart illustrating a data visualization process 1000. In the implementation of FIG. 10, it is contemplated that the process 1000 will be executed primarily by the CMS module 220 and the CMS client module 354. As shown, the interaction occurring with the CMS database 116, data warehouse 226 and an external mapping server 1006 during the data visualization process is also illustrated in FIG. 10 in order to more fully elucidate this process. In the exemplary implementation the data visualization process 1000 may be utilized in connection with providing a visual representation of the geographic distribution of members of an individual Segment or of the collection of Segments included within a campaign.

In one implementation the external mapping server 1006 may be commercially operated by a third party engaged in providing geographic information systems (GIS) and other mapping services to Internet-enabled client browsers. For example, ESRI (http://www.esri.com/software/arcims/index.html) operates an ArcIMS Server which facilitates access to, and interaction with, Internet mapping and GIS data from a Web browser.

Referring to FIG. 10, the data visualization process 1000 is initiated through issuance of a request to the CMS database 116 for data relating to a Segment or set of Segments within a campaign (step 1004). Once this data has been received or pending its receipt, the external mapping server 1006 is queried (step 1012) and geographic information concerning the identified area is returned (step 1016). The returned geographic data is then joined with the data received from the CMS database 116 and/or data warehouse 226 that is specific to the Segment or collection of Segments of interest (step 1020). At this point the resultant geographic representation of the Segment data may be spatially analyzed in the manner described below (step 1030).

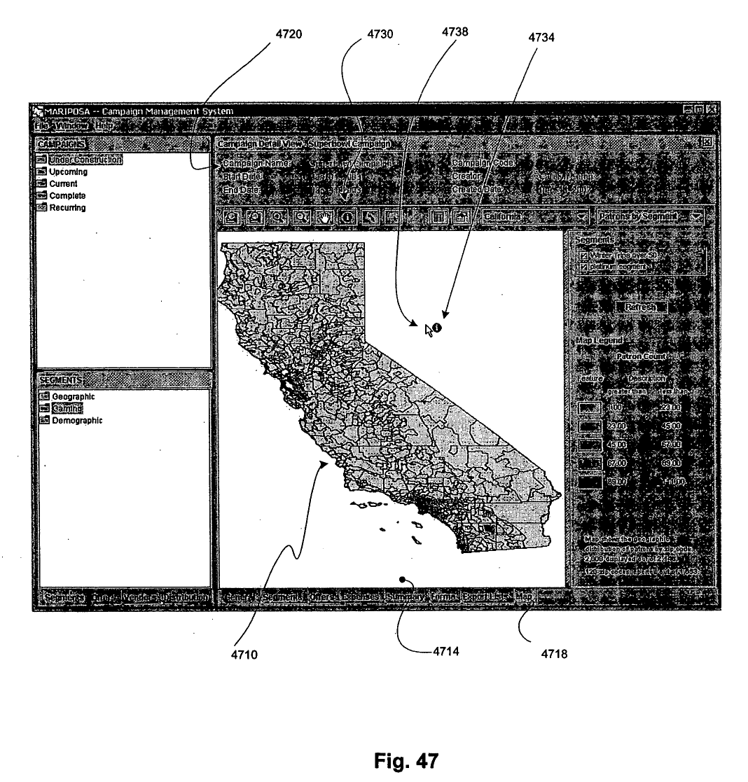

FIGS. 47-49 depict user interface windows through which certain aspects of spatial analysis of mapped Segment data may be performed. In each of FIGS. 47-49, mapped Segment data 4710 is displayed within a primary panel 4714 exhibited upon selection of a Map tab 4718. In the exemplary implementation the mapped Segment data 4710 comprises a geographic representation of the patrons comprising the Segments of the campaign having a Campaign Name 4720 of “Superbowl Campaign”..

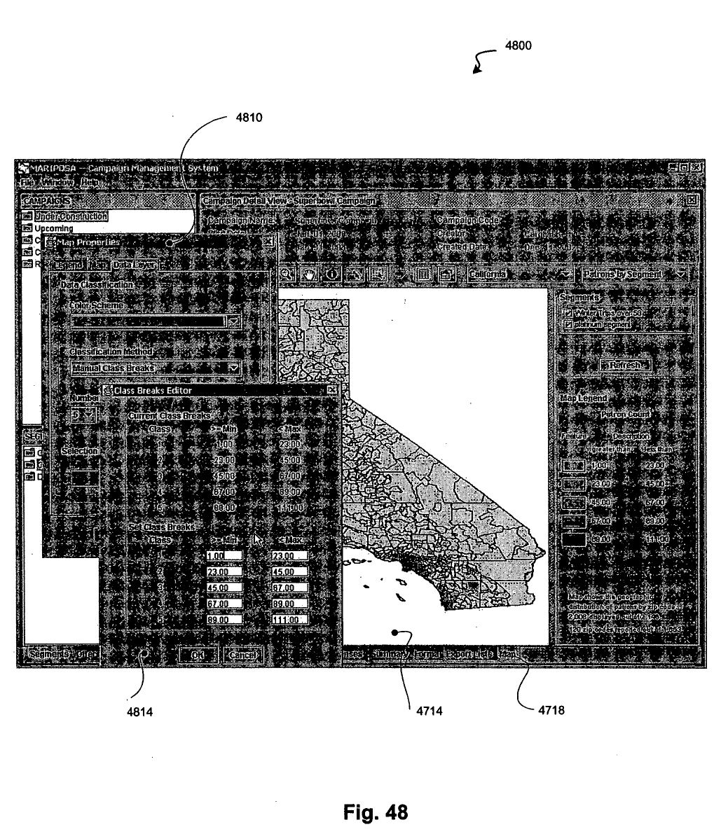

Turning now to FIG. 47, a user has selected an Identify tool 4430 in connection with viewing of the mapped Segment data 4710. The selection of the Identify tool 4730 is further indicated by the icon 4734 proximate the displayed cursor 4738. As is illustrated by the user interface window 4700 of FIG. 47, the Identify tool 4730 may be used to obtain detailed information concerning an attribute of the mapped Segment data 4710. Specifically, clicking upon the mapped Segment data 4710 causes a dialogs to appear, which will generally consist of a table containing general and statistical data relevant to the attribute. In the case of FIG. 48, a Map Properties dialog 4810 and a Class Breaks Editor dialog 4814 have been opened. The Class Breaks Editor dialog 4814 may be used to create manual class breaks as the data classification method for the mapped Segment data 4710 in its entirety, and provides one example of the interactive nature of the mapping process.

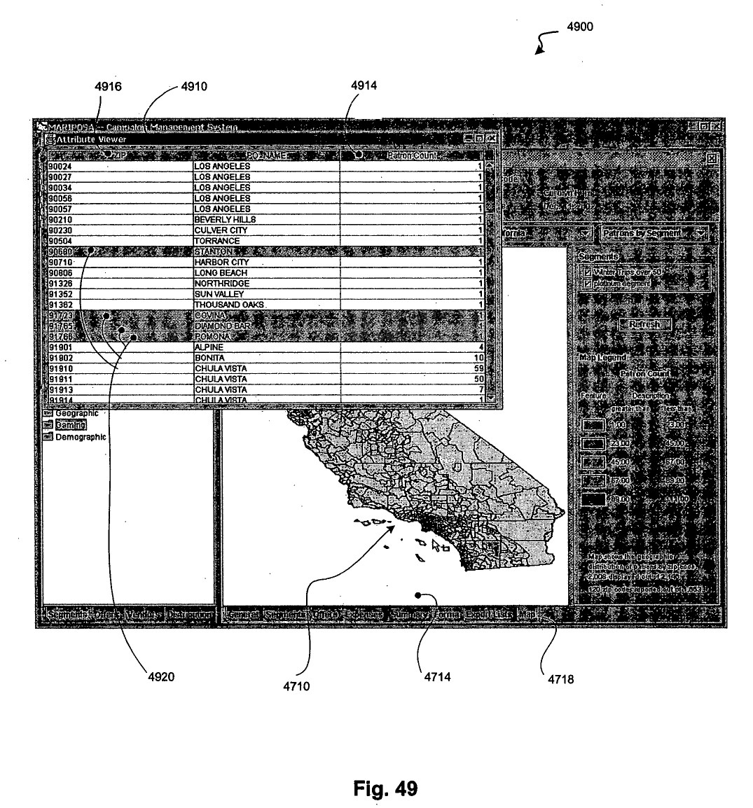

Referring now to the user interface window 4900 of FIG. 49, a user has utilized one of the selection tools (not shown) to open an Attribute Viewer window 4910 comprising an attribute table characterizing the mapped Segment data 4710. The attribute table provides an indication of the number of patrons, i.e., Patron Count 4914, as a function of ZIP code 4916. Within the attribute table, highlighted rows 4920 correspond to geographic features highlighted on the mapped Segment data 4710.

FIG. 10 also indicates that the results of the spatial analysis of the mapped Segment data (step 1030) may also be used to create one or more reports. For example, in the implementation of FIG. 10 a Feature Analysis report 1050 and an Attribute Analysis report 1054 may be generated. In this regard the attribute table displayed within the Attribute Viewer window 4910 exemplifies that type of data which could form the basis of an Attribute Analysis report 1054. In contrast, a Feature Analysis report 1050 is typically intended to provide a visual representation of the geographic distribution and location of the patrons within one or more Segments. Accordingly, information in the form of, for example, the mapped Segment data 4710 may be used in creating a Feature Analysis report 1050.

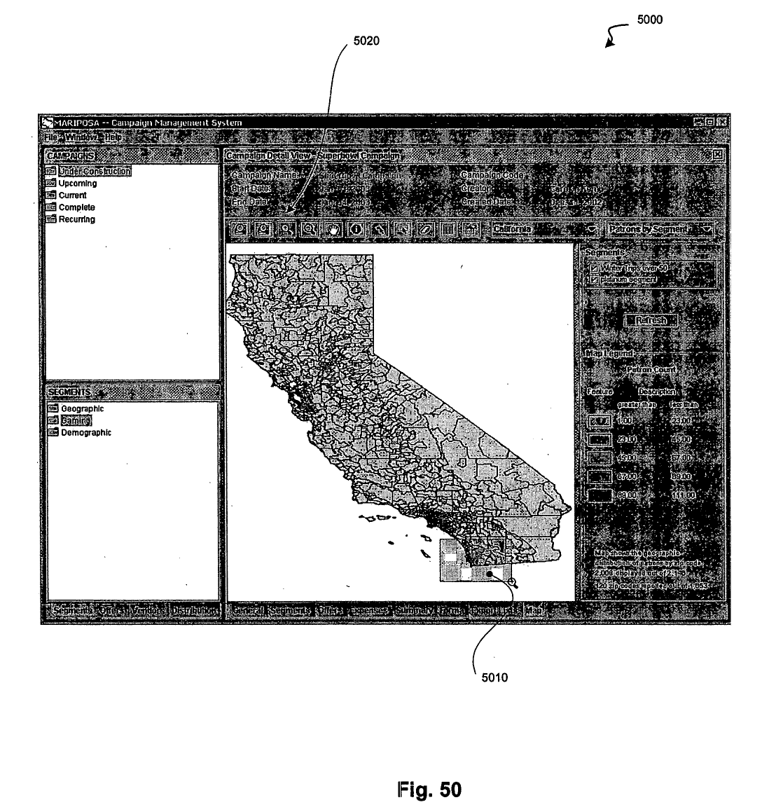

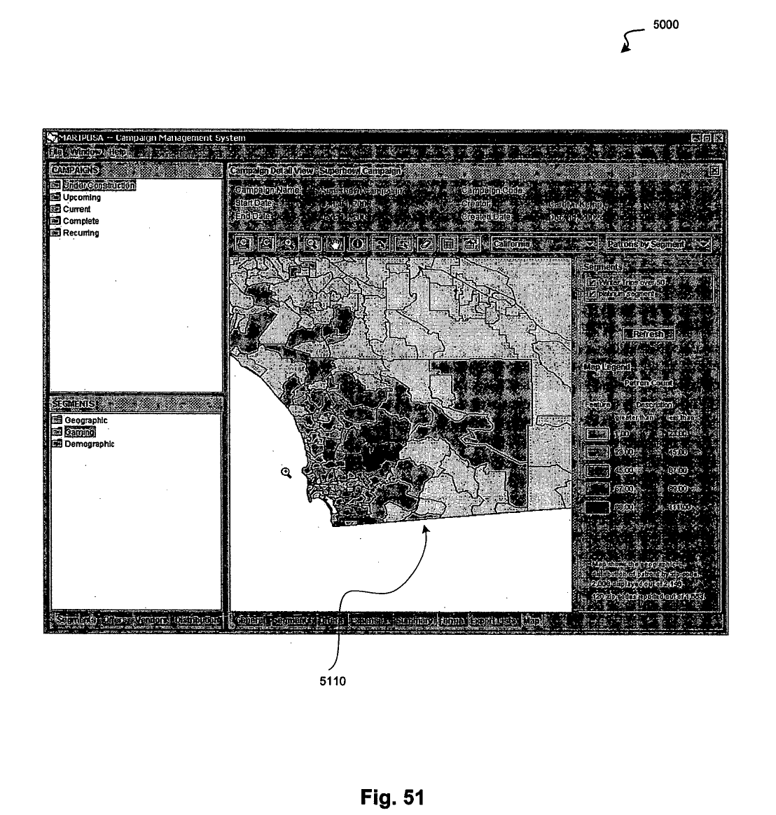

As is indicated by FIG. 10, in addition to being spatially analyzed the mapped Segment data 4710 may be scrutinized from differing perspectives using interactive mapping tools (step 1040). For example, FIG. 50 shows a user interface window 5000 through which a user is defining the coverage of an extent 5010 by clicking and dragging with using a zoom-in tool 5020. Once the extent 5010 has been defined and then selected for viewing, it is transformed into the new map 5110 within the user interface window 5100 of FIG. 51.

III. Player Contact System (PCS)

A. Overview

The PCS module 216 of the system 100 is designed to provide a mechanism for system users (e.g., the staff of a casino) to identify, manage and analyze relationships with valued customers or potential patrons. As is described hereinafter, the deployment of the PCS module 216 in conjunction with the data warehouse 226 is believed to be unique and to offer the advantages of providing greater access to detailed historical data (i.e., finer data granularity) and of reducing the load on the underlying transactional systems (as represented by the transactional databases 108). In addition, this reduced loading of the underlying transactional systems is believed to enhance the performance of the system 100.

FIG. 11 provides a simplified illustrative representation of certain aspects of the structure and function of the PCS module 216 relative to other components of the system 100. During operation of the PCS module 216, historical and otherwise “pre-processed” data may be obtained from both the dedicated PCS database 112 and the data warehouse 226. In contrast; any required “real time” data is retrieved via interface 1104 from transactional databases 108. In order to determine the extent of any requirements for such real time data, the PCS module 216 queries the transactional databases 108 (e.g., upon user access of the PCS module 216) in order to determine if a user account being accessed has had activity since the last update of the data warehouse 226; if so, the PCS module 216 requests and obtains the updated information as needed during the session via interface 1104. If there has been no activity on the applicable user account recorded in the transactional databases 108 since the last update of the data warehouse 226, the PCS module 216 pulls, data exclusively from the data warehouse 226. This configuration significantly reduces load on the underlying transactional system (as represented by transactional databases 108) and enables access to a broader range of historical data than would otherwise be obtainable from a conventional transactional system.

In certain implementations the PCS module 216 may be configured to operate in the absence of data warehouse 226. However, in such implementations it is anticipated that the granularity of the data available would be more coarse than that furnished in configurations including a data warehouse. The PCS module 216 preferably includes “plug-and-play” configurability, so that the existence of the warehouse 226 can be identified at installation or modified to “point” to the warehouse 226 if it is subsequently added to the system 100.

B. Player General Data

A patron general data component 1108 comprises a repository of information with respect to patrons which have registered with an underlying transactional system (e.g., a system operated by a casino) and thus are known to one or more of the transactional databases 108. In the exemplary implementation, the patron general data component 1108 includes at least the following information for each tracked patron or customer: account number, name(s), address and phone number. Related geographic and other demographic data may also be included to the extent available from the applicable transactional database 108.

C. Stated Preferences

A stated preferences component 1112 comprises a plurality of data points a table of information indexed by account number that describe various preferences and dislikes, as reported by the patron to the system 100 (e.g., via a casino staff member). Examples include hobbies, sporting events, dining, gaming preferences and dislikes.

D. Observed Preferences

An observed preferences data structure 1116 includes a plurality of data points a table of information indexed by account number which are calculated based upon various metrics descriptive of patterns of behavior discerned from analysis of certain transactions stored within the data warehouse 226. In the exemplary implementation the table of data points stored within the preferences data structure 1116 is updated at regular intervals (e.g., once per day) using transformed sets of data provided during these intervals by the data transformation services 232. The preferences data reflected by the preferences data structure 1116 may be based upon activity over various default time periods (e.g., most recent 30, 60 or 90 days). Alternately, users may specify the duration of the time period represented by the preferences data stored by the data structure 1116 (e.g., most recent 74 days) Attributes of these transactions are stored within the PCS database 112, and the contents of the observed preferences data structure 1116 is distilled from this stored information. These preferences contained within the data structure 1116 may include, for example, (1) gaming preferences based on observed time played or actual win or theoretical win as recorded (derived or observed) from a casino's management system (2) favorite restaurant based on number of visits to restaurants as recorded in the warehouse 226 on the basis of restaurant-related transactions stored within the transactional databases 108.

E. Transaction Summaries; Gaming History

A transaction summaries component 1120 comprises a set of data points collectively presenting a complete view of a patron's gaming activity as recorded in the casino management system and data warehouse 226. The PCS module 216 preferably uses a folder-tree type of GUI that allows users to drill down into finer grains of detail as needed to acquire information relating to the gaming activity metrics of interest. Representative metrics include, for example, number of visits to the applicable casino, theoretical win (i.e., the product of the aggregate amount of money exchanged during playing of a given game and the percentage of such aggregate amount expected to be retained by the applicable casino installation), average theoretical win per visit, actual win/loss for slot machines and table games, and amount of compensatory products and services (“comps”) consumed (e.g., room, food, show tickets, and travel). Different sets of these metrics will generally be tracked by the separate installations of the system 100 in different casino establishments. In addition, the metrics tracked will also tend to differ in installation of the system 100 which include a data warehouse 226 relative to installations in which a data warehouse 226 is not present.

F. Campaign History

A campaign history component 1124 includes information identifying the marketing campaigns associated with a given customer account, as well as the status of the campaign and any associated offers. This information may vary from installation to installation of the system 100, and between installations including a data warehouse 226 and those not including a data warehouse 226.

G. Operation of Player Contact System

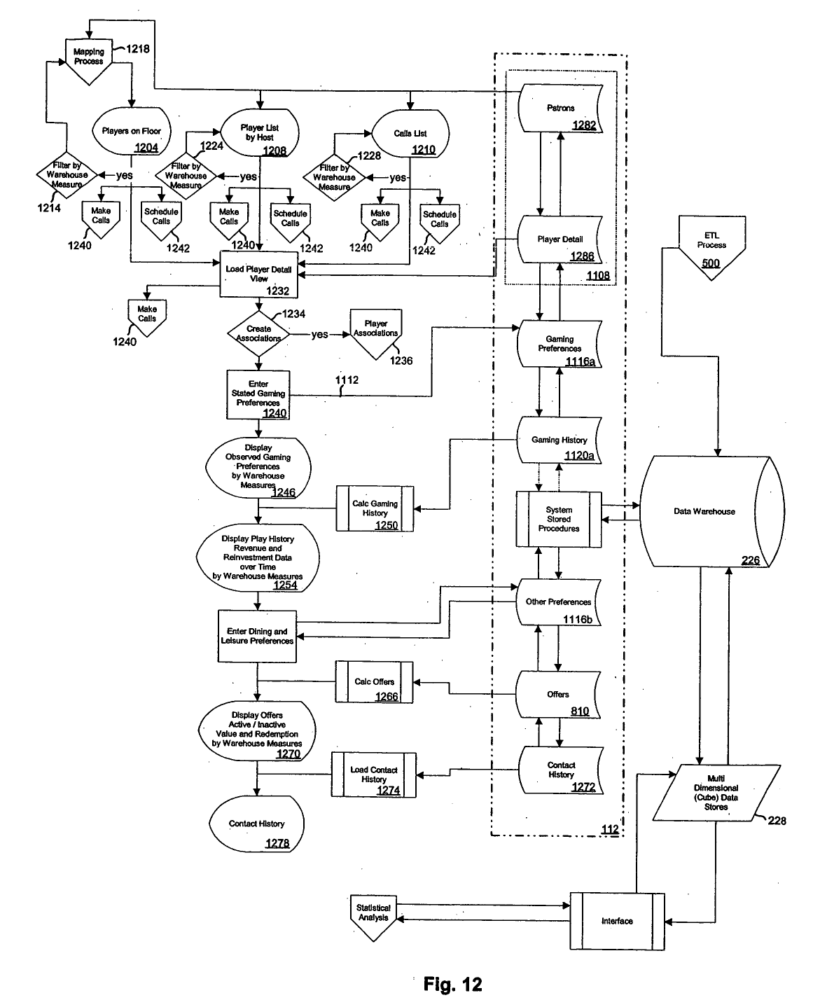

FIG. 12 is a flowchart 1200 illustrating the operation of the player contact system. As shown, the interaction occurring with the PCS database 112 and data warehouse 226 during the campaign creation process is also illustrated in FIG. 12 in order to more fully elucidate this process. As may be appreciated with reference to FIG. 12, the PCS database 112 provides a first or “local” repository of information that is populated by the data warehouse 226. In the exemplary implementation the functionality of the player contact system is effected though execution of program instructions stored within the PCS module 216 and the PCS client module 350.

Referring to FIG. 12, in one implementation of the player contact system, several different types of information regarding players or other patrons are accessible to various system users. In particular, a view 1204 may be provided of the set of players currently located on the “floor” of a gaming establishment, another view 1208 may be provided of the players assigned to a particular host employed by the establishment, and yet another view 1210 of a list of the calls to be made to the players assigned to a given host may also be displayed. Access to the views 1204, 1208 and 1210 will often be restricted as a function of the role of the system user within the gaming establishment. For example, player hosts and the like will often be granted access to views 1204 and 1210, while access to view 1208 may be available exclusively to management personnel. As is discussed below, each of these views is generated by applying a filter comprised of various criteria or “warehouse measures” to the player data stored within the data warehouse 226. In addition, operations relating to the making of calls upon patrons (step 1240) or the scheduling of such calls (step 1242) may be conducted from within the contexts of the various views 1204, 1208 and 1210.

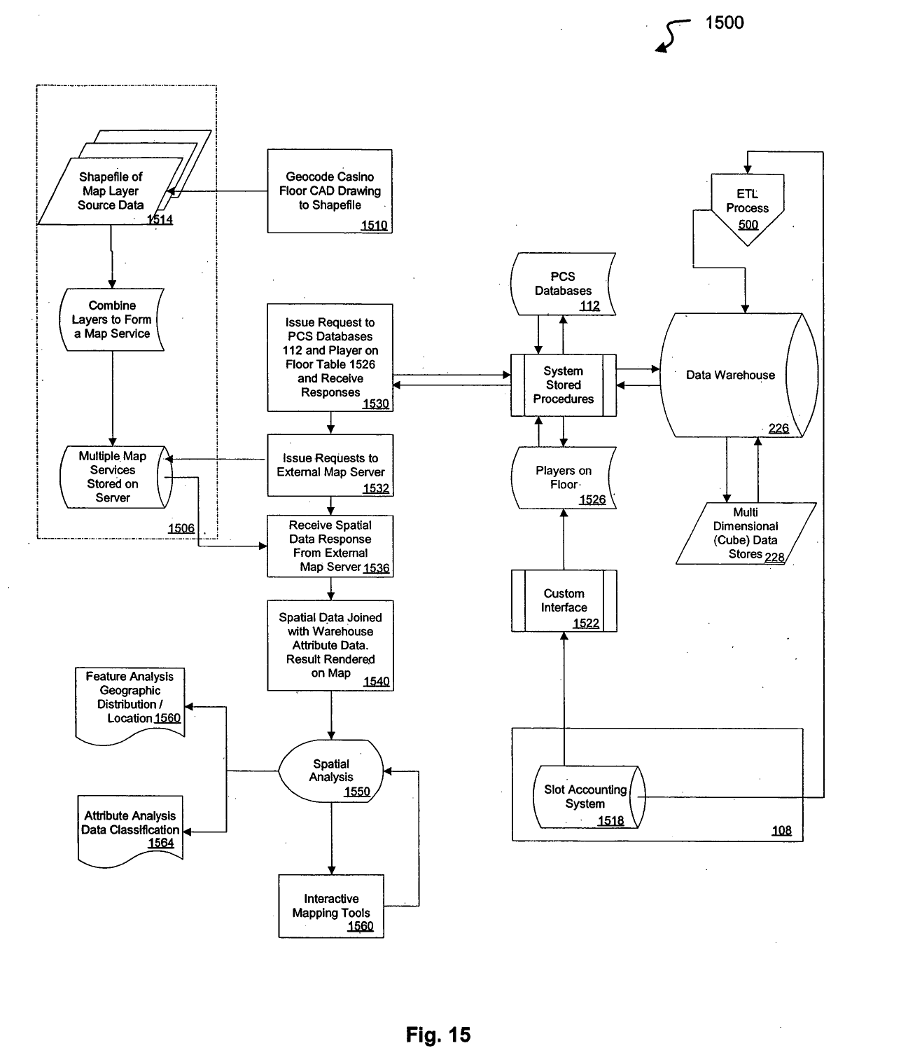

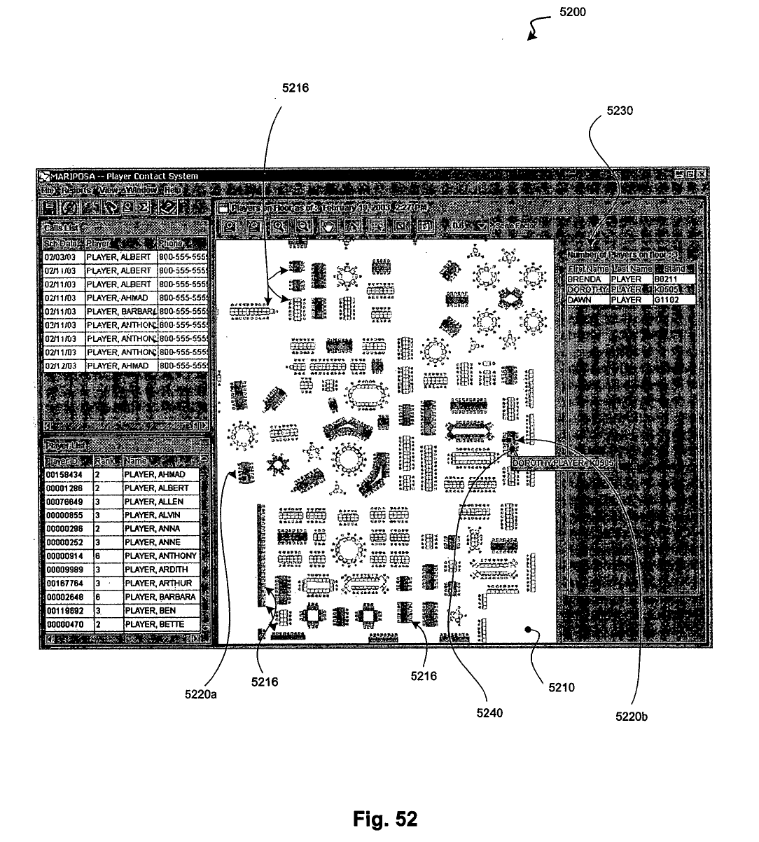

FIG. 52 depicts a user interface window 5200 providing an illustrative representation of one potential player location view 1204 of the locations of players within a gaming establishment. As shown, the interface window 5200 includes a floor diagram pane 5210 illustrating the layout of various gaming machines 5216 within the applicable gaming establishment. The locations of certain players 5220 within the gaming establishment are also illustrated within the floor diagram pane 5210, as well as within a player location table 4930. As may be appreciated by reference to FIG. 12, the contents of the user interface window 5200 may be generated by applying filter to warehouse 226 (step 1214) and mapping the results of the filtering operation (step 1218). As is discussed below, such application of a filter to the data warehouse 226 involves defining a set of warehouse measures and then extracting information from the data warehouse 226 corresponding to players fitting the criteria established by the defined warehouse measures. In the case of FIG. 52, the filtering process (step 1214) identifies a subset of the players on the floor of the applicable gaming establishment which meet the filtering criteria. The information extracted through the filtering process (e.g., player identification number and/or name information) may then be associated with corresponding locations within the floor diagram pane 5210 during the mapping process 1218, which is described in further detail below with reference to FIG. 15. As is indicated by FIG. 52, a user may then cause the identify of a particular player to be displayed by moving a cursor 5240 over the location of a particular player 5220.

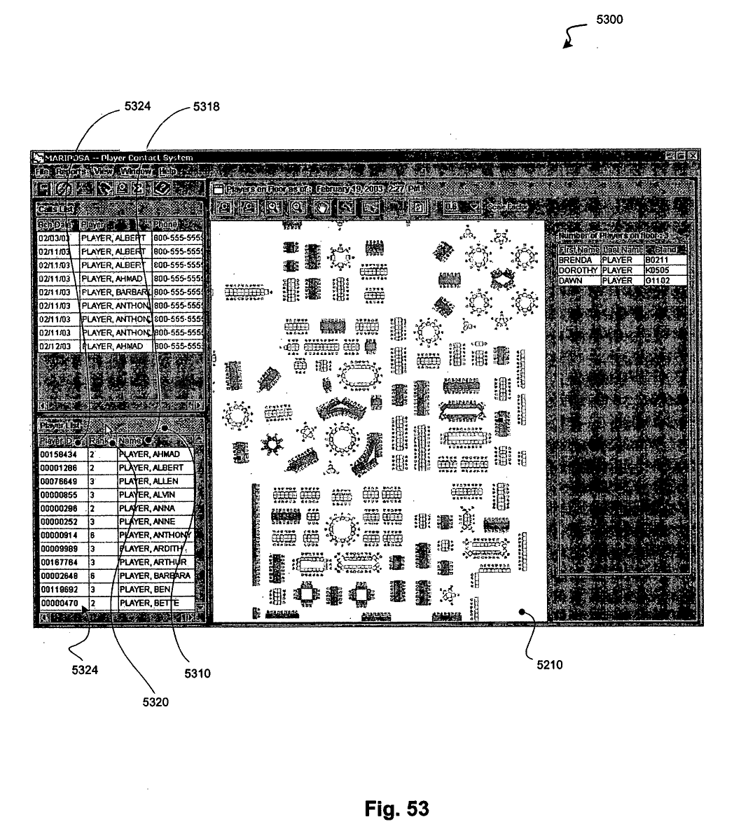

Turning now to FIG. 53, a user interface window 5300 is shown which illustratively represents a player list table 5310 comprising a player list view 1208. As shown, the player list table 5310 includes a Player ID column 5314, a corresponding Name column 5318, and a Rank column 5320. In the implementation of FIG. 53 the Player List Table 5310 includes a Player ID 5324 for all the patrons assigned to the player host logged in to the terminal 120 displaying the user interface window 5300. If an individual having superior viewing rights to the player host (e.g., a manager of multiple player hosts) were instead logged in to the terminal 120, the Player List Table 5310 would instead contain a list of all player hosts and associated patrons. Again referring to FIG. 12, the contents of the user interface window 5000 may be generated by applying a filter to warehouse 226 (step 1224) and generating the view

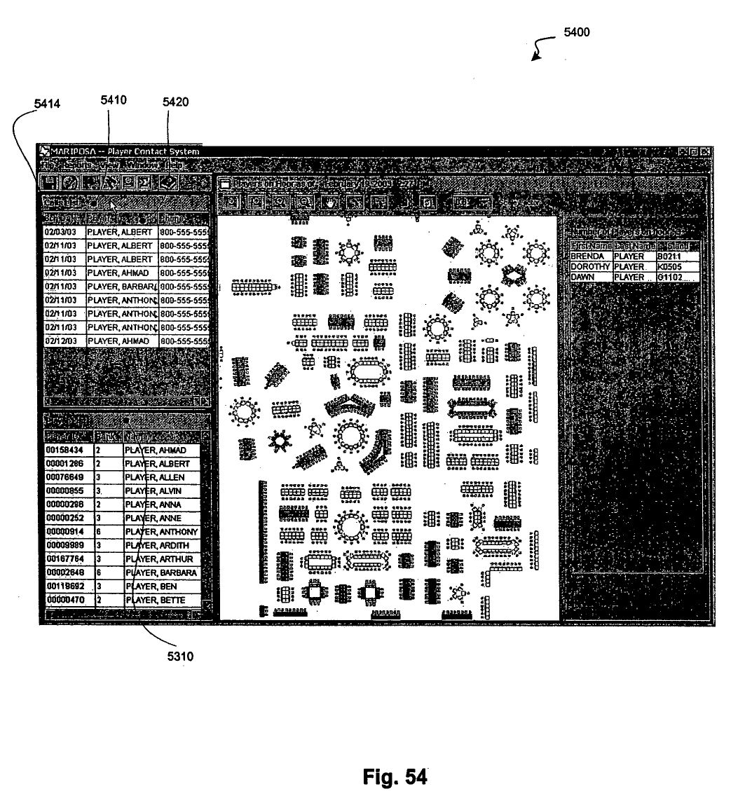

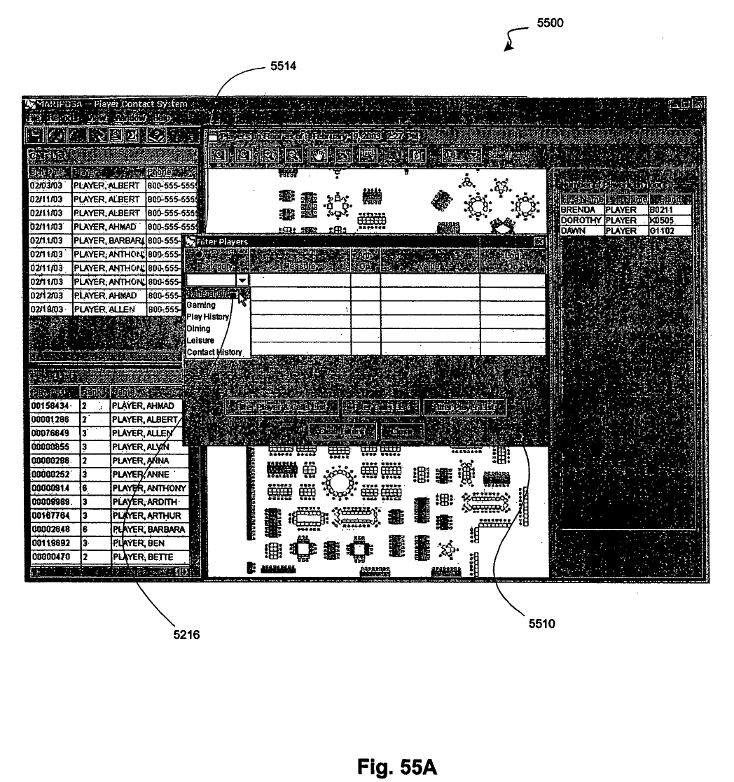

FIG. 54 depicts a. user interface window 5400 containing a calls list table 5410 comprising one potential implementation of the calls list view 1204. The calls list table 5410 is intended to provide a player host with a tabular listing of the calls to be made to the players assigned to such host. In the exemplary implementation the term “calls” encompasses telephone calls, “in-person” meetings and any other mode of contacting or communicating with patrons. As shown, the calls list table 5110 includes a Sch Date column 5414 in which are listed the dates upon which the applicable host is scheduled to make calls to the corresponding players within a Player list 5420. It is noted that although all players associated with the applicable host will typically be listed within Player List Table 5310, only those players which are scheduled to receive calls from the host are identified within the calls list table 5410. In certain implementations those scheduled calls within the call list table 5410 which are “overdue” may be displayed in a different color (e.g, red) than that used to display calls which are schedule to occur at a later date. In addition to being manually entered within the calls list table 5410, calls to players may also be scheduled and added to the calls list table 5410 by other means. For example, a player 5120 within the floor diagram pane 5110 may be “right-clicked” and a call to such player may then be scheduled.

Again referring to FIG. 12, the contents of the user interface window 5400 may be generated by applying a filter to warehouse 226 (step 1228) and extracting the identities of a set of patrons for which calls have been scheduled and which meet the other filtering criteria. Such other filtering criteria may be related to any parameter of the data contained within the data warehouse 226 (e.g., birthday, gaming preferences, Offers sent/redeemed, lodging preferences).

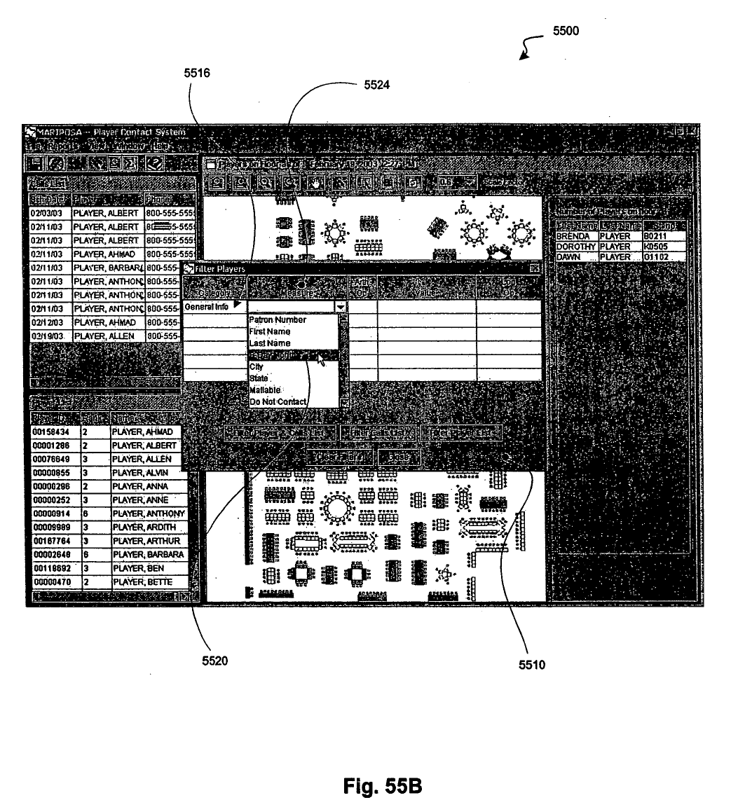

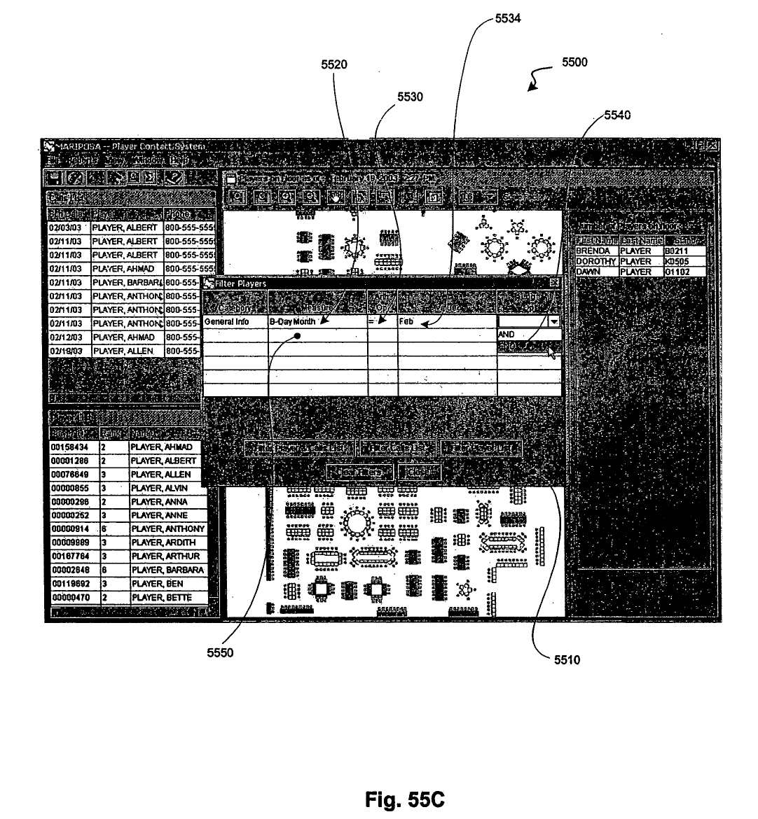

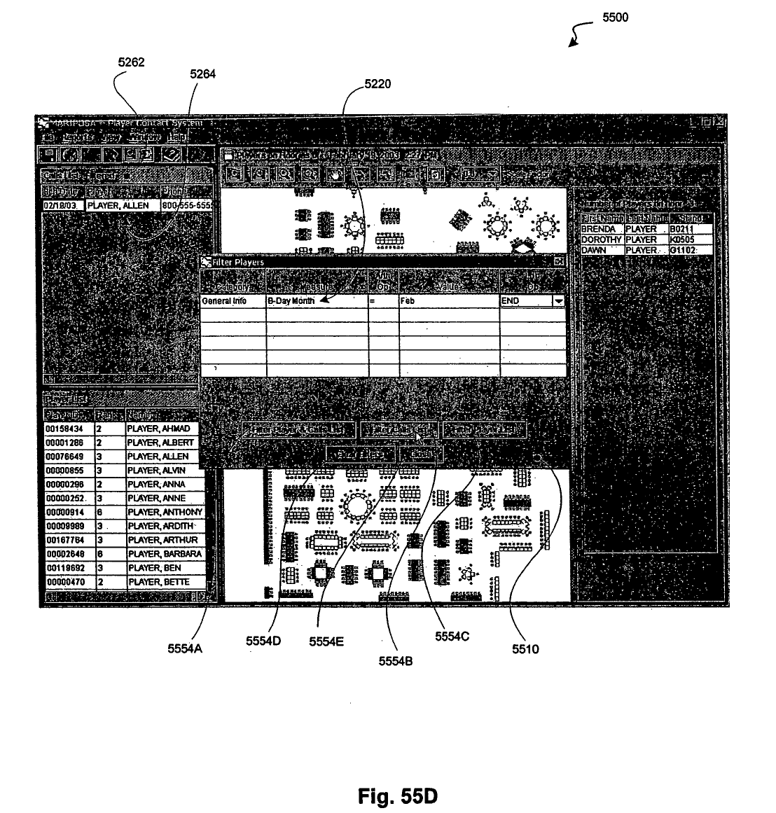

Turning now to FIGS. 55A-55D, a user interface window 5500 containing a filter patrons dialog 5510 is depicted. The filter patrons dialog 5510 may be invoked from within several contexts when it is desired to generate a list of patrons meeting various criteria. The use of the filter patrons dialog 5510 in establishing such criteria is illustrated by FIGS. 55A-55D.

Referring to FIG. 55A, the filter dialog 5510 is seen to include a Category column 5514 from which a user is selecting a particular category 5516 applicable to the filtering process. In the exemplary implementation the categories within the Category column 5514 are intended to impose a degree of organization upon the potentially large list of warehouse measures available for selection as filtering criteria. That is, each of these measures is placed into a particular category. This organizational approach is further illustrated by FIG. 55B, which shows a particular measure 5520 within the specified category 5516 being selected from a Measure column 5524. In FIG. 55C, an arithmetic operator 5530 and a value 5534 have been specified for application against the selected measure 5520. In addition, FIG. 55C represents the manner in which further measures may be chained to the selected measure in connection with development of the desired filtering criteria. Specifically, FIG. 55C depicts a logical operator 5540 being selected, which would define the relationship of any next measure 5550 potentially entered within the dialog 5510 to the measure 5520. In the implementation of FIG. 55C it has been decided not to enter any such additional measure 5550, and hence the logical operator 5540 is seen to comprise the “END” operator. Finally, FIG. 55D illustrates the selection of a Filter Calls List button 5554B, which is one of several buttons 5554 which could be selected at this juncture in order specify the operations executed in response to the contents of the filter dialog 5510. In this case selection of the Filter Calls List button 5554B causes display of a Calls List—Filtered table 5562, which contains a single entry 5564 corresponding to the results of the filtering process defined by the dialog 5510.

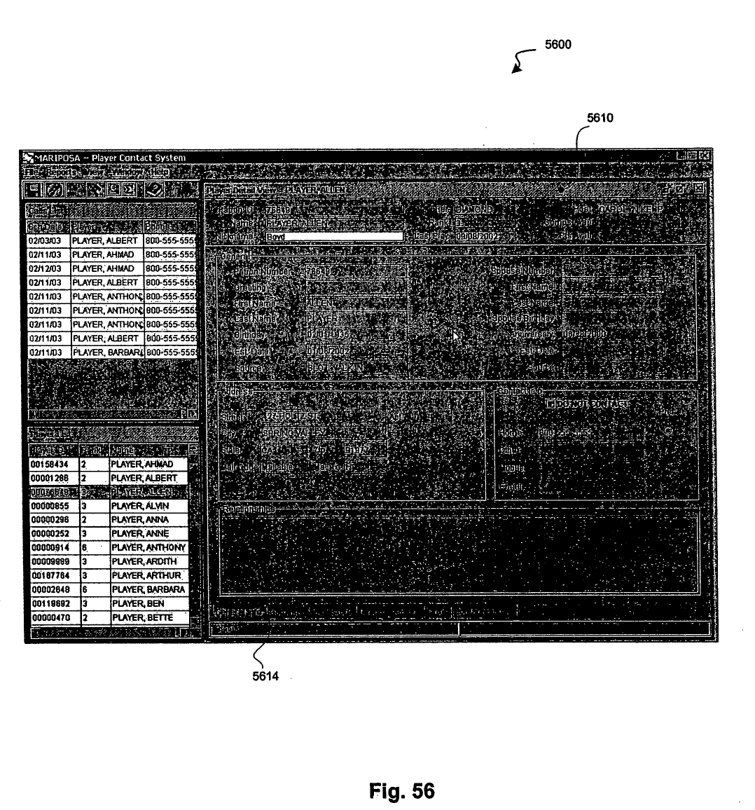

Turning now to FIG. 56, a user interface window 5600 is depicted which includes an initial Player Detail View pane 5610. Referring to FIG. 12, the initial Player Detail View pane 5610 may be caused to appear through execution of a Load Player Detail View operation 1232 from the context of each of the views 1204, 1208 and 1210. As shown in FIG. 56, the initial Player Detail View pane 5610 is displayed upon selection of a General tab 5614, and enables entry of general contact information for the applicable patron and the patron's spouse.

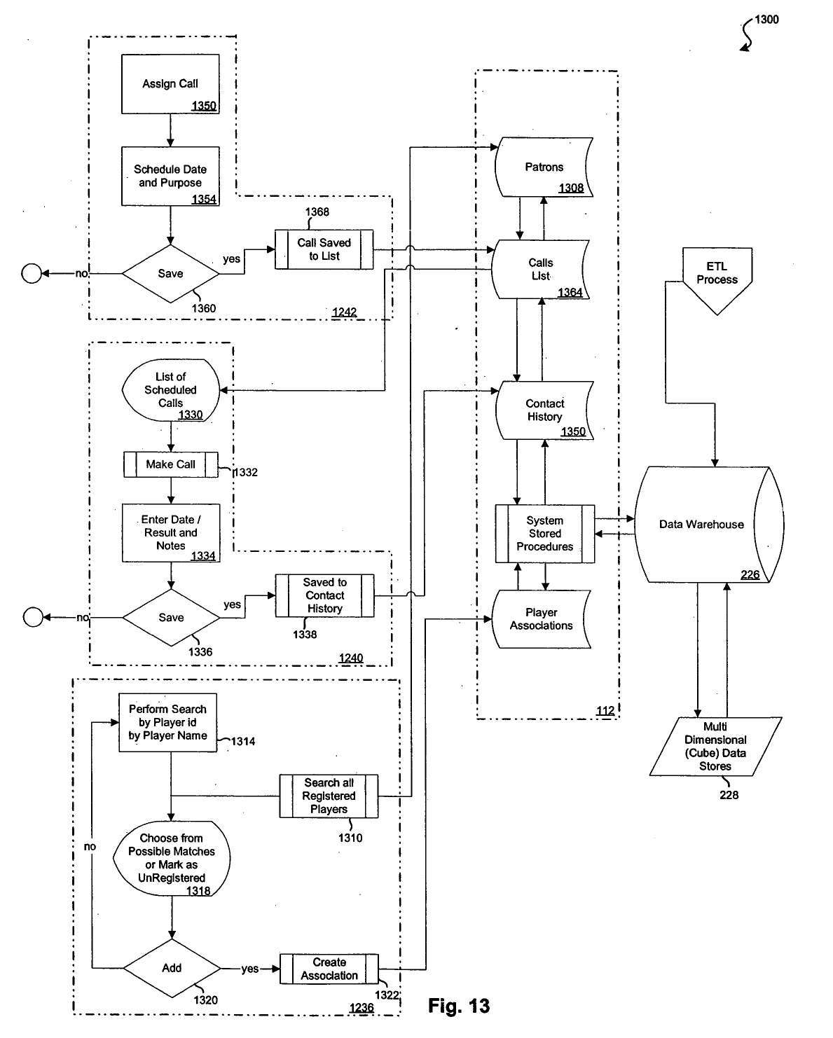

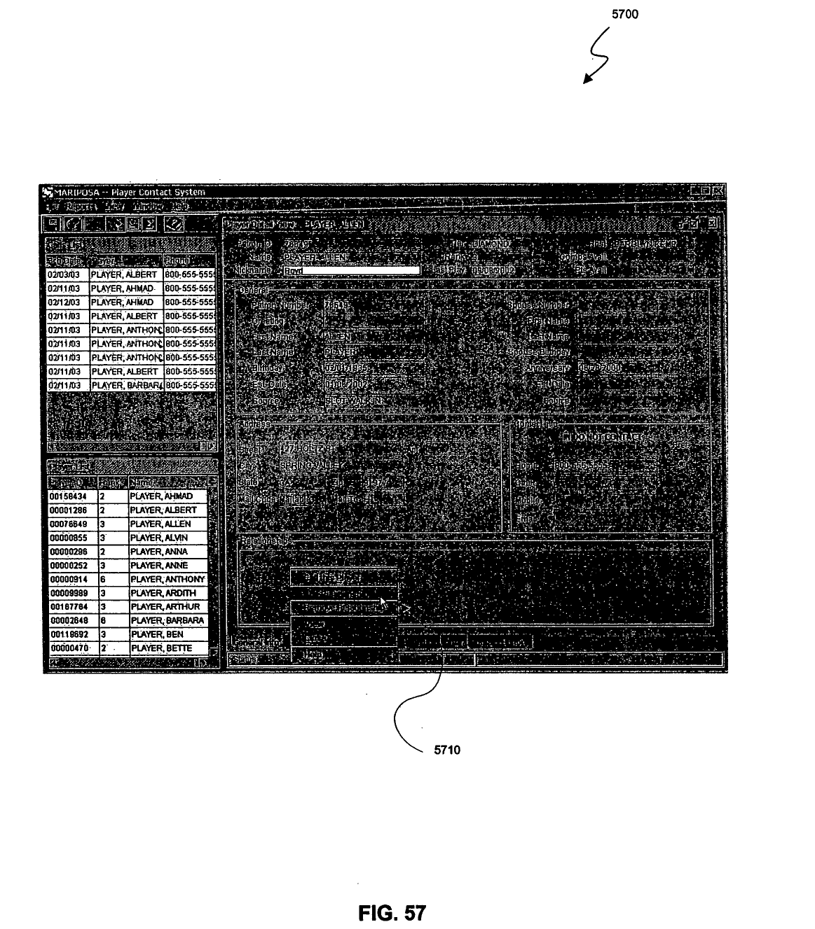

If it is decided to define associations between the patron and other patrons or non-patrons (e.g., spousal relationships, friendships) (step 1234), then such relationships may be defined from within the context of the Player Detail View (step 1236). This definition process is introduced by FIG. 57, which depicts a user interface window 5700 containing a context menu 5410 displayed upon right-clicking from within the Player Detail View pane 5610. As shown, a user is in the process of selecting an “Add Relationship” entry 5714 from the context menu 5710, which enables definition of an association with the applicable patron (i.e., the patron identified by the Player Detail View pane 5610) in the manner illustrated by FIGS. 13 and FIGS. 68-70.

Referring now to FIG. 13, a flowchart 1300 is provided which illustrates the operations involved in making calls upon patrons (step 1240), the scheduling of such calls (step 1242) and the definition of associations between patrons (step 1236). Considering first the sequence of operations involved in performing the patron association process of step 1236, a search of the records of a patrons data structure 1308 is initially performed (step 1310) as a function of patron identification number or name information entered by a user (step 1314). The search results may yield a list of one or more registered and unregistered patrons, one of which is selected by the user (step 1318). If the user decides that it is desired to create an association between the selected patron and the patron identified during the Load Player Detail View operation 1232 (step 1320), then the association is created and stored within a player associations data structure 1324 within the PCS database 112 (step 1322).

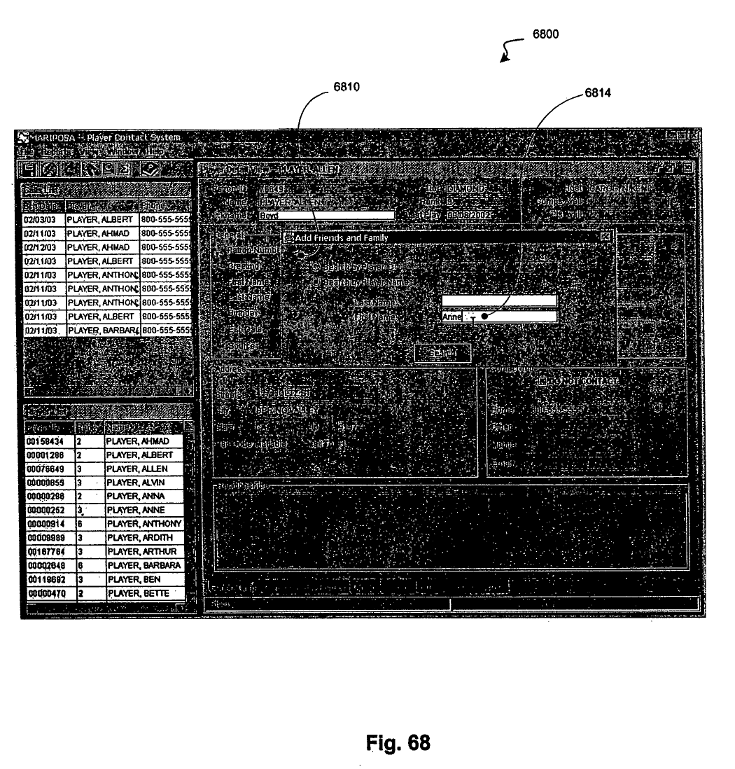

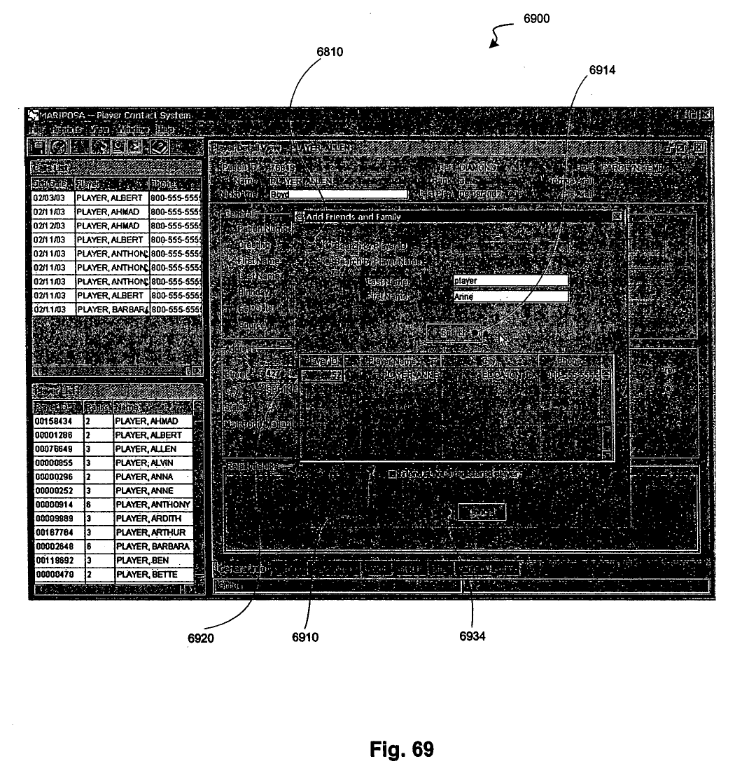

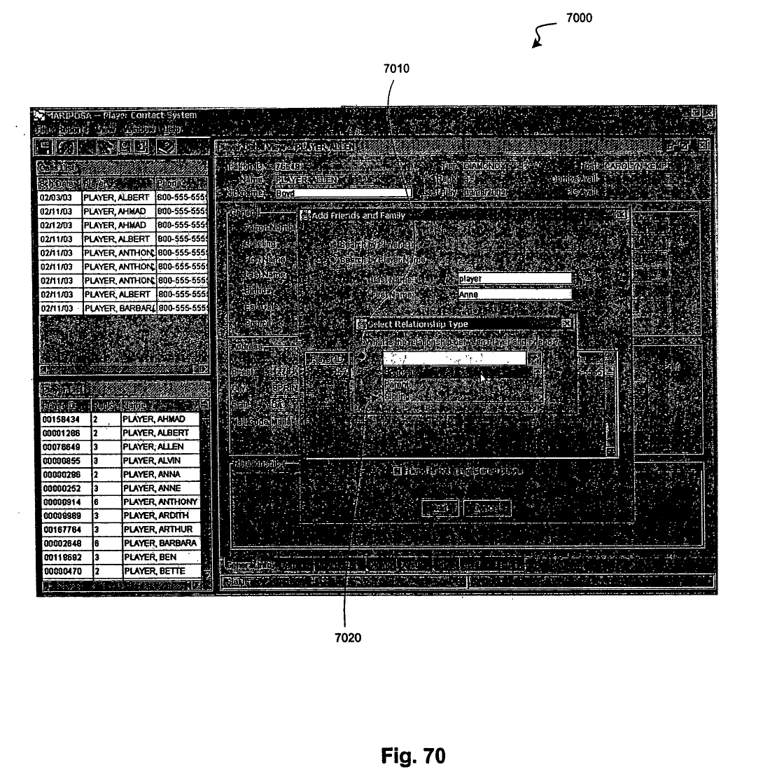

FIGS. 68-70 are a set of screen shots illustrating an exemplary user interface through which the player association process 1236 may be effected. Referring to FIG. 68, a user interface window 6800 is depicted within which an Add Friends and Family dialog 6810 has been displayed. The Add Friends and Family dialog 6810 is the first of multiple dialogs launched upon selection of the Add Relationship entry from the context menu 5710 (FIG. 57). In the dialog 6810, the user has selected Search by Player Name and has begun entering a name within a First Name field 6814. As shown in a user interface window 6900 of FIG. 69, a results table 6910 is made to appear within the dialog 6810 immediately following selection of a Search button 6914. The results table 6910 is seen to include an entry 6920 for a single patron matching the search criteria. If other registered patrons had met the search criteria, these other patrons would also have had corresponding entries within the results table 6910. After deciding that is desired to create an association between the patron corresponding to the entry 6920 and the patron identified within the Player Detail View pane 6930, an Add button 6634 is enabled and selected by the user. Selection of the an Add button 6934 results in display of a Select Relationship Type dialog 7010 within a user interface window 7000 (FIG. 70). In FIG. 70, the user is shown selecting from a drop-down list of relationship types 7020 in order to complete the association process.

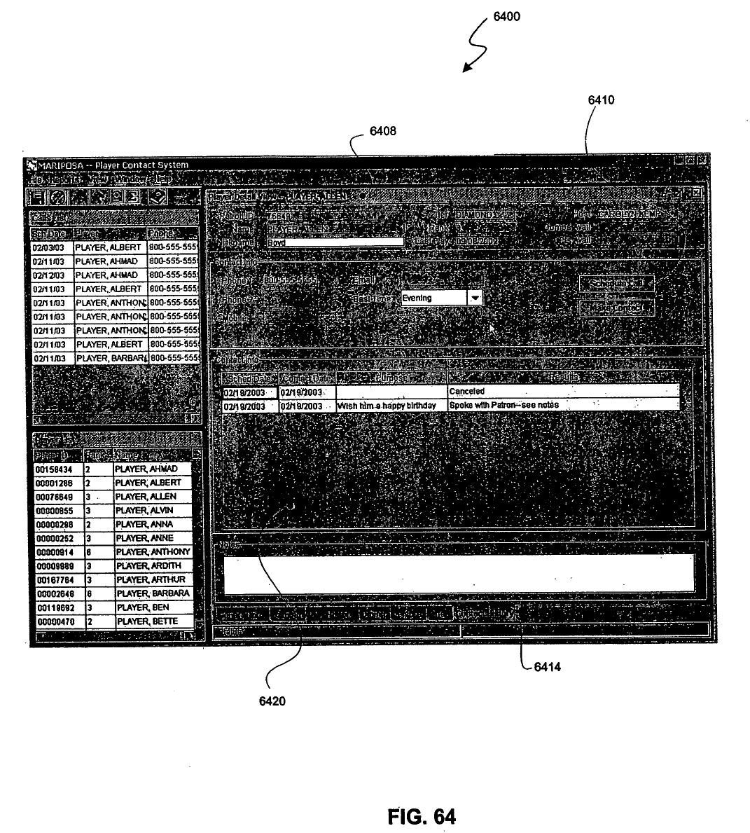

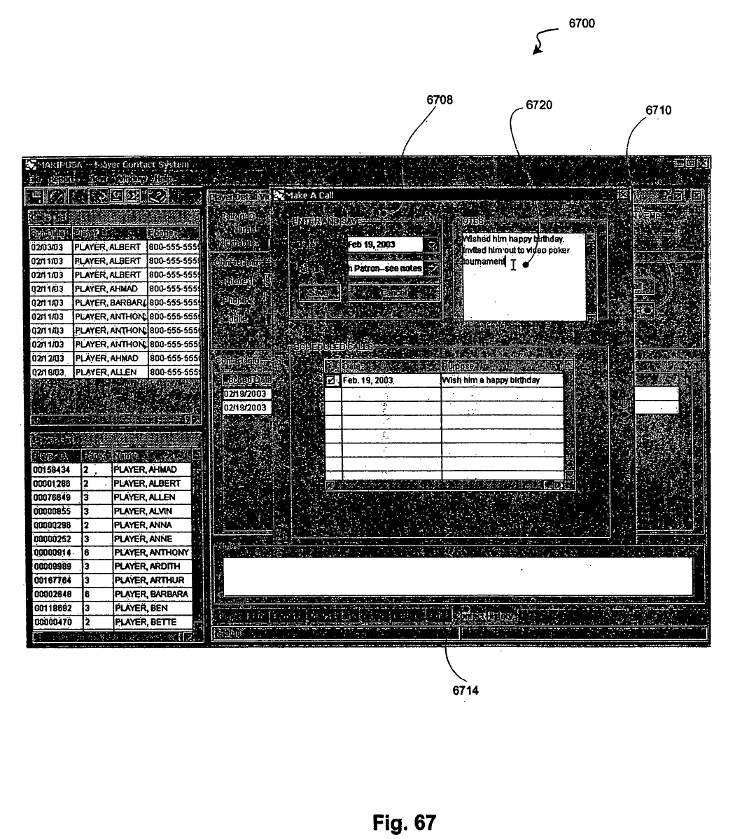

Referring again to FIG. 13, the call making process 1240 is initiated in a step 1330 by examining a list of scheduled calls (see, e.g., the Calls List—Filtered table 5562 of FIG. 55D). The telephonic or other call upon the identified patron is then made by the responsible player host (step 1332). The host may then elect to record the result of the call and note regarding any impressions or observations of the host (step 1334), which is illustrated by the user interface window 6700 of FIG. 67. As shown, the window 6700 includes a Make a Call dialog 6708 displayed upon selection of a Make Contact button 6710 from a Contact History tab 6714. In FIG. 67, the user is in the process of entering information within a Notes field 6720 pertinent to the applicable call. If it is decided to save this information once entered (step 1336), then it is stored within a contact history data structure 1350 (step 1338). See also the user interface window 6400 of FIG. 64, which contains a Contact Info sub-pane through which is displayed information from the contact history data structure 1350.

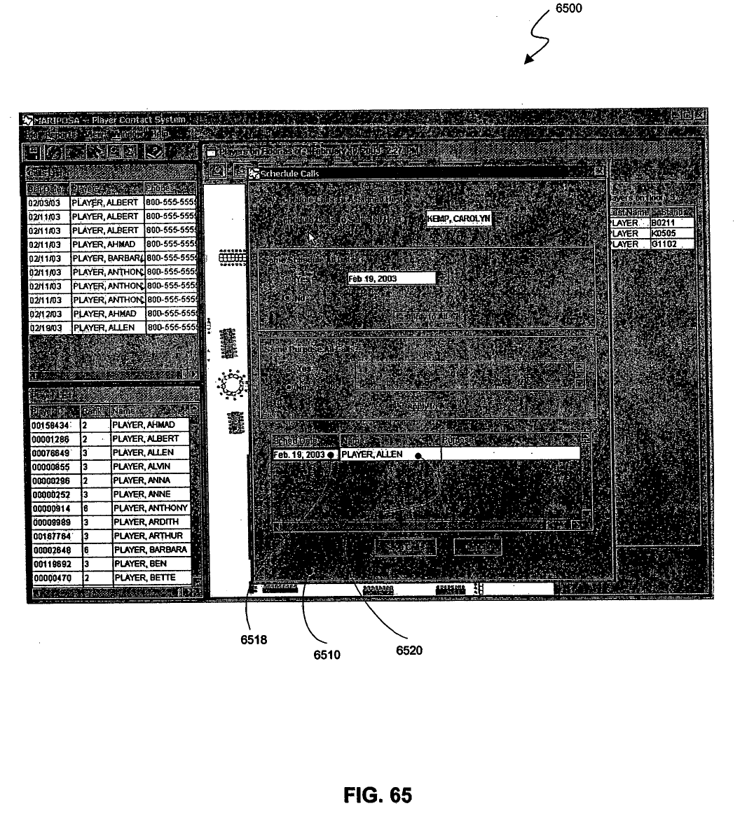

Again referring to FIG. 13, the call scheduling process 1242 is initiated by assigning a host a particular call desired to be made upon or to a patron (step 1350). This essentially entails selecting, typically from a filtered list of patrons, those patrons for which it is desired to schedule calls. This is illustrated by the user interface window 6500 of FIG. 65, which includes a Schedule Calls dialog 6510. The dialog 6510 is launched by clicking upon a Schedule Call button 6410 (FIG. 64) subsequent to selection of the Contact History tab 6414. In FIG. 65, the dialog 6510 has opened with default values present within a scheduled date field 6518 (i.e., the current date) and a Name field 6520 (i.e., the name of the open patron). In this case a call is being scheduled only for the patron that is “open” or displayed; however, information regarding the entire series of patrons would be displayed via the Schedule Calls dialog 6510 if more than one customer were selected.

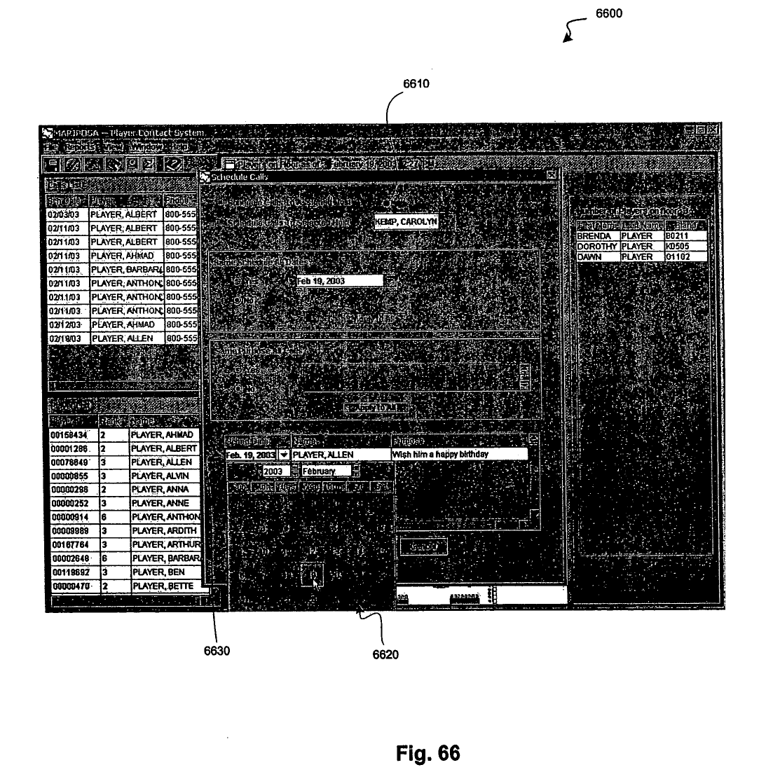

As is indicated by FIG. 13, a scheduled date and purpose for the call is then entered (step 1354), which is illustrated by the user interface window 6600 of FIG. 66. In this case the user has entered a purpose for the scheduled call within a Purpose field 6610 of FIG. 66. In addition, the user is in the process of using a drop down calendar 6620 to modify the date of the call within a scheduled date field 6630. If it is decided to save this information once entered (step 1360), then it is saved to a calls list 1364 stored within the PCS database 112 (step 1368).

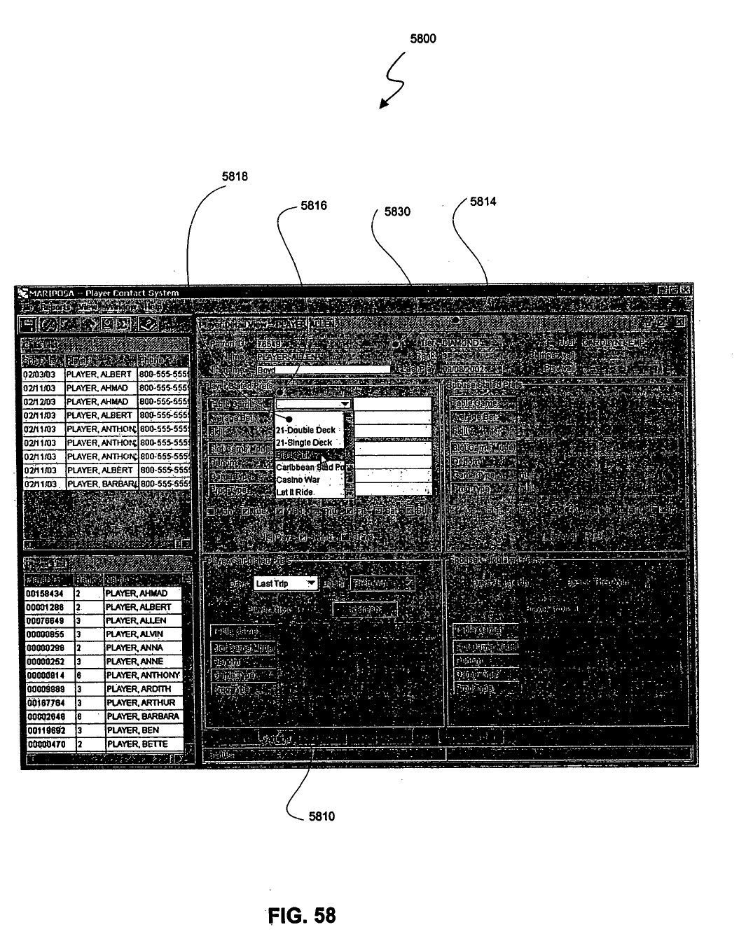

Referring again to FIG. 12, stated gaming preferences provided by a patron may be entered via the user interface window 5800 of FIG. 58 and stored as stated gaming preferences within the gaming preferences data structure 1116a (step 1240). In FIG. 58, selection of a Gaming tab 5810 results in display of a primary pane 5814 containing a Player Stated Prefs sub-pane 5816 in which is entered the gaming preferences articulated or otherwise provided by a patron. Within the sub-pane 5816, a user is seen to be in the process of selecting among many Table Game options listed within drop-down menu 5818. The user may also enter additional table game, bet and skill information within the sub-pane 5816, as well information relating to as slot games based upon the information provided by the applicable patron (i.e., the patron identified within the Player Detail View pane 5610).

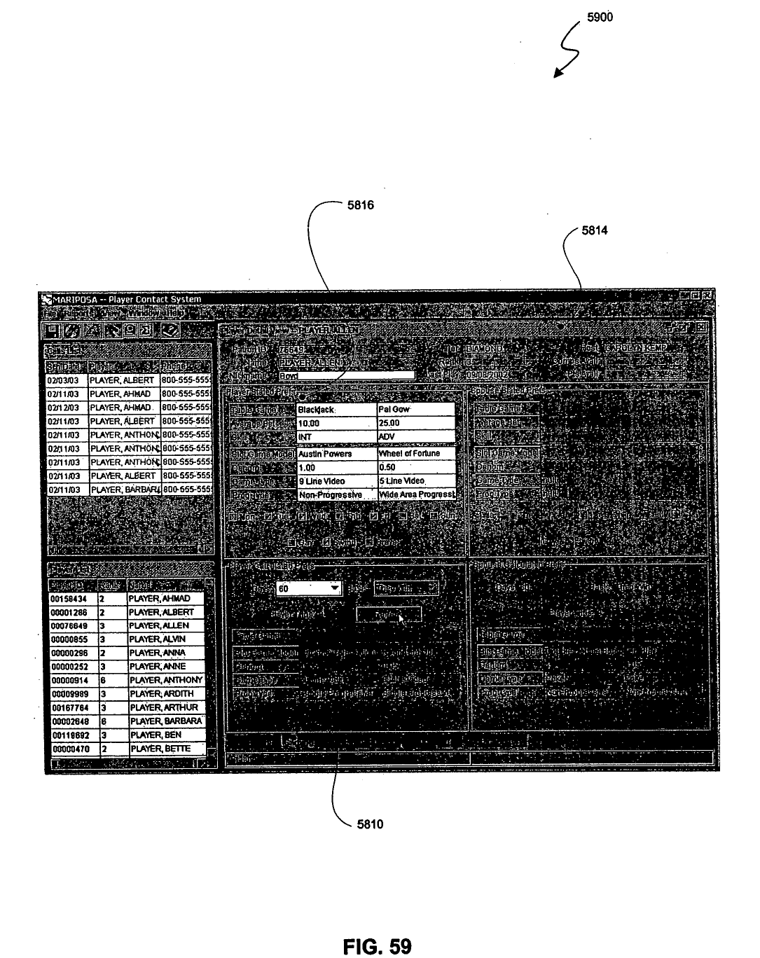

As is indicated by FIG. 12, observed gaming preferences for the applicable patron are calculated based upon the actual gaming preference data for the patron maintained within the PCS database 112 (step 1244) and may then be displayed (step 1246). In the exemplary implementation this actual gaming preference data is “pre-calculated” based upon preferences information for the applicable patron accessed from the data warehouse and stored within the gaming preferences data structure 1116a. In FIG. 59, various observed gaming preferences for the applicable patron may be viewed through the user interface window 5900. As shown, the user has selected from among various warehouse measures, and has also actuated a Refresh button in order to update the displayed information. The user interface window 5900 advantageously provides significant information as to the activities of the applicable patron on the floor of the gaming establishment.

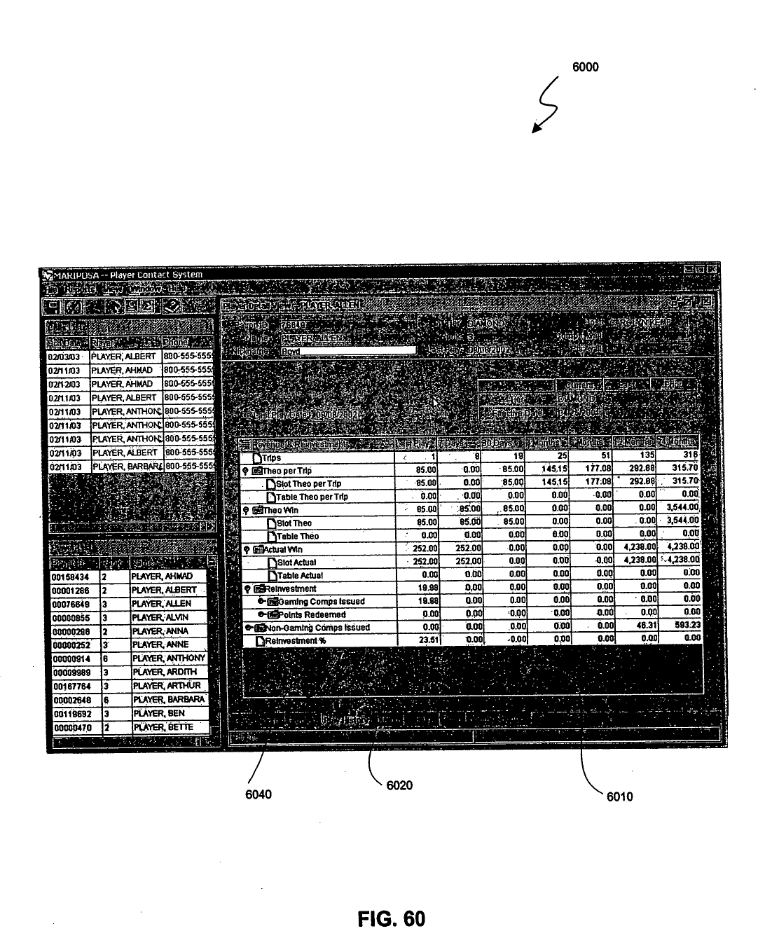

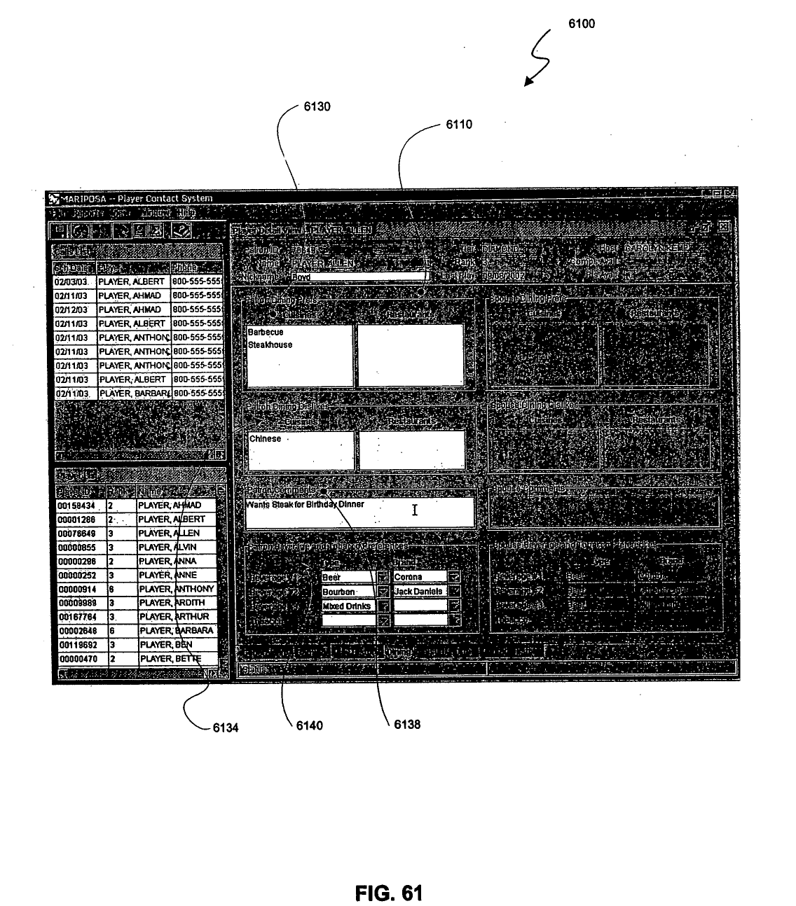

Gaming history for the applicable patron is also calculated based upon gaming history information maintained within a gaming history data structure 1120a of the transaction summaries component 1120 (step 1250). In the exemplary implementation gaming history may comprise, for example, the play history, revenues, reinvestment information, number of trips or visits, theoretical win, actual win, as well as more specific gaming results for slots and table games, associated with the applicable patron. These historical gaming results may be represented as a function of time in the manner illustrated by FIG. 60 (step 1254), which depicts a user interface window 6000 having a Play History panel 6010 that is displayed upon selection of a Play History tab 6020. An upper portion 6030 of panel 6010 includes information identifying the applicable patron, while a lower panel portion 6034 includes a revenue/reinvestment table 6040. As shown, the revenue/reinvestment table 6040 contains revenue and reinvestment measures organized as a function of time. This information is typically displayed in a “read-only” format and is intended to permit users to analyze the revenues and costs associated with the applicable patron.

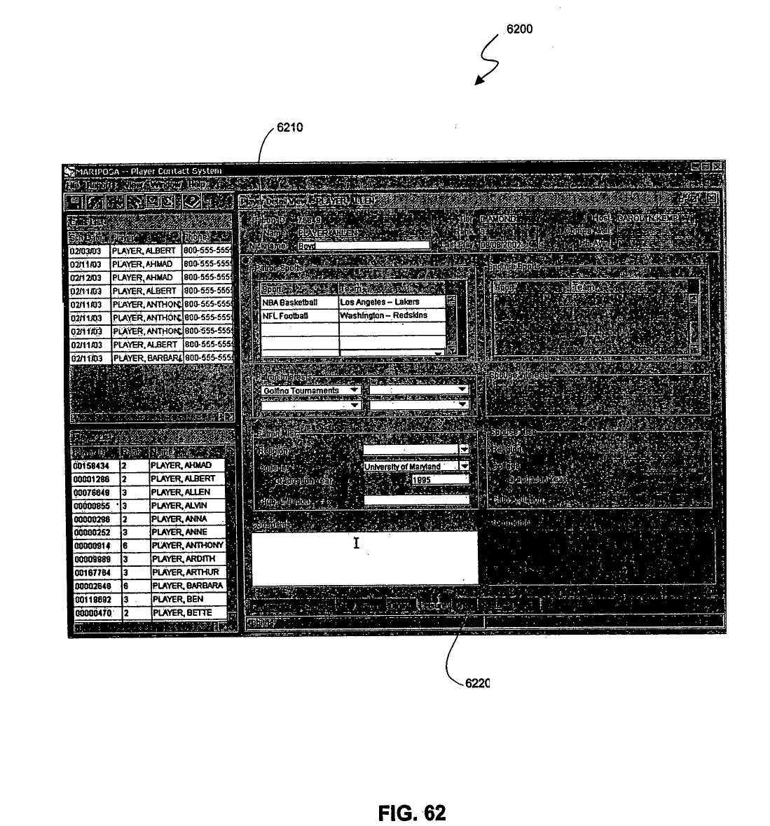

Referring again to FIG. 12, dining and leisure preferences for the applicable patron may also be entered (step 1258). FIG. 58 illustrates a user interface window 6100 containing a Dining pane 6110 that is displayed upon selection of a Dining tab 6120. In this case a user has entered information within a Patron Dining Prefs field 6130, a Patron Dining Dislikes field 6134, a Patron Comments field 6138 and a Patron Beverage and Tobacco Preferences field 6140. Similarly, FIG. 62 depicts a user interface window 6200 including a Leisure pane 6210 that is displayed upon selection of a Leisure tab 6220. As shown, the Leisure pane 6210 includes a number of fields through which patron preferences regarding leisure activities may be entered or updated.

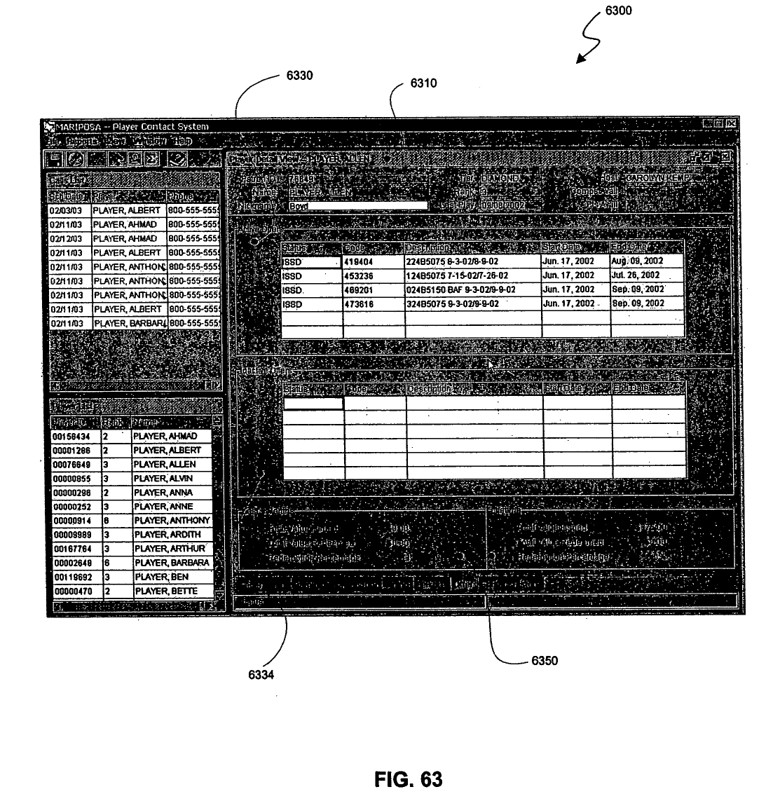

As is illustrated by FIG. 12, the PCS database 112 includes an Offers data structure 1262 containing information regarding Offers associated with the patron identified within the Player Detail View pane 5610. The information within the data structure 1262 characterizes each such Offer as either active or inactive (i.e., utilized or expired), along with the value and redemption amount thereof. In addition, aggregate Offer values and redemption amounts are also maintained for the applicable patron. This Offer information for the applicable patron is calculated based upon the information within the data structure 1262 (step 1266) and then may be displayed (step 1270). FIG. 63 depicts a user interface window 6300 containing an Offer pane 6310 displayed upon selection of an Offer tab 6320. As shown, information regarding Offers sent to the applicable patron may be viewed through the Offer pane 6310. Information regarding active Offers is presented through an Active Offers sub-pane 6330, while information pertaining to inactive Offers is conveyed via an Inactive Offers sub-pane 6334. An additional sub-pane 6350 provides information concerning Offer revenue and redemption information.

Turning again to FIG. 12, contact history information 1272 relating to the contacts made with the applicable patron (e.g., telephone calls from a player host to the patron) may be loaded (step 1274) and displayed upon request of a user (step 1278). The contact history information 1272 may comprise the player host or other individual initiating the contact with the patron, the date of the contact, as well a summary of the result of the contact. FIG. 64 shows a user interface window 6400 containing a Contact History pane 6408 that is displayed upon selection of the Contact History tab 6414. As may be appreciated with reference to FIG. 64, a user may review the contact history information for the applicable patron that is displayed through the Contact History pane 6408.

In the exemplary implementation of FIG. 12, the contents of the PCS database 112 are updated regularly (e.g., daily) with information from the data warehouse 226. For example, the gaming preferences data structure 1116a may include information relating to the type of slot machines the applicable patron frequently plays, whether the patron tends to play other games (e.g. , Blackjack and then Baccarat) before or after playing slots, the denominations typically used, and similar information. This information will generally be updated on a daily basis so as to accurately reflect the current gaming preferences of the applicable patron.

As shown in FIG. 12, patron general data component 1108 includes a Patrons data structure 1282 and a Player Detail data structure 1286. The Patrons data structure 1282 preferably comprises of a list of the account numbers for registered patrons and is linked to the other data structures within the PCS database 112. The Player Detail data structure 1286 includes various identifying information pertaining to each patron (e.g., address, phone number).

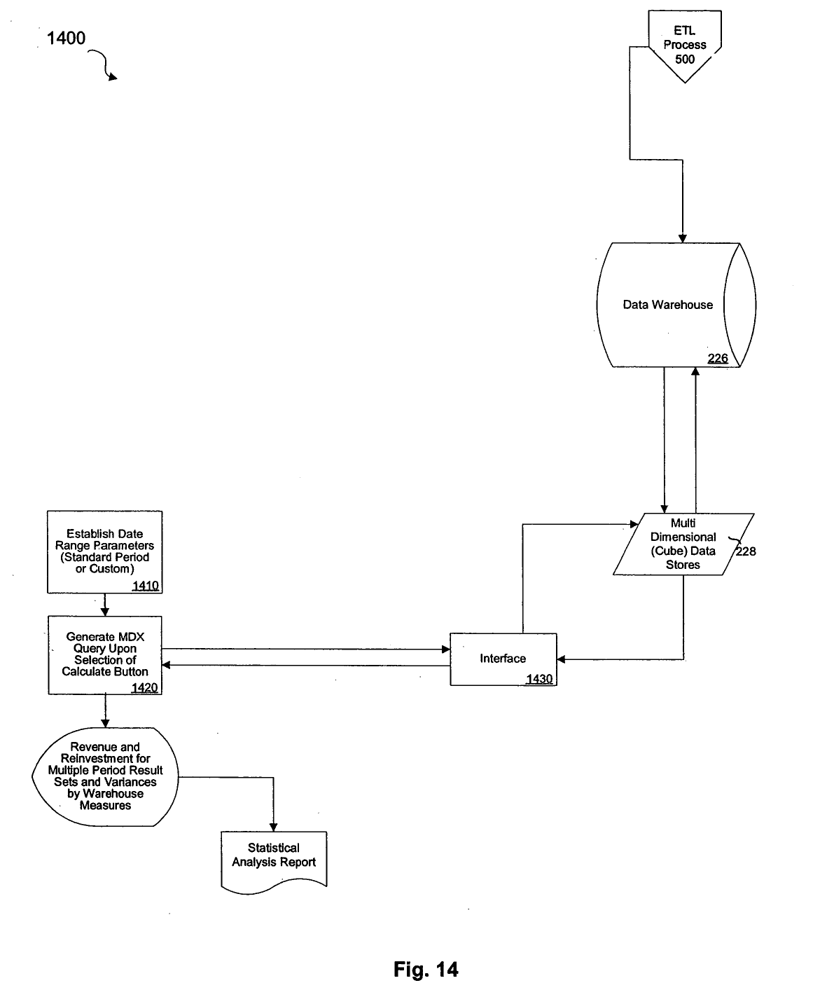

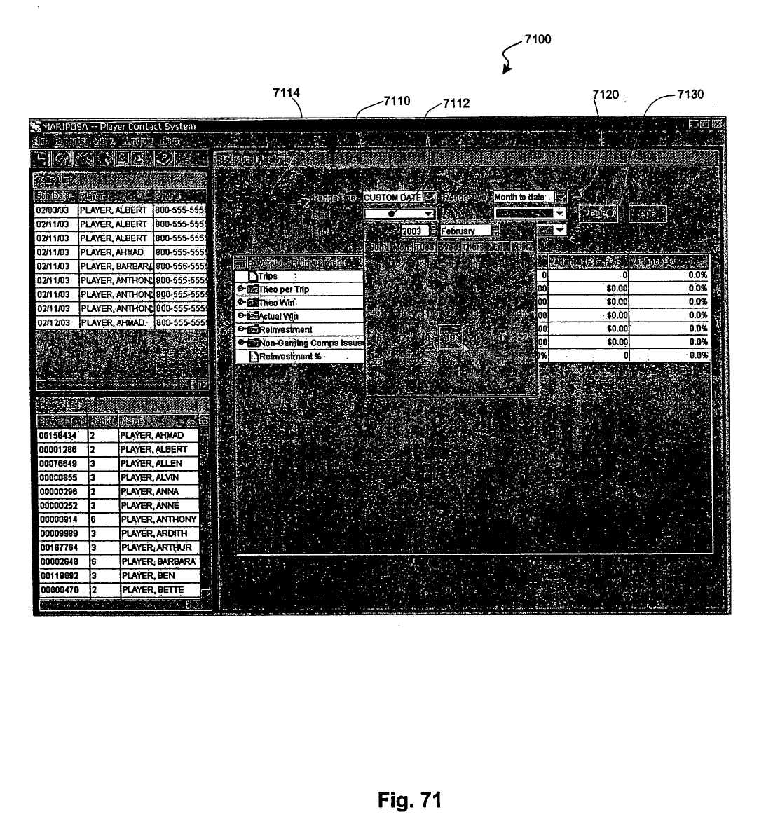

Turning now to FIG. 14, a flowchart is provided of an exemplary statistical analysis routine 1400 which may be employed in connection with the analysis of data accumulated by the player contact system. Execution of the routine 1400 enables a user (e.g., a patron host or host manager) to view the activity or gaming performance of specified patrons. The routine 1400 may be applied to a complete or filtered set of the patrons associated with particular host(s), and facilitates comparison of performance over different date ranges. That is, date range parameters may be specified in order to define different periods of interest, and variance in performance then computed between the defined periods. Either standard or “custom” periods may be defined by entering desired date ranges (step 1410). In the exemplary implementation performance results may be pre-calculated for various standard periods (e.g., month-to-date, year-to-date, week-to-date, etc.). FIG. 71 depicts a screen shot of a user interface window 7100 containing a Statistical Analysis pane 7110 through which such standard and custom periods may be defined. In FIG. 68, a user is in the process of entering a date within a Start field 6812 for the first date range, i.e., Range One 7114, of a customized period. As shown, the user may also enter start/end date information defining a second period, i.e., Range Two 7120. By default, any reports generated based upon the contents of the user interface window 7100 will be predicated upon the set of patrons assigned to the user (e.g. patron host) currently logged in.

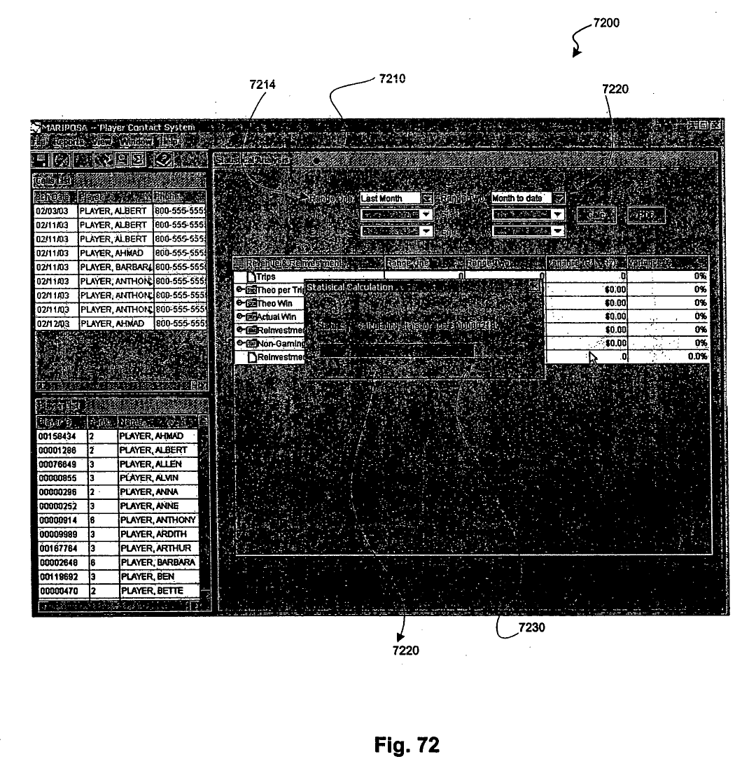

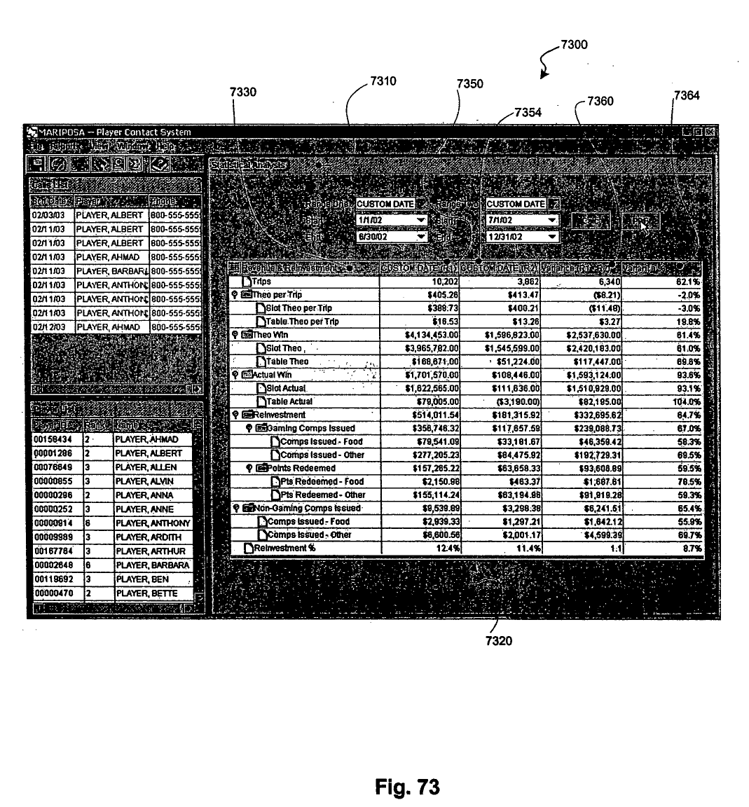

Referring again to FIG. 14, upon selection of a Calc button 7130 (FIG. 71) an MDX query is generated based upon the information entered through the Statistical Analysis pane 7110 (step 1420). After passing through interface 1430, the MDX query is applied to multi-dimensional data storage 228. In response, data concerning the subset of patrons specified by the query is reported to the interface 1430. FIG. 72 shows a screen shot of a user interface window 7200 in which a Calc button 7230 of a Statistical Analysis pane 7210 has just been selected. As shown, the user has selected the system-defined date ranges of “Last Month” for Range One 7214 and “Month to date” for Range Two 7220. The presence of the Statistical Calculation pop-up 7228 having progress bar 7230 indicates that calculations necessary for generation of a report are being performed. In FIG. 73, a screen shot of a user interface window 7300 is depicted in which the Statistical Analysis pane 7310 displays a report 7320 of the type which could result from similar such calculations. As shown, the report 7320 includes a Revenue & Reinvestment column 7330 containing multiple revenue and reinvestment measures. Corresponding statistical data is shown in subsequent columns, including a Custom Date (R1) column 7350 for the first date range, a Custom Date (R2) column 7354 for the second date range, a Variance (R1-R2) column 7060 reflective of the variance between the results of like kind for the two date ranges, and a Variance % column 7364 indicative of the corresponding variance percentage..

I. Patron Locator and PCS Data Visualization

FIG. 15 is a flowchart illustrating a patron locator and data visualization process 1500 pertinent to the player contact system. In the implementation of FIG. 15, it is contemplated that the process 1500 will be executed primarily by the PCS module 216 and the PCS client module 350. As shown, the interaction occurring with the PCS database 112, data warehouse 226 and an external mapping server 1506 during the data visualization process is also illustrated in FIG. 15 in order to more fully elucidate this process. In the exemplary implementation the data visualization process 1500 may be utilized in connection with providing a visual representation of the location of specified patrons or Segment members on the “floor” of the applicable gaming establishment.

As initial step 1510 in the process 1500, the floor layout of the applicable gaming establishment (i.e., the relative position and arrangement of the various gaming tables and devices) is geocoded into a predefined format and provided to the external mapping server 1506 for use as map layer source data 1514. The process 1500 also operates upon patron location data obtained from a property source system 1518 within the transactional databases 108. Such source system 1518 will often comprise a slot accounting system, which contains information as to the locations of registered patrons within the gaming establishment (e.g., patron #A currently playing slot machine #X). This patron location information from the property source system 1518 is transferred through an interface 1522 and stored within a Players on Floor table 1526 within memory 212 of the server 104. In the exemplary implementation the data from the Players on Floor table 1526 and PCS databases 112 is either pushed to the PCS client module 350 or provided upon request. The PCS client module 350 may then invoke an appropriate mapping service from the external mapping server 1506, join the information provided by the mapping service with attribute data furnished by the PCS databases 112, and generate reports facilitating the analysis of location and/or attributes of specified patrons.

In one implementation the external mapping server 1506 may be commercially operated by a third party engaged in providing geographic information systems (GIS) and other mapping services to InterMet-enabled client browsers. For example, ESRI (http://www.esri.com/software/arcims/index.html) operates an ArcIMS Server which facilitates access to, and interaction with, Internet mapping and GIS data from a Web browser.

Referring to FIG. 15, the data visualization process 1500 is initiated through issuance of a request to the PCS database for data relating to a particular patron or Segment population (step 1530). Once this data has been received or pending its receipt, the external mapping server 1506 is queried (step 1532) and location information concerning the identified area of the floor of the gaming establishment is returned (step 1536). The returned geographic data is then joined with the data received from the PCS database 112 and/or data warehouse 226 that is specific to the patron or Segment population of interest (step 1540). At this point the resultant localized geographic representation of the Segment data may be spatially analyzed in the manner described below (step 1550). FIG. 15 also indicates that the results of the spatial analysis of the mapped patron data (step 1550) may be further used to create one or more reports. For example, in the implementation of FIG. 15 a Feature Analysis report 1560 and an Attribute Analysis report 1564 may be generated.

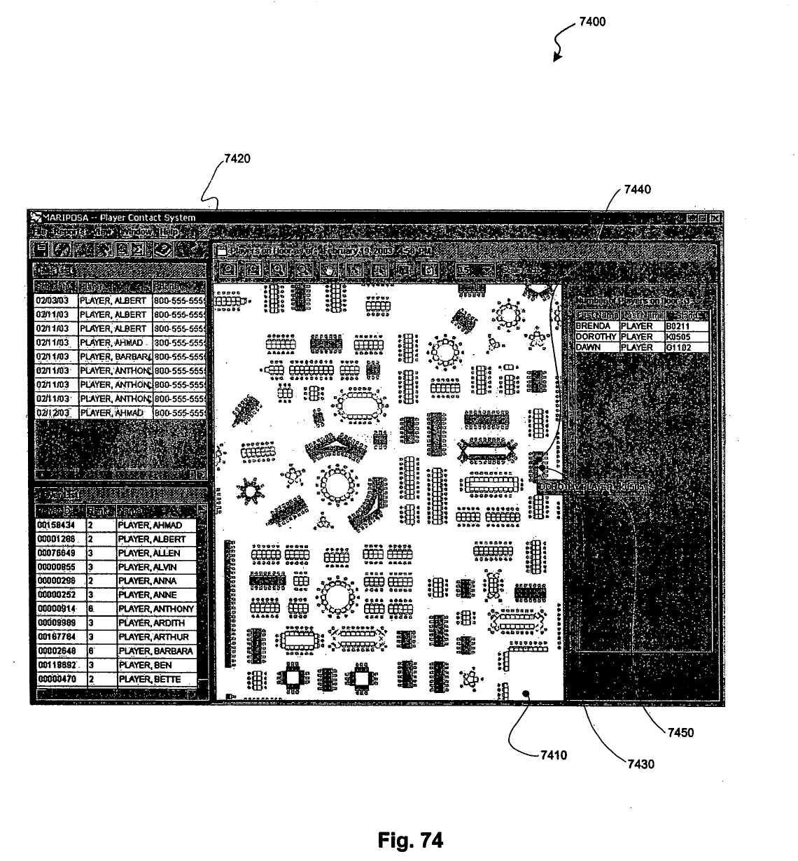

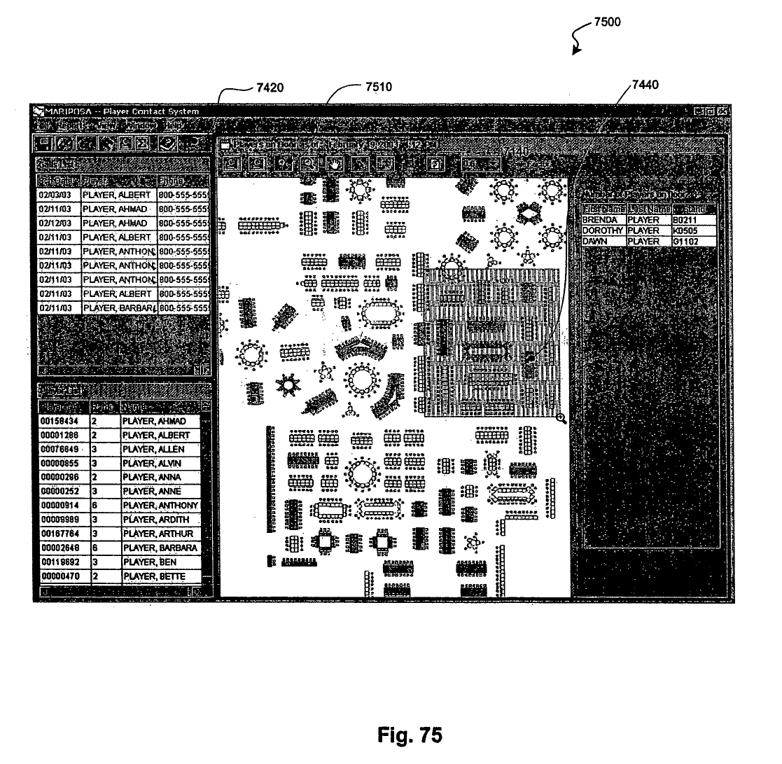

FIGS. 74-76 depict user interface windows through which certain aspects of spatial analysis of mapped Segment data may be performed. Referring to FIG. 74, a user interface window 7400 containing a primary pane 7410 is depicted. In the exemplary implementation the user interface window 7400 is loaded upon selection of a particular button (not shown) from toolbar 7420. In FIG. 74, the user is in the process of previewing a map of the floor of the applicable gaming establishment though primary pane 7410. The user has also moved a mouse pointer 7430 over a highlighted stand 7440 in order to ascertain the identity 7450 of the patron currently interacting with the device at the stand 7440. In the user interface window 7500 of FIG. 75, an interactive mapping tool (i.e., a zoom tool 7510) is being used to specify a smaller map extent 7520, from which a new map may be rendered.

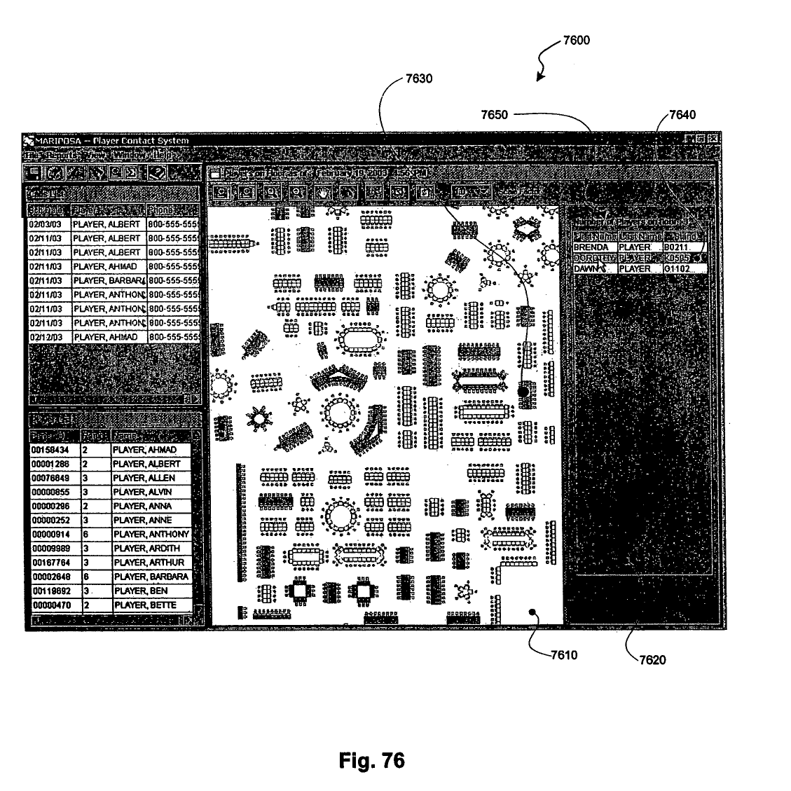

FIG. 76 provides another example of the manner in which interactive mapping tools may be used. As shown, FIG. 76 depicts a user interface window 7600 containing a primary pane 7610 and a patron list pane 7620. In FIG. 76 a user has caused the representation 7630 of a particular patron within the primary pane 7610 to be highlighted by selecting the patron's name 7640 from a table 7650 within the patron list pane 7620. In the exemplary implementation the representation 7630 may take the form of a large flashing red dot, thus providing a readily discernible visual indicator of the location of the applicable patron within the gaming establishment.

J. Report Writer

The report writer module 224 is configured to process both transactional and analytical data processed by the player contact system. In the exemplary implementation the report writer module 224 uses industry-standard XML to define the format and layout of reports, as well as to define the columns and selection clauses that control the displayed data points.

In the case of analytical data, the report writer module 224 (i) defines base levels of information, and (ii) provides an interactive client that allows a user to drill down into the data and print a report from the selected data level of the interactive client as formatted hard-copy.

During operation, the report writer module 224 provides a user with lists of the dimensions and measures available to them in connection with a desired report. The user then “drags” the dimensions into the “X” and “Y” positions depicted via display device 320 of a user computer 120, and also drags the measures into the display section provided. The report writer module 224 also provides for multiple dimensions, as well as the ability to “drill down” into a dimension for further clarification (e.g., in the case of a report with “time” as one of the dimensions, a user would be capable of drilling down from “Year” into “Quarter” into “Month” into “Day”). The comprehensive reports and visualization tools provided by the exemplary implementation of the system 100 described herein facilitate understanding of customer demographic information. This information can be used to develop new marketing campaigns and adjust the focus of existing campaigns.

IV. Distributed Data Warehouse

A. Overview

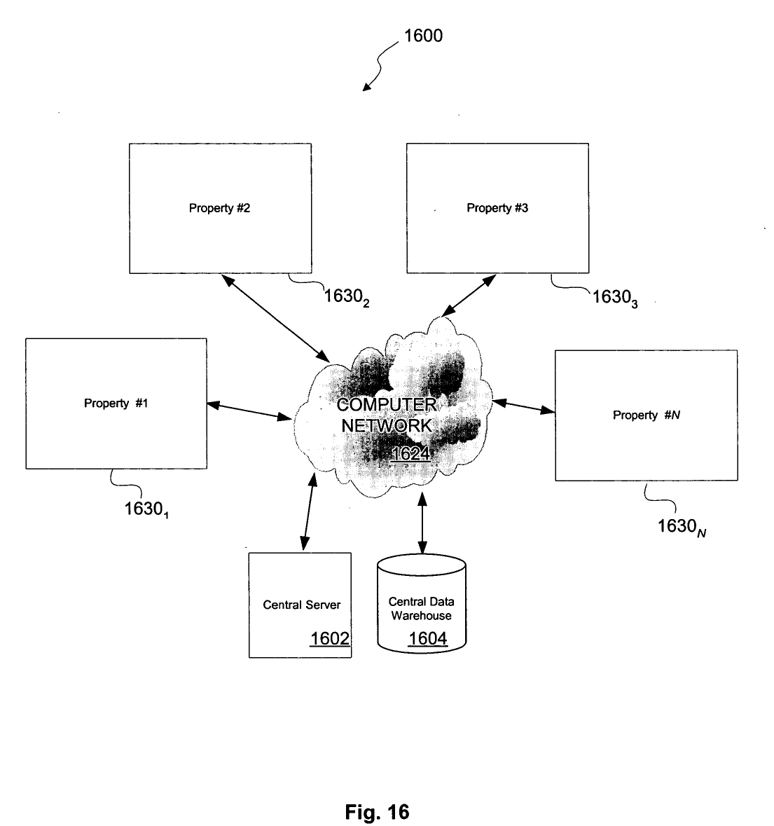

FIG. 16 is an overview of a computing environment in which a distributed data warehouse system 1600 of the present invention may be embodied. In the environment of FIG. 16, the system 1600 is implemented with a central server 1602 disposed to interface with N properties 1630_{1-N} and a central data warehouse. in this exemplary embodiment, the central server 1602 communicates with the N properties and the central data warehouse over a computer network 1624. (e.g., the Internet, wide area network (WAN), or a local area network (LAN)).

In the present embodiment, N properties 1630_{1-N} are separate gaming entities (e.g. casinos) that operate with substantial independence from one another. For example, each of the N properties 1630_{1-N} may be owned by substantially different public or privately held entities. While each of the separate N properties 1630_{1-N} may not directly share information with each other, the N properties 1630_{1-N} share data with the central processor 1602, which gathers and stores the data in the central data warehouse 1604. In an exemplary embodiment, each of the N properties 1630_{1-N} is a separately owned casino that cooperates with the central server 1602 to provide patron data (e.g., anonymous patron demographics) and gaming machine data (e.g., usage by machine type) for the patrons and gaming machines at the respective N properties 1630_{1-N}.

In this way, the distributed data warehouse system 1600 provides a larger collection of cross-property data than would otherwise be available to any one of the N properties 1630_{1-N}. As a consequence, a user accessing the cross-property data in the central warehouse 1604 will be able to draw more meaningful conclusions about the general success of a particular gaming machine. Moreover, a user will be able to make more meaningful conclusions about the success of a particular gaming machine relative to a particular group of patrons and a particular type of casino. With such information, a user will be able to make a more accurate prediction about a particular machines' likelihood of success in a particular casino which is frequented by a particular demographic of patrons.

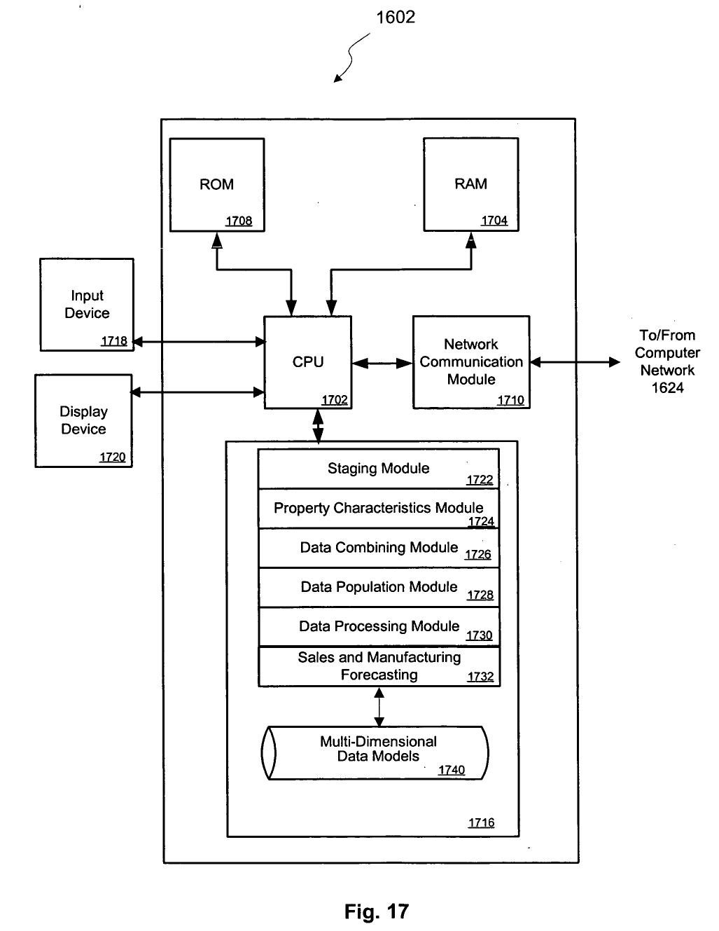

FIG. 17 is a schematic diagram of the structure of the central server 1602. The central server 1602 includes a CPU 1702 connected to RAM 1704, ROM 1708, a network communication module 1710 and a distributed data processing module 1716. Included within the data processing module 1716 are a staging module 1722, a property characteristics module 1724, a data combining module 1726, a data population module 1728, a data processing module 1730, a sales and forecasting module 1732 and the multi-dimensional data storage 1740. When effecting the functionality described below, the CPU 1702 loads into RAM 1704 and executes one or more of the program modules 1722, 1724, 1726, 1728, 1730, 1732 included in the data processing module 1716. Although not shown in FIG. 17, it should be recognized that the central data warehouse 1604 described with reference to FIG. 16 may be located with the central server 1602.

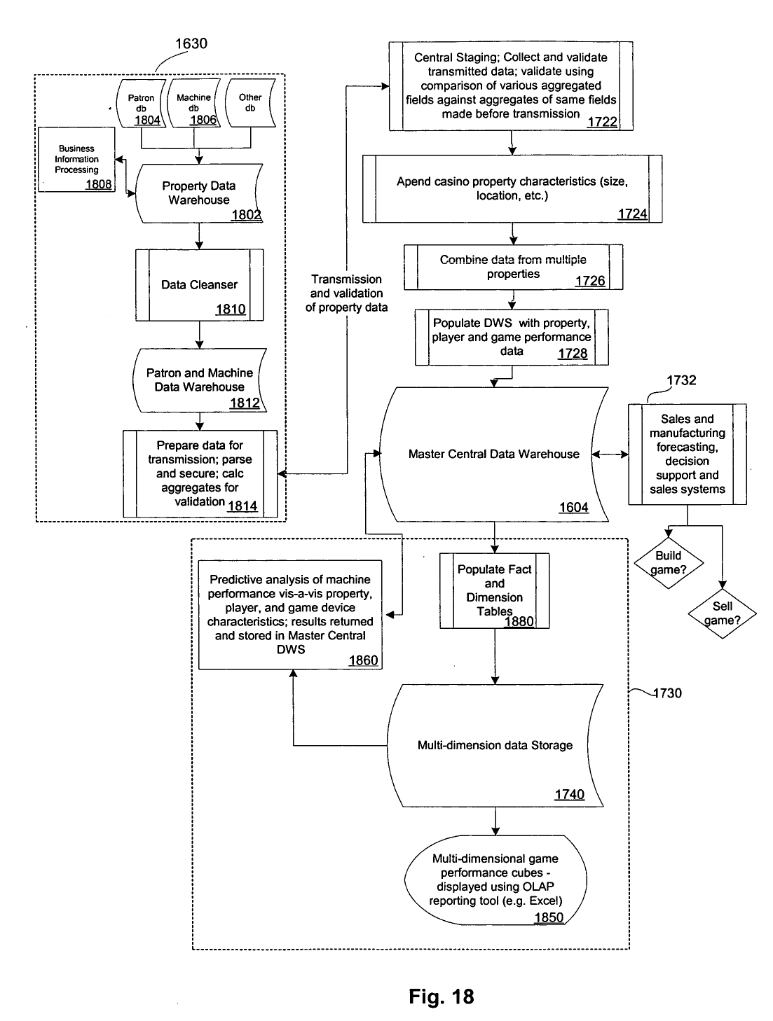

FIG. 18 is a data flow diagram illustrating the interaction among various functional components comprising an exemplary embodiment of the system 1600. Shown is an exemplary property 1630 representing one of the N properties 1630_{1-N} described with reference to FIG. 16. As shown, the exemplary property 1600 includes a property data warehouse 1802 disposed to receive patron data from a patron database 1804 and machine data from a machine database 1806. The property data warehouse 1802 is also operatively coupled to a business information processing system 1808, which may include the patron contact system and customer management system described with reference to FIGS. 1-15.

The patron data in the patron database 1804 typically includes demographic and other relevant information for each patron of the property 1630. For example, the name, address, age and gender may be included. In addition, a patron's interests (e.g., stated and observed references) may also stored in the patron database 1804. It should be recognized that each of the N properties 1630_{1-N} may have different patron data depending upon the information collected and stored by each of the N properties 1630_{1-N}.

Machine data for machines (e.g., slot machines) in the property 1630 is stored in the machine database 1806. The machine data may include the manufacturer, model, denomination (i.e., the monetary denomination accepted by each machine), physical attributes (e.g., cabinet type) and performance metrics (e.g., number of handle pulls, number of games played, “coin in,” which is the amount of money received by the machine and “drop,” which is the amount of money left in the machine after payouts). As with patron data, the machine data collected and stored by each of the N properties 1630_{1-N} may vary from property to property.

As shown in FIG. 18, a data cleanser unit 1810 receives patron and machine data from the property data warehouse 1802 and parses the patron information from the machine information. The data cleanser unit 1810 then removes information that identifies specific patrons from the patron data so as to generate substantially anonymous patron data. In an exemplary embodiment, information including name, phone number and address (except ZIP code) is removed from the patron data. The removed information may be reclassified (e.g., to “other”) so that a data field is still present for the removed data. The substantially anonymous patron data is then recombined with the machine data and provided as combined patron and machine data to a patron and machine data warehouse 1812. In one embodiment, the machine data is also anonymized with respect to one or more attributes. For example, all games manufactured by certain companies may be anonymized and reclassified as “other” in the machine database 1806. This may be beneficial when the master server 1602 is controlled by a first entity (e.g., XYZ Machine Co.) and the property 1603 does not want to provide information that identifies the machines of a second entity (e.g., ABC Machine Co.).

The machine data and substantially anonymous patron data is then retrieved from the patron and machine data warehouse 1812 by a transmission module 1814 where it is parsed and secured for transmission. In addition, an aggregation of certain fields of the patron and game machine data is calculated so that when the substantially anonymous patron data and gaming data is received at the staging module 1722, as shown in FIG. 17, it may be validated by calculating an aggregation of the same data fields and comparing the aggregation of the received data with that of the transmitted data. The patron and machine data, along with the corresponding validation data, is then transmitted to the central server 1602 from which it is relayed to the staging module 1722.

As shown in FIG. 18, once the patron and machine data is received and validated, property characteristics for the property 1630 are appended to the patron and gaming machine data by the property characteristics module 1724. This results in generation of a dataset comprising property data, machine data and the substantially anonymous patron data for the property 1630. The data combining module 1726 then combines the dataset for the property 1630 with the datasets for the other properties so as to generate a combined data set. The data population module 1728 then populates the master data warehouse 1604 with the combined dataset. In one embodiment, the master data warehouse 1604 stores the combined dataset as a flat file (e.g., a comma delimited file), but this is certainly not required. In other embodiments, for example, the master data warehouse may be structured as a relational database.

As shown in FIG. 18, the master central data warehouse 1604 is operatively coupled to the data processing module 1730, which is configured to convert the patron and machine data into multidimensional data models, which facilitate reporting and predictive analysis as discussed further herein. In one embodiment, the data processing module 1730 may be realized by implementing, in the manner described hereinafter, Microsoft SQL Server 2000 Analysis Services software produced by the Microsoft Corporation of Redmond, Wash.

Within the data processing module 1730 is shown a fact and dimension population module 1820 disposed to organize the patron, machine and property data in the master data warehouse 1604 on the basis of a plurality of dimensions. The dimensions will generally be selected so as to facilitate forecasting of the productivity of gaming machines in view of profiles of the properties where the machines may be placed and the patrons that frequent the properties. Potential dimensions for patron data include patron age, gender, residence (e.g., ZIP code), preferences and any other relevant information obtainable from the plurality of properties 1630_{1-N}. With respect to machine data, potential dimensions include machine manufacturer, cabinet type, denominations, drop, coin-in and handle pulls. Property dimensions potentially include property location (e.g., with respect to cities and airports), number of tables, number of games and type (e.g., hotel or casino only).

The fact and dimension tables are used to create multi-dimensional data models, also referred to as cubes, that are stored in the multi-dimensional data storage portion 1740. As one of ordinary skill in the art will appreciate, preaggregating the patron, gaming and property data from the master data warehouse 1604 into cubes allows a user to analyze the data in a much more efficient manner than would otherwise be possible using SQL queries of the master data warehouse 1604.

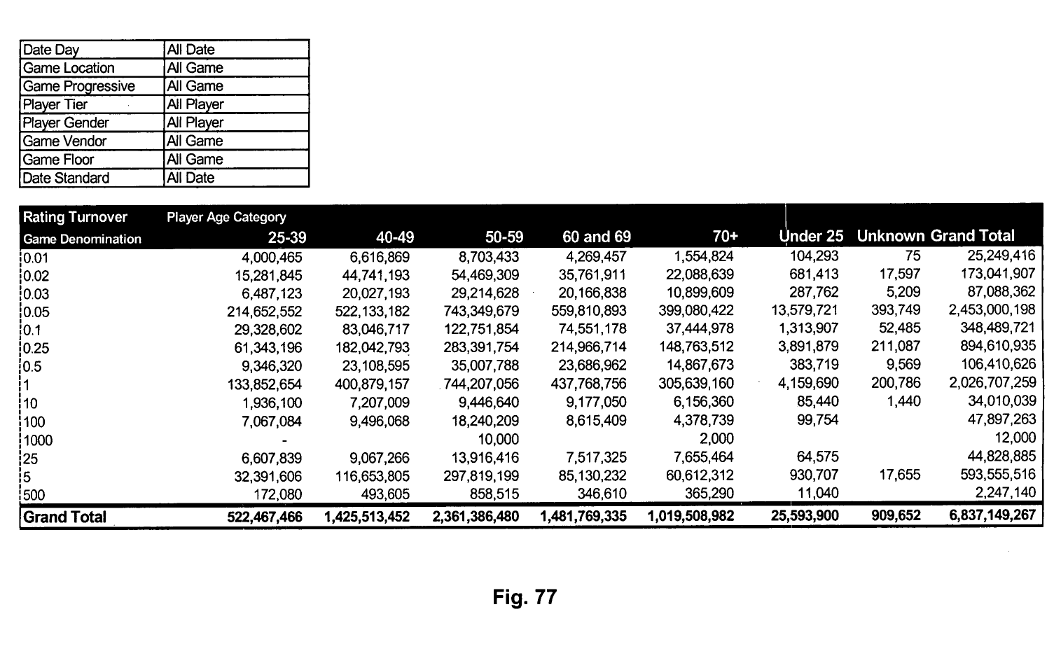

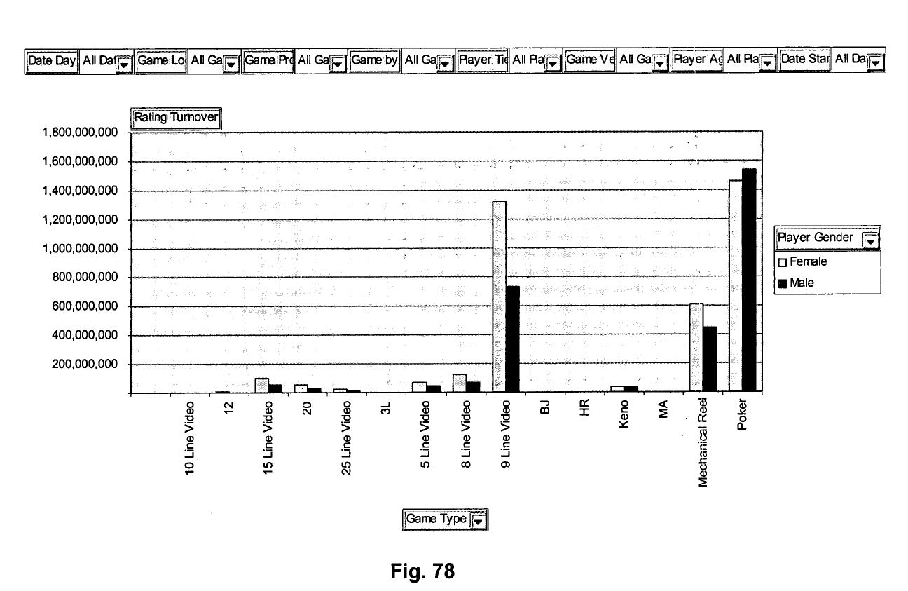

As shown, online analytical processing (OLAP) 1850 provides an interface through which users may quickly and interactively examine the results in various dimensions of the data. Referring to FIGS. 77 and 78, shown are tabular and graphic reports respectively illustrating reporting along exemplary dimensions available with the OLAP processing 1850. The table 7700 shown in FIG. 77 provides, for various game denominations, rating turnover data for six different patron age categories. A table such as table 7700 is useful in quickly identifying the game denominations that are the most popular among each patron age group. It should be recognized that the present table is merely exemplary of the type of tables that may be created along the available dimensions of data available from the multi-dimensional data storage 1740 and/or the central data warehouse 1604. Referring next to FIG. 78, shown is a bar graph 7800, which conveys, for a variety of machine types, rating turnover with respect to both male and female patrons. Such a graph quickly communicates to a user which machines are the most successful with respect to the gender of the patrons. Beneficially, a user is able to create various types of graphs and charts (e.g., bar, line, pie) to quickly analyze cross-property data along the multiple dimensions of data available from the multi-dimensional data storage 1740 and/or the central data warehouse 1604.

As shown, data processing module 1730 in the exemplary embodiment also includes a predictive analysis module 1860 capable of carrying out predictive analysis of machine performance vis-á-vis property, patron and machine characteristics. For example, the success of a video poker machine of a particular type at a particular property (e.g., a 400 room property with at least 2000 games 20 miles from an urban center of over 1 million people) with respect to patrons of various ages may be predicted based upon the cross-property data gathered.

As shown in FIG. 18, the predictive analysis module 1860 accesses data from either the central data warehouse 1604 or the multi-dimensional data storage 1740. Typically, however, the multi-dimensional data storage 1740 is accessed because the preaggregated nature of the data stored therein may be more quickly and efficiently searched than by performing SQL queries of the central data warehouse 1604.

In the exemplary embodiment, once the prediction analysis module 1860 has generated a prediction of machine performance (e.g., a predicted success rate), the prediction is stored in the central data warehouse 1604 for later retrieval.

As shown, the predictive analysis results stored in the central data warehouse 1604 are then accessible by the sales and manufacturing support module 1732. In the exemplary embodiment, the sales and manufacturing support module 1732 obtains predictive analysis data from the central data warehouse 1604 to assist manufacturing decisions and/or sales decisions. In the context of game development, a game machine manufacturer may utilize the sales and manufacturing support module 1732 when strategically planning the types of machines to develop for particular markets. For example, the cross-property data and the predictive analysis results in the central data warehouse 1604 may be used to help identify when properties are approaching a replacement cycle (i.e., when properties are replacing a substantial number of machines) and the most appropriate type of machine that should be developed in advance, based upon the profiles of those properties, to meet the properties' needs.

Similarly, sales and marketing personnel may utilize the sales and manufacturing support module 1732 to help identify the machines that best match the profile of a given property. The manufacturing support module 1732 may also be used during the sales process to enable informed purchasing decisions to be made. For example, when the profile of a property has been analyzed by the predictive analysis module 1860 (i.e., with respect to the likelihood of success of a variety of machines), the machines with the highest likelihood of success may be targeted as machines to offer to the property owner. In this way, the a sales organization is more likely to have success with their sales and the property owners are more likely to have success with the games they purchase.

In an exemplary embodiment, the manufacturing support module 1732 is communicatively coupled (e.g., via wide area network) to a portable communication device (e.g., laptop computer, pager, cell phone or personal digital assistant (PDA)) operated by a field salesperson to enable real time predictive analysis and reporting to the field salesperson. As an example, if the salesperson is about to make a sales call at a property with a particular profile (e.g., a casino with a hotel, with over a thousand games, located twenty miles from a municipality with over a million people that is frequented by patrons forty to fifty years old), the salesperson may request that the manufacturing support module 1732 send a report detailing the machines that are successful in properties of that particular profile. In response, the sales and manufacturing support module 1732 either accesses the central data warehouse 1604, if a predictive analysis has already been done for that profile, or initiates a predictive analysis for that property profile with the predictive analysis module 1860. The sales and manufacturing support module 1732 then relays a predictive analysis report to the salesperson's portable communication device, which informs the salesperson of the types of machines that have been successful at other properties with that profile.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

1. A method for warehousing data comprising:
receiving, from each of a plurality of properties, corresponding patron data and gaming machine data;
appending property characteristics to the patron data and gaming machine data so as to generate a plurality of datasets respectively corresponding to the plurality of properties;
combining the plurality of datasets so as to generate a combined dataset; and
populating a data warehouse with said combined dataset so as to generate stored combined data.

2. The method of claim 1 including receiving the property characteristics in advance of the patron data and the gaming machine data.

3. The method of claim 1 further including anonymizing the patron data.

4. The method of claim 1 wherein at least a portion of the gaming machine data lacks reference to a manufacturer of one or more gaming machines.

5. The method of claim 1 wherein the plurality of properties are operated by separate business entities.

6. The method of claim 1 further including populating fact and dimension tables with at least a portion of said stored combined data so as to generate multidimensional data models.

7. The method of claim 6 further including processing said multidimensional data models so as to predict performance of a machine with respect to a property characterized by multiple dimensions.

8. The method of claim 7 wherein said multiple dimensions are selected from the group consisting of: number of rooms, location, total number of machines.

9. The method of claim 7, wherein said processing includes processing said multidimensional data models so as to predict performance of a machine with respect to the property and a patron type.

10. A system for gathering data from a plurality of properties comprising:
a plurality of data warehouses, each of the plurality of data warehouses being located at a corresponding one of the plurality of properties;
a central server unit operatively connected to said plurality of data warehouses, said central server including a processor and a memory associated with said processor wherein said memory includes:
a staging module executable by said processor, said staging module being disposed to receive, from each of the plurality of data warehouses, patron data and gaming machine data;
a data combination module executable by said processor, said data combination module being configured to combine said patron data and said gaming machine data from each of the plurality of warehouses with corresponding property characteristics associated with each of the plurality of warehouses so as to generate a combined dataset; and
a central data warehouse disposed to receive said combined data set.

11. The system of claim 10 wherein said memory includes a multi-dimensional data manipulation module configured to populate fact and dimension tables with at least a portion of said combined dataset so as to be capable of generating multidimensional data models.

12. The system of claim 11 wherein said memory includes an on-line analytical processing (OLAP) module configured to display combinations of said patron data, said gaming machine data and said property characteristics vis-á-vis one another.

13. The system of claim 11 wherein said memory includes a predictive analysis module configured to predict performance of a particular machine vis-á-vis a particular property by accessing and analyzing said multidimensional data models.

14. The system of claim 13 wherein said predictive analysis module is configured to predict said performance of said particular machine vis-á-vis both said particular property and a particular patron type.

15. The system of claim 10 wherein said memory of said central server includes a property characteristics module configured to append property characteristics, received in advance of said patron data and gaming machine data, for each of the plurality of warehouses to said corresponding patron data and gaming machine data so as to be capable of generating a plurality of datasets, wherein said data combination module is configured to combine said plurality of datasets into said combined dataset.

16. A processor readable medium including processor executable instructions for warehousing data, the instructions including:
receiving, from each of a plurality of properties, corresponding patron data and gaming machine data;
appending property characteristics to the patron data and gaming machine data so as to generate a plurality of datasets respectively corresponding to the plurality of properties;
combining the plurality of datasets so as to generate a combined dataset; and
populating a data warehouse with said combined dataset so as to generate stored combined data.

17. The processor readable medium of claim 16 including receiving the property characteristics in advance of the patron data and the gaming machine data.

18. The processor readable medium of claim 16 wherein the patron data is substantially anonymous patron data.

19. The processor readable medium of claim 16 wherein at least a portion of the gaming machine data lacks reference to a manufacturer of one or more gaming machines.

20. The processor readable medium of claim 16 wherein the plurality of properties are operated by separate business entities.

21. The processor readable medium of claim 16 further including populating fact and dimension tables with at least a portion of said stored combined data so as to generate multidimensional data models.

22. The processor readable medium of claim 21 further including processing said multidimensional data models so as to predict performance of a machine with respect to a property characterized by multiple dimensions.

23. The processor readable medium of claim 22 wherein said multiple dimensions are selected from the group consisting of: number of rooms, location, total number of machines.

24. The processor readable medium of claim 22, wherein said processing includes processing said multidimensional data models so as to predict performance of a machine with respect to the property and a patron type.
